(19) United States
(12) Patent Application Publication
(10) Pub. No.: US 2015/0026604 A1
(43) Pub. Date: Jan. 22, 2015

(54) ENHANCED CHAT FEATURES FOR AN ENTERPRISE LEVEL BUSINESS INFORMATION NETWORKING ENVIRONMENT

(71) Applicant: Salesforce.com, inc., San Francisco, C (US)

(72) Inventors: Viswanath Mulukuri, Hyderabad (IN); Ashok Gadamsetty, Prakasam (IN); Zach Perkins, San Francisco, CA (US); Sundar Subramanian, Hyderabad (IN); Yaseen Shaik, Visakhapatnam (IN)

(73) Assignee: Salesforce.com, inc., San Francisco, CA (US)

(21) Appl. No.: 14/035,183

(22) Filed: Sep. 24, 2013

Related U.S. Application Data
(60) Provisional application No. 61/847,471, filed on Jul. 17, 2013.
(60) Provisional application No. 61/847,476, filed on Jul. 17, 2013.
(60) Provisional application No. 61/847,481, filed on Jul. 17, 2013.
(60) Provisional application No. 61/847,486, filed on Jul. 17, 2013.
(60) Provisional application No. 61/847,488, filed on Jul. 17, 2013.
(60) Provisional application No. 61/847,491, filed on Jul. 17, 2013.
(60) Provisional application No. 61/847,496, filed on Jul. 17, 2013.
(60) Provisional application No. 61/847,497, filed on Jul. 17, 2013.
(60) Provisional application No. 61/847,500, filed on Jul. 17, 2013.
(60) Provisional application No. 61/847,502, filed on Jul. 17, 2013.
(60) Provisional application No. 61/847,505, filed on Jul. 17, 2013.

(51) Int. Cl. H04L 12/58

(52) U.S. Cl. CPC H04L 51/046
USPC 715/758

(57) ABSTRACT

Systems, apparatus, and methods for implementing enterprise level social and business information networking are provided. Users can receive relevant information about a database system and its users at an appropriate time. Users can then use this relevant information to reduce errors and limit redundant efforts. For example, an update of a record in the database can be identified, and a story created automatically about the update and sent to the users that are following the record. Other events besides updating of records can also be tracked. A variety of enhanced features and functions are also presented in the context of an enterprise level social and business information networking environment.

### CROSS-REFERENCE TO RELATED APPLICATIONS

This application claims the benefit of: U.S. provisional patent application No. 61/847,471, filed Jul. 17, 2013 (titled Enhanced Features For An Enterprise Level Business Information Networking Environment: Sharing Information With Multiple Groups/Organizations); U.S. provisional patent application No. 61/847,476, filed Jul. 17, 2013 (titled Enhanced Features For An Enterprise Level Business Information Networking Environment: Blind Mentions Of Users); U.S. provisional patent application No. 61/847,481, filed Jul. 17, 2013 (titled Enhanced Features For An Enterprise Level Business Information Networking Environment: Advanced Searching For Posts/Comments); U.S. provisional patent application No. 61/847,486, filed Jul. 17, 2013 (titled Enhanced Features For An Enterprise Level Business Information Networking Environment: Collaborative Advertising); U.S. provisional patent application No. 61/847,488, filed Jul. 17, 2013 (titled Enhanced Features For An Enterprise Level Business Information Networking Environment: Designating Chat Favorites); U.S. provisional patent application No. 61/847,491, filed Jul. 17, 2013 (titled Enhanced Features For An Enterprise Level Business Information Networking Environment: Automatic Out Of Office Post); U.S. provisional patent application No. 61/847,496, filed Jul. 17, 2013 (titled Enhanced Features For An Enterprise Level Business Information Networking Environment: Smart Posting To Multiple Groups); U.S. provisional patent application No. 61/847,497, filed Jul. 17, 2013 (titled Enhanced Features For An Enterprise Level Business Information Networking Environment: Group-Based Synchronized File Folder); U.S. provisional patent application No. 61/847,500, filed Jul. 17, 2013 (titled Enhanced Features For An Enterprise Level Business Information Networking Environment: Saving Favorite Chats); U.S. provisional patent application No. 61/847,502, filed Jul. 17, 2013 (titled Enhanced Features For An Enterprise Level Business Information Networking Environment: Notification Of Online User Status For A Chat Feature); and U.S. provisional patent application No. 61/847,505, filed Jul. 17, 2013 (titled Enhanced Features For An Enterprise Level Business Information Networking Environment: Note-Taking For A Chat Feature).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the subject matter described herein relate generally to database systems, and more particularly to implementing enterprise level business information networking.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Using present database systems, it is difficult to know about the activity of others users of a database system. For example, the activity of another user may be important to the user's boss. The user can create a report about what the user has done and send it to the boss, but such reports may be inefficient, not timely, and incomplete. Also, it may be difficult to know other people who might benefit from the information in the report.

Therefore it is desirable to provide systems and methods that overcome the above and other problems.

### BRIEF SUMMARY

Embodiments described herein provide systems, apparatus, and methods for implementing enterprise level social and business information networking. These mechanisms and methods can provide users with relevant information about a database system and its users at an appropriate time (e.g., in real-time). Users can then use this relevant information, for example, to reduce errors and limit redundant efforts.

As an example, an update of a record in the database can be identified, and a story can be created automatically by the database system about the update and sent to the users that are following the record. The database system can provide configuration of which updates have stories created and which stories are to be sent to which users. Other events besides updating of records can also be tracked. For example, actions of a user that result in an event can be tracked, where such tracking can also be configurable.

In an embodiment and by way of example, a method of tracking updates to a database system is provided. The database system receives (e.g. from a first user) a request to update a first record of a database of the database system. The database system creates a story about the update. The story is posted to a first feed associated with the update.

Other embodiments of the invention are directed to systems and computer readable media associated with methods described herein.

While the present invention is described with reference to an embodiment in which techniques for performing searches of feeds in an on-demand enterprise services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 illustrates a block diagram of an example of an environment wherein an on-demand database service might be used.

FIG. 2 illustrates a block diagram of an embodiment of elements of FIG. 1 and various possible interconnections between these elements.

FIG. 3 is a flowchart of a method for tracking updates to a record stored in a database system according to one or more embodiments.

FIG. 4 is a block diagram of components of a database system performing a method for tracking an update to a record according to one or more embodiments.

FIG. 5 is a flowchart of a method for tracking actions of a user of a database system according to one or more embodiments.

FIG. 6 is a flowchart of a method for creating a news feed from messages created by a first user about a record or another user according to one or more embodiments.

FIG. 7 shows an example of a group feed on a group page according to one or more embodiments.

FIG. 8 shows an example of a record feed containing a story, post, and comments according to one or more embodiments.

FIG. 9A shows a plurality of tables that may be used in tracking events and creating feeds according to one or more embodiments.

FIG. 9B shows a flowchart illustrating a method for automatically subscribing a user to an object in a database system according to embodiments.

FIG. 10 is a flowchart of a method for saving information to feed tracking tables according to one or more embodiments.

FIG. 11 is a flowchart of a method for reading a feed item as part of generating a feed for display according to one or more embodiments.

FIG. 12 is a flowchart of a method for reading a feed item of a profile feed for display according to one or more embodiments.

FIG. 13 is a flowchart of a method of storing event information for efficient generation of feed items to display in a feed according to one or more embodiments.

FIG. 14 is a flowchart of a method for creating a custom feed for users of a database system using filtering criteria according to embodiments.

FIG. 15 is a flow chart that illustrates an exemplary process for automatically posting information to multiple groups or organizations supported by a database system.

FIG. 16 is a flow chart that illustrates an exemplary process for notifying users of content published in an information networking environment by way of a blind at-mention scheme.

FIG. 17 is a flow chart that illustrates an exemplary process for enhanced searching of content that is posted in an information networking environment.

FIG. 18 is a flow chart that illustrates an exemplary process for electronic advertising collaboration in an information networking environment.

FIG. 19 depicts a portion of a chat window, which includes a chat favorites element.

FIG. 20 depicts a portion of a chat window, which includes an expanded group of users.

FIG. 21 is a flow chart that illustrates an exemplary process for supporting a chat favorites feature in an information networking environment.

FIG. 22 is a flow chart that illustrates an exemplary process for automatically responding to posts.

FIG. 23 depicts a configuration interface that can be used to link groups across tenants of a multi-tenant database system.

FIG. 24 depicts a confirmation interface that allows a user to select multiple groups for publishing a post.

FIG. 25 is a flow chart that illustrates an exemplary process for posting content across a plurality of groups.

FIG. 26 is a flow chart that illustrates an exemplary process for synchronizing files for a group of users in an information networking environment.

FIG. 27 is a flow chart that illustrates an exemplary process for saving and retrieving favorite chat conversations.

FIG. 28 is a flow chart that illustrates an exemplary process for alerting users of an information networking environment.

FIG. 29 is a flow chart that illustrates an exemplary process for supporting a chat notes feature in an information networking environment.

### DETAILED DESCRIPTION

### Definitions

As used herein, the term “multi-tenant database system” refers to those systems in which various elements of hardware and software of the database system may be shared by one or more customers. For example, a given application server may simultaneously process requests for a great number of customers, and a given database table may store rows for a potentially much greater number of customers.

As used herein, the term “query plan” refers to a set of steps used to access information in a database system.

As used herein, the term “user's profile” includes data about the user of the database system. The data can include general information, such as title, phone number, a photo, a biographical summary, and a status (e.g., text describing what the user is currently doing). As mentioned below, the data can include messages created by other users. Where there are multiple tenants, a user is typically associated with a particular tenant. For example, a user could be a salesperson of a company that is a tenant of the database system that provides a database service.

As used herein, the term “record” refers to an instance of a data object created by a user of the database service, for example, about a particular (actual or potential) business relationship or project. The data object can have a data structure defined by the database service (a standard object) or defined by a subscriber (custom object). For example, a record can be for a business partner or potential business partner (e.g., a client, vendor, distributor, etc.) of the user, and can include an entire company, subsidiaries, or contacts at the company. As another example, a record can be a project that the user is working on, such as an opportunity (e.g., a possible sale) with an existing partner, or a project that the user is trying to get. In one embodiment implementing a multi-tenant database, all of the records for the tenants have an identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

As used herein, the term “feed” includes a combination (e.g., a list) of feed items. As user herein, the term “feed item” (or feed element) refers to information about a user (“profile feed”) of the database or about a record (“record feed”) in the database. A user following the user or record can receive the associated feed items. The feed items from all of the followed users and records can be combined into a single feed for the user.

As examples, a “feed item” can be a message and story (also called a feed tracked change). A feed can be a combination of messages and stories. Messages include text created by a user, and may include other data as well. Examples of messages include posts, status updates, and comments. Messages can be created for a user's profile or for a record. Posts can be created by various users, potentially any user, although some restrictions can be applied. As an example, posts can be made to a wall section of a user's profile (which can include a number of recent posts) or a section of a record that includes multiple posts. The posts can be organized in chronological order. In contrast to a post, a status update changes a status of a user and is made by that user. Other similar sections of a user's profile can also include an “About” section. A record can also have a status, whose update can be restricted to the owner of the record. The owner can be a single user, multiple users, or a group. In some embodiments, there is only one status for a record. In some embodiments, a comment can be made on any feed item. In other embodiments, comments are organized as a list explicitly tied to a particular story, post, or status update. In certain embodiments, comments may not be listed in the first layer (in a hierarchal sense) of feed items, but listed as a second layer branching from a particular first layer feed item.

A “story” is data representing an event, and can include text generated by the database system in response to the event. In one embodiment, the data can initially be stored, and then the database system can later use the data to create text for describing the event. Both the data and/or the text can be a story, as used herein. In various embodiments, an event can be an update of a record and/or can be triggered by a specific action by a user. Which actions trigger an event can be configurable. Which events have stories created and which stories are sent to which users can also be configurable. Messages and stories can be stored as a field or child object of the record. For example, the feed can be stored as a child object of the record.

As used herein, a “group” is a collection of users. In some aspects, the group may be defined as users with a same or similar attribute, or by membership. In some embodiments, a “group feed” includes any feed item about any user in a group. In other embodiments, a “group feed” includes feed items that are about the group as a whole. In some implementations, the feed items for a group are only posts and comments.

As used herein, an “entity feed” or “record feed” refers to a feed of feed items about a particular record in the database, such as stories about changes to the record and posts made by users about the record. An entity feed can be composed of any type of feed item. Such a feed can be displayed on a page (e.g., a web page) associated with the record (e.g., a home page of the record). As used herein, a “profile feed” is a feed of feed items about a particular user. In one embodiment, the feed items for a profile feed are posts and comments that other users make about or send to the particular user, and status updates made by the user. Such a profile feed can be displayed on a page associated with the particular user. In another embodiment, feed items in a profile feed could include posts made by the particular user and feed tracked changes (stories) initiated based on actions of the particular user.

I. General Overview

Systems, apparatus, and methods are provided for implementing enterprise level social and business information networking. Such embodiments can provide more efficient use of a database system. For instance, a user of a database system may not easily know when important information in the database has changed, e.g., about a project or client. Embodiments can provide stories about such changes and other events, thereby keeping users informed.

By way of example, a user can update a record (e.g., an opportunity such as a possible sale of 1000 computers). Once the update has been made, a story about the update can then automatically be sent (e.g., in a feed) to anyone subscribing to the opportunity or to the user. Thus, the user does not need to contact a manager regarding the change in the opportunity, since the story about the update is sent via a feed right to the manager's feed page (or other page).

Next, mechanisms and methods for providing systems and methods for implementing enterprise level social and business information networking will be described with reference to exemplary embodiments. First, an overview of an exemplary database system is described, and then examples of tracking events for a record, actions of a user, and messages about a user or record are described. Various embodiments about the data structure of feeds, customizing feeds, user selection of records and users to follow, generating feeds, and displaying feeds are also described.

II. System Overview

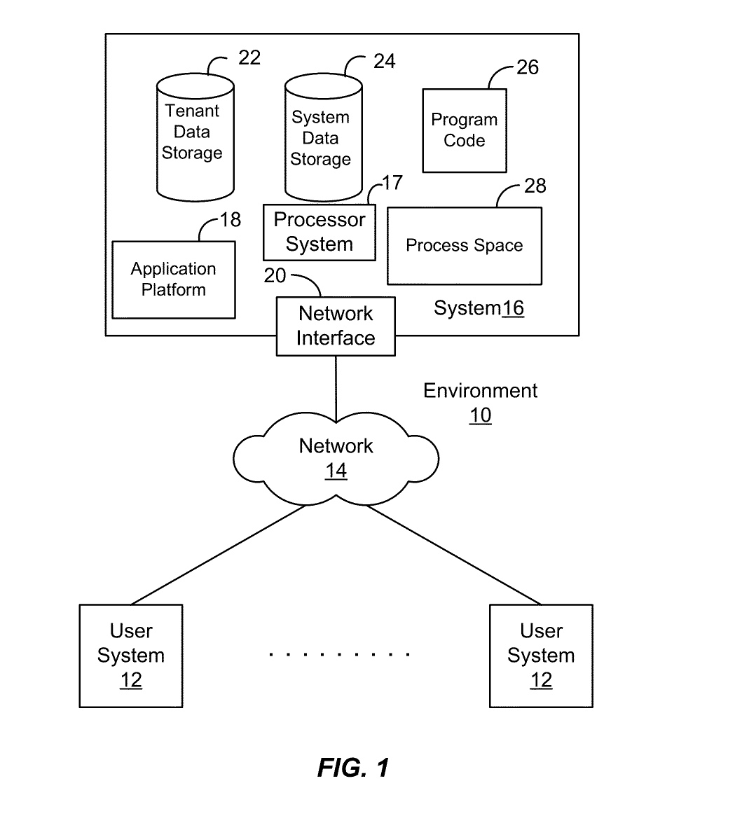

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

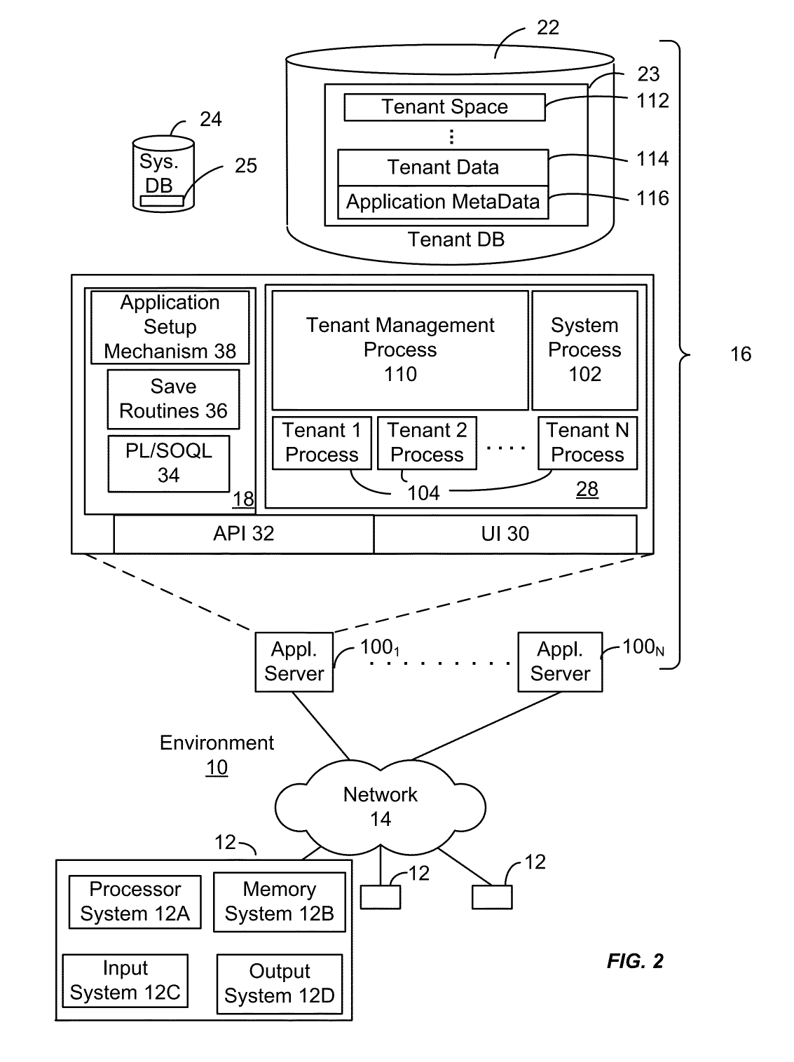

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level (profile type) may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications as well as provide related data, code, forms, webpages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (JAVA™ is a trademark of Sun Microsystems, Inc.).

According to some embodiments, each system 16 is configured to provide webpages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 1001-100N, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 1001 might be coupled via the network 14 (e.g., the Internet), another application server 100N-1 might be coupled via a direct network link, and another application server 100N might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In some embodiments, therefore, an interface system implementing a load balancing function (e.g., an F5 Big-IP load balancer) is communicably coupled between the application servers 100 and the user systems 12 to distribute requests to the application servers 100. In some embodiments, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object type” may be used interchangeably herein. Each table generally contains one or more data categories logically arranged as columns or fields in a viewable schema. Each row or record of a table contains an instance of data for each category (type) defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, Opportunity data, and other object types, each containing pre-defined fields. It should be understood that the word “entity” may also be used interchangeably herein with “object” and “table”, when entity or object is referring to a collection of objects or entities of a particular type.

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

III. Tracking Updates to a Record Stored in a Database

As multiple users might be able to change the data of a record, it can be useful for certain users to be notified when a record is updated. Also, even if a user does not have authority to change a record, the user still might want to know when there is an update. For example, a vendor may negotiate a new price with a salesperson of company X, where the salesperson is a user associated with tenant X. As part of creating a new invoice or for accounting purposes, the salesperson can change the price saved in the database. It may be important for co-workers to know that the price has changed. The salesperson could send an e-mail to certain people, but this is onerous and the salesperson might not e-mail all of the people who need to know or want to know. Accordingly, embodiments can inform others (e.g., co-workers) who want to know about an update to a record automatically.

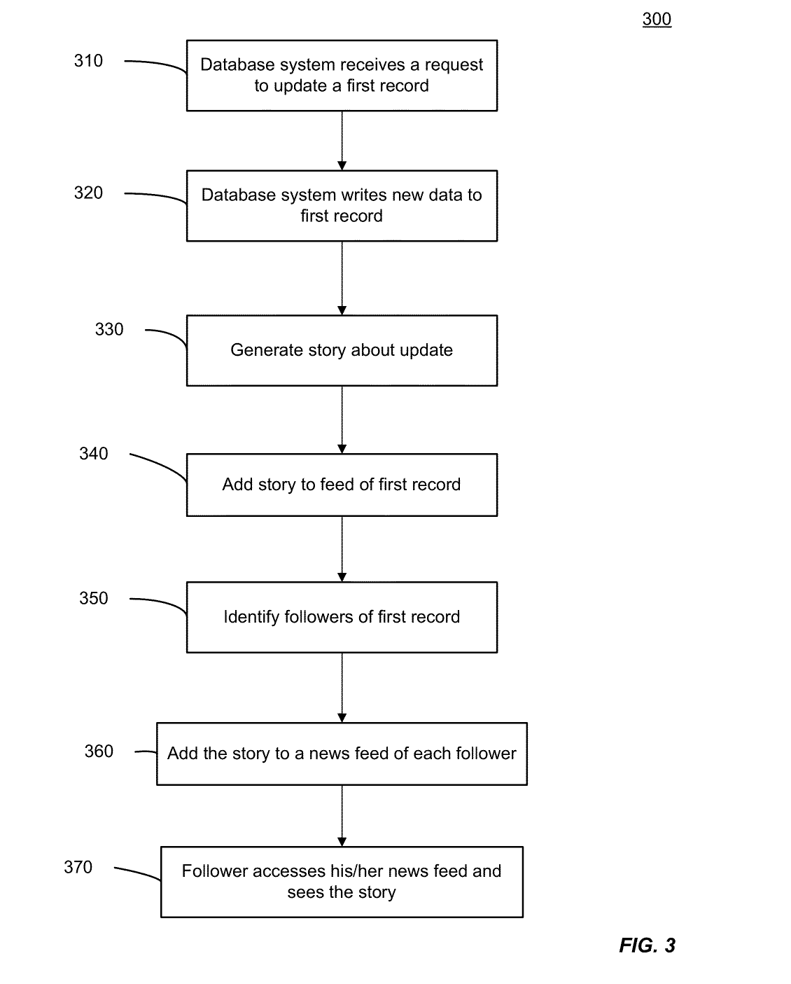

FIG. 3 is a flowchart of a method 300 for tracking updates to a record stored in a database system according to embodiments. In some embodiments, method 300 (and other methods described herein) may be implemented at least partially with multi-tenant database system 16, e.g., by one or more processors configured to receive or retrieve information, process the information, store results, and the transmit the results. In other embodiments, method 300 may be implemented at least partially with a single tenant database system. In various embodiments, steps may be omitted, combined, or split into additional steps for method 300, as well as for other methods described herein.

In step 310, the database system receives a request to update a first record. In one embodiment, the request is received from a first user. For example, a user may be accessing a page associated with the first record, and may change a displayed field and hit save. In another embodiment, the database system can automatically create the request. For instance, the database system can create the request in response to another event, e.g., a request to change a field could be sent periodically at a particular date and/or time of day, or a change to another field or object. The database system can obtain a new value based on other fields of a record and/or based on parameters in the system.

The request for the update of a field of a record is an example of an event associated with the first record for which a story may be created. In other embodiments, the database system can identify other events besides updates to fields of a record. For example, an event can be a submission of approval to change a field. Such an event can also have an associated field (e.g., a field showing a status of whether a change has been submitted). Other examples of events can include creation of a record, deletion of a record, converting a record from one type to another (e.g., converting a lead to an opportunity), closing a record (e.g., a case type record), and potentially any state change of a record—any of which could include a field change associated with the state change. Any of these events update the record whether by changing a field of the record, a state of the record, or some other characteristic or property of the record. In some embodiments, a list of supported events for creating a story can be maintained within the database system, e.g., at a server or in a database.

In step 320, the database system writes new data to the first record. In some embodiments, the new data may include a new value that replaces old data. For example, a field is updated with a new value. In other embodiments, the new data can be a value for a field that did not contain data before. In yet other embodiments, the new data could be a flag, e.g., for a status of the record, which can be stored as a field of the record.

In some embodiments, a “field” can also include records that are child objects of the first record. A child object itself can include further fields. Thus, if a field of a child object is updated with a new value, the parent record also can be considered to have a field changed. In one example, a field could be a list of related child objects, also called a related list.

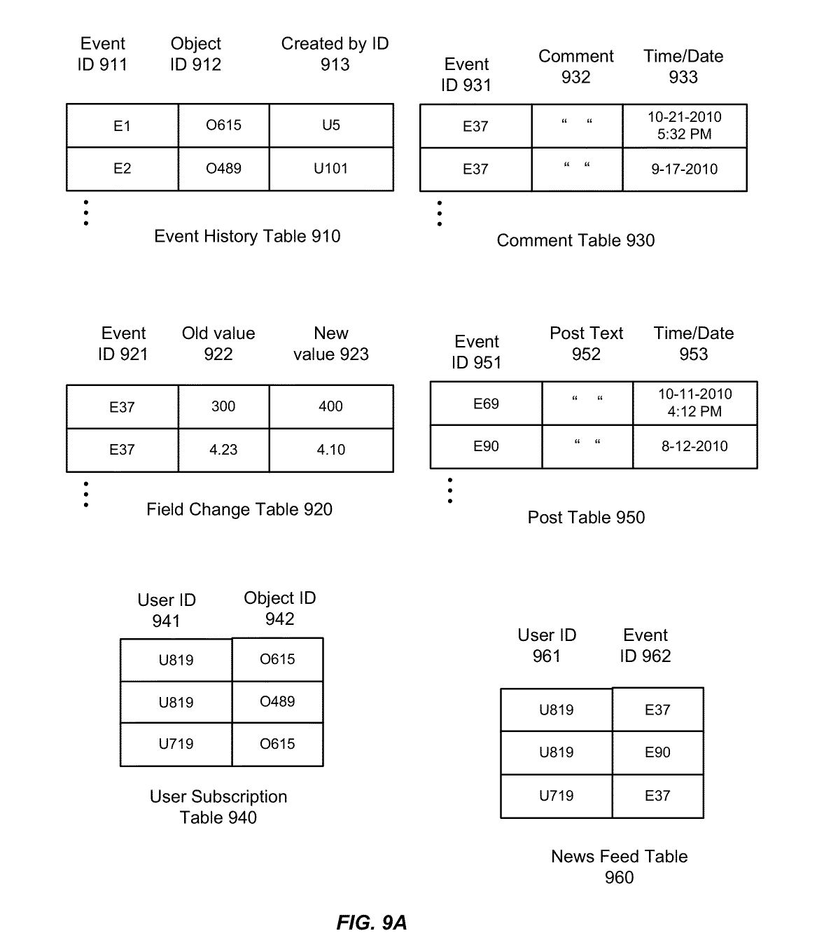

In step 330, a story is generated about the update. In one embodiment, the story is created in parts for assembling later into a display version. For example, event entries can be created and tracked in one table, and changed field entries can be tracked in another table that is cross-referenced with the first table. More specifics of such embodiments are provided later, e.g., with respect to FIG. 9A. In another embodiment, the story is automatically generated by the database system. The story can convey in words that the first record has been updated and provide details about what was updated in the record and who performed the update. In some embodiments, a story is generated for only certain types of event and/or updates associated with the first record.

In some embodiments, a tenant (e.g., through an administrator) can configure the database system to create (enable) stories only for certain types of records. For example, an administrator can specify that records of type Account and Opportunity are enabled. When an update (or other event) is received for the enabled record type, then a story would be generated. In another embodiment, a tenant can also specify the fields of a record whose changes are to be tracked, and for which stories are created. In one aspect, a maximum number of fields can be specified for tracking, and may include custom fields. In one implementation, the type of change can also be specified, for example, that the value change of a field is required to be larger than a threshold (e.g., an absolute amount or a percentage change). In yet another embodiment, a tenant can specify which events are to cause a generation of a story. Also, in one implementation, individual users can specify configurations specific to them, which can create custom feeds as described in more detail below.

In some embodiments, changes to fields of a child object are not tracked to create stories for the parent record. In other embodiments, the changes to fields of a child object can be tracked to create stories for the parent record. For example, a child object of the parent type can be specified for tracking, and certain fields of the child object can be specified for tracking. As another example, if the child object is of a type specified for tracking, then a tracked change for the child object is propagated to parent records of the child object.

In step 340, the story is added to a feed for the first record. In some embodiments, adding the story to a feed can include adding events to a table (which may be specific to a record or be for all or a group of objects), where a display version of a story can be performed dynamically when a user requests a feed for the first record. In other embodiments, a display version of a story can be added when a record feed is stored and maintained for a record. As mentioned above, a feed may be maintained for only certain records. In one implementation, the feed of a record can be stored in the database associated with the feed. For example, the feed can be stored as a field (e.g., as a child object) of the record. Such a field can store a pointer to the text to be displayed for the story.

In some embodiments, only the current story (or other current feed item) may be kept or temporarily stored, e.g., in some temporary memory structure. For example, a story for only a most recent change to any particular field is kept. In other embodiments, many previous stories may be kept in the feed. A time and/or date for each story can be tracked. Herein, a feed of a record is also referred to as an entity feed, as a record is an instance of a particular entity object of the database.

In step 350, followers of the first record can be identified. A follower is a user following (subscribing to a feed) of the first record. In one embodiment, when a user requests a feed of a particular record such an identification need not be done. In another embodiment where a record feed is pushed to a user (e.g., as part of a news feed), then the user can be identified as a follower of the first record. Accordingly, this step can be the identification of records and other objects being followed by a particular user.

In certain embodiments, the database system can store a list of the followers for a particular record. In various implementations, the list can be stored with the first record or associated with the record using an identifier (e.g., a pointer) to retrieve the list. For example, the list can be stored in a field of the first record. In other embodiments, a list of the records that a user is following is used. In some implementations, the database system can have a routine that runs for each user, where the routine polls the records in the list to determine if a new story has been added to a feed of the record. In other implementations, the routine for the user can be running at least partially on a user device, which contacts the database to perform the polling.

In step 360, the story is added to a feed of each follower. In some embodiments, the story is pushed to the feed of a user, e.g., by a routine that determines the followers for the record from a list associated with the record. In other embodiments, the story is pulled to a feed, e.g., by a user device. This pulling may occur when a user requests the feed, as occurs in step 370. Thus, these actions may occur in a different order. The creation of the feed for a pull may be a dynamic creation that identifies records being followed by the requesting user, generates the display version of relevant stories from stored information (e.g., event and field change), and adds the stories into the feed. A feed of stories of records and other objects that a user is following is also called a news feed.

In yet other embodiments, the story could be sent as an e-mail to the follower, instead of in a feed. In some implementations, e-mail alerts for events can enable people to be e-mailed when certain events occur. In other implementations, e-mails can be sent when there are posts on a user profile and posts on entities to which the user subscribes. In accordance with one implementation, a user can turn on/off email alerts for all or some events. In some embodiments, a user can specify what kind of stories to receive about a record that the user is following. For example, a user can choose to only receive stories about certain fields of a record that the user is following, and potentially about what kind of update was performed (e.g., a new value input into a specified field, or the creation of a new field).

In step 370, a follower can access his/her news feed to see the story. In some embodiments, the user has just one news feed for all of the records that the user is following. In one aspect, a user can access his/her own feed by selecting a particular tab or other object on a page of an interface to the database system. Once selected, the feed can be provided as a list, e.g., with an identifier (e.g., a time) or including some or all of the text of the story. In other embodiments, the user can specify how the stories are to be displayed and/or sent to the user. For example, a user can specify a font for the text, a location of where the feed can be selected and displayed, amount of text to be displayed, and other text or symbols to be displayed (e.g., importance flags).

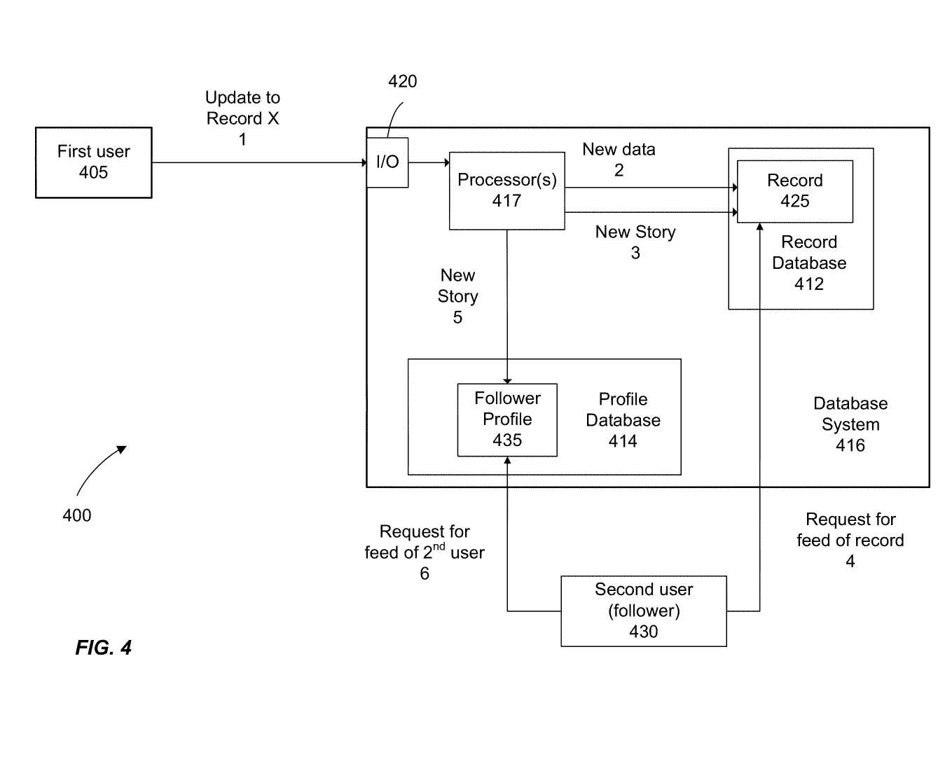

FIG. 4 is a block diagram 400 of components of a database system performing a method for tracking an update to a record according to embodiments. Block diagram 400 can perform embodiments of method 300, as well as embodiments of other method described herein.

A first user 405 sends a request 1 to update record 425 in database system 416. Although an update request is described, other events that are being tracked are equally applicable. In various embodiments, the request 1 can be sent via a user interface (e.g., 30 of FIG. 2) or an application program interface (e.g., API 32). An I/O port 420 can accommodate the signals of request 1 via any input interface, and send the signals to one or more processors 417. The processor 417 can analyze the request and determine actions to be performed. Herein, any reference to a processor 417 can refer to a specific processor or any set of processors in database system 416, which can be collectively referred to as processor 417.

Processor 417 can determine an identifier for record 425, and send commands 2 with the new data to record database 412 to update record 425. In some embodiments, record database 412 is where tenant data 112 is stored. The request 1 and new data commands 2 can be encapsulated in a single write transaction sent to record database 412. In an embodiment, multiple changes to records in the database can be made in a single write transaction.

Processor 417 can also analyze request 1 to determine whether a story is to be created, which at this point may include determining whether the event (e.g., a change to a particular field) is to be tracked. This determination can be based on an interaction (i.e., an exchange of data) with record database 412 and/or other databases, or based on information stored locally (e.g., in cache or RAM) at processor 417. In some embodiments, a list of record types that are being tracked can be stored. The list may be different for each tenant, e.g., as each tenant may configure the database system to their own specifications. Thus, if the record 425 is of a type not being tracked, then the determination of whether to create a story can stop there.

The same list or a second list (which can be stored in a same location or a different location) can also include the fields and/or events that are tracked for the record types in the first list. This list can be searched to determine if the event is being tracked. A list may also contain information having the granularity of listing specific records that are to be tracked (e.g., if a tenant can specify the particular records to be tracked, as opposed to just type).

As an example, processor 417 may obtain an identifier associated with record 425 (e.g., obtained from request 1 or database 412), potentially along with a tenant identifier, and cross-reference the identifier with a list of records for which stories are to be created. Specifically, the record identifier can be used to determine the record type and a list of tracked types can be searched for a match. The specific record may also be checked if such individual record tracking was enabled. The name of the field to be changed can also be used to search a list of tracking-enabled fields. Other criteria besides field and events can be used to determine whether a story is created, e.g., type of change in the field. If a story is to be generated, processor 417 can then generate the story.

In some embodiments, a story is created dynamically when a feed (e.g., the entity feed of record 425) is requested. Thus, a story can be created when a user requests the entity feed for record 425. The story may be created (e.g., assembled), including re-created, each time the entity feed is to be displayed to any user. One or more history tables can keep track of previous events so that the story can be re-created.

In other embodiments, a story can be created at the time the event occurs, and the story can be added to a list of feed items. The list of feed items may be specific to record 425, or may be an aggregate of feed items including feed items for many records. Such an aggregate list can include a record identifier so that the feed items for the entity feed of record 425 can be easily retrieved. For example, after the story has been generated, processor 417 can add the new story 3 to a feed of record 425. As mentioned above, the feed can be stored in a field (e.g., as a child object) of record 425. In other embodiments, the feed can be stored in another location or in another database, but with a link (e.g., a connecting identifier) to record 425. The feed can be organized in various ways, e.g., as a linked list, an array, or other data structure.

A second user 430 can access the new story 3 in various ways. In some embodiments, second user 430 can send a request 4 for the record feed. For example, second user 430 can access a home page (detail page) of the record 425 (e.g., with a query or by browsing), and the feed can be obtained through a tab, button, or other activation object on the page. The feed can be displayed on the screen or downloaded.

In other embodiments, processor 417 can add the new story in a step 5 to a feed (e.g., a news feed) of a user that is following record 425. The processor 417 can determine each of the followers of record 425 by accessing a list of the users that have been registered as followers. This determination can be done for each new event (e.g., update 1). In other implementations, processor 417 can poll (e.g., with a query) the records that second user 430 is following to determine when new stories (or other feed items) are available. Processor 417 can use a follower profile 435 of second user 430, which can contain a list of the records that the second user 430 is following. Such a list can be contained in other parts of the database as well. Second user 430 can then send a request 6 to his/her profile 435 to obtain a feed, which contains the new story. The user's profile 435 can be stored in a profile database 414, which can be the same or different than database 412.

In some embodiments, a user can define a news feed to include new stories from various records, which may be limited to a maximum number. In some embodiments, each user has one news feed. In other embodiments, the follower profile 435 can include the specifications of each of the records to be followed (with the criteria for what stories are to be provided and how they are displayed), as well as the feed.

Some embodiments can provide various types of record feeds. Entity Feeds can exist for records, e.g., of type Account, Opportunity, Case, and Contact. An entity feed can tell a user about the actions that people have taken on that particular record or on one its related records. The entity feed can include who made the action, which field was changed, and the old and new values. Entity feeds can exist on all supported records as a list that is linked to the specific record. For example, a feed could be stored in a field that allows lists (e.g., linked lists) or as a child object.

IV. Tracking Actions of a User

In addition to knowing about events associated with a particular record, it can be helpful for a user to know what a particular user is doing. In particular, it might be nice to know what the user is doing without the user having to generate the story (e.g., a user submitting a synopsis of what the user has done). Accordingly, embodiments can automatically track actions of a user that trigger events, and stories can be generated for certain events.

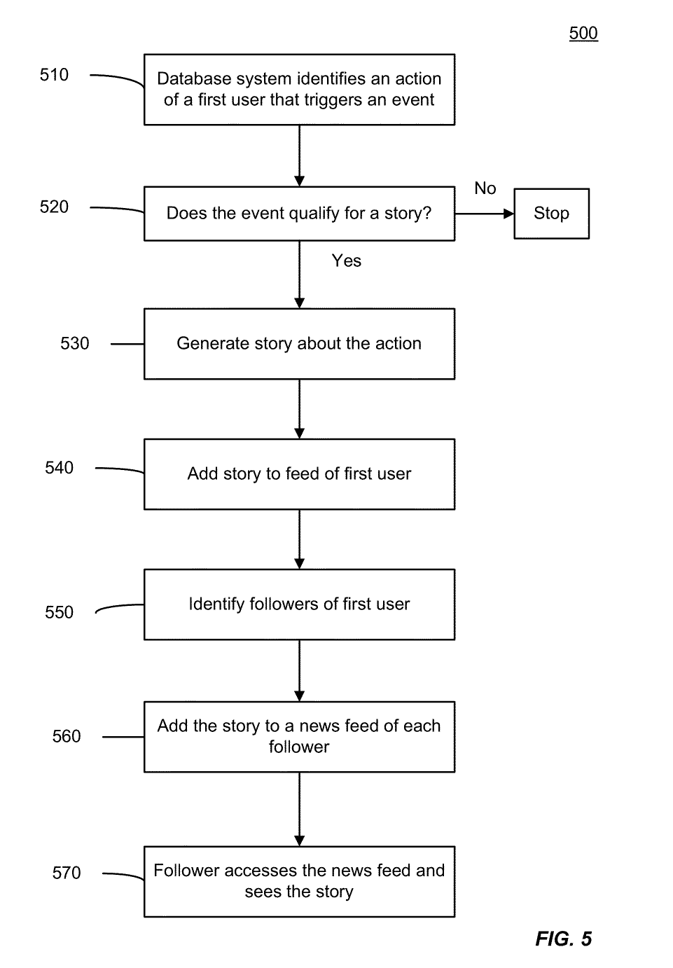

FIG. 5 is a flowchart of a method 500 for tracking actions of a user of a database system according to embodiments. Method 500 may be performed in addition to method 300. The manner of implementing method 300, including order of steps, can also be applied to method 500 and other methods described herein. Thus, a feed can be composed of changes to a record and actions of users.

In step 510, a database system (e.g., 16) identifies an action of a first user. In some embodiments, the action triggers an event, and the event is identified. For example, the action of a user requesting an update to a record can be identified, where the event is receiving a request or is the resulting update of a record. The action may thus be defined by the resulting event. In another embodiment, only certain types of actions (events) are identified. Which actions are identified can be set as a default or can be configurable by a tenant, or even configurable at a user level. In this way, processing effort can be reduced since only some actions are identified.

In step 520, it is determined whether the event qualifies for a story. In some embodiments, a predefined list of events (e.g., as mentioned herein) can be created so that only certain actions are identified. An administrator (or other user) of a tenant can specify the type of actions (events) for which a story is to be generated. This step may also be performed for method 300.

In step 530, a story is generated about the action. In an example where the action is an update of a record, the story can be similar or the same as the story created for the record. The description can be altered though to focus on the user as opposed to the record. For example, “John D. has closed a new opportunity for account XYZ” as opposed to “an opportunity has been closed for account XYZ.”

In step 540, the story is added to a profile feed of the first user. In some embodiments, a feed for a particular user can be accessed on a page of the user's profile, in a similar manner as a record feed can be accessed on a detail page of the record. In other embodiments, the first user may not have a profile feed and the story may just be stored temporarily before proceeding. A profile feed of a user can be stored associated with the user's profile. This profile feed can be added to a news feed of another user.

In step 550, followers of the first user are identified. In some embodiments, a user can specify which type of actions other users can follow. Similarly, a follower can select what actions by a user the follower wants to follow. In an embodiment where different followers follow different types of actions, which users are followers of that user and the particular action can be identified, e.g., using various lists that track what actions and criteria are being followed by a particular user. In various embodiments, the followers of the first user can be identified in a similar manner as followers of a record, as described above for step 350.

In step 560, the story is added to a news feed of each follower of the first user. The story can be added in a similar manner as the feed items for a record feed. The news feed can contain stories both about users and records. In other embodiments, a user can specify what kind of stories to receive about a user that the user is following. For example, a user could specify stories with particular keywords, of certain types of records, of records owned or created by certain users, particular fields, and other criteria as mentioned herein.

In step 570, a follower accesses the news feed and sees the story. In some embodiments, the user has just one news feed for all of the records that the user is following. In other embodiments, a user can access his/her own feed (i.e., feed about his/her own actions) by selecting a particular tab or other object on a page of an interface to the database system. Thus, a feed can include stories about what other users are doing in the database system. When a user becomes aware of a relevant action of another user, the user can contact the co-worker, thereby fostering teamwork.

V. Generation of a Story

As described above, some embodiments can generate text describing events (e.g., updates) that have occurred for a record and actions by a user that trigger an event. A database system can be configured to generate the stories for various events in various ways.

A. Which Events to Generate a Story for

In a database system, there are various events that can be detected. However, the operator of the database system and/or a tenant may not want to detect every possible event as this could be costly with regards to performance. Accordingly, the operator and/or the tenant can configure the database system to only detect certain events. For example, an update of a record may be an event that is to be detected.

Out of the events that are detected, a tenant (including a specific user of the tenant) may not want a story about each detected event. For example, all updates to a record may be identified at a first level. Then, based on specifications of an administrator and/or a specific user of a tenant, another level of inquiry can be made as to whether a story is to be generated about the detected event. For example, the events that qualify for a story can be restricted to changes for only certain fields of the record, which can differ depending on which user is receiving the feed. In one embodiment, a database system can track whether an event qualifies for a story for any user, and once the story is generated, it can be determined who is to receive the story.

Supported events (events for which a story is generated) can include actions for standard fields, custom fields, and standard related lists. Regarding standard fields, for the entity feed and the profile feed, a standard field update can trigger a story to be published to that feed. In one embodiment, which standard field can create a story can be set by an administrator to be the same for every user. In another embodiment, a user can set which standard fields create a story for that user's news feed. Custom fields can be treated the same or differently than standard fields.

The generation of a feed item can also depend on a relationship of an object to other objects (e.g., parent-child relationships). For example, if a child object is updated, a story may be written to a feed of a parent of the child object. The level of relationship can be configured, e.g., only 1 level of separation (i.e. no grandparent-grandchild relationship). Also, in one embodiment, a story is generated only for objects above the objects being updated, i.e., a story is not written for a child when the parent is updated.

In some embodiments, for related lists of a record, a story is written to its parent record (1 level only) when the related list item is added, and not when the list item is changed or deleted. For example: user A added a new opportunity XYZ for account ABC. In this manner, entity feeds can be controlled so as not to be cluttered with stories about changes to their related items. Any changes to the related list item can be tracked on their own entity feed, if that related list item has a feed on it. In this embodiment, if a user wants to see a feed of the related list item then the user can subscribe to it. Such a subscription might be when a user cares about a specific opportunity related to a specific account. A user can also browse to that object's entity feed. Other embodiments can create a story when a related entity is changed or deleted.

In one embodiment, an administrator (of the system or of a specific tenant) can define which events of which related objects are to have stories written about them in a parent record. In another embodiment, a user can define which related object events to show. In one implementation, there are two types of related lists of related objects: first class lookup and second class lookup. Each of the records in the related lists can have a different rule for whether a story is generated for a parent record. Each of these related lists can be composed as custom related lists. In various embodiments, a custom related list can be composed of custom objects, the lists can contain a variety of records or items (e.g., not restricted to a particular type of record or item), and can be displayed in a customized manner.

In some embodiments, a first class lookup contains records of a child record that can exist by itself. For example, the contacts on an account exist as a separate record and also as a child record of the account. In other embodiments, a record in a first class lookup can have its own feed, which can be displayed on its detail page.

In one embodiment, a second class lookup can have line items existing only in the context of their parent record (e.g., activities on an opportunity, contact roles on opportunity/contact). In one implementation, the line items are not objects themselves, and thus there is no detail page, and no place to put a feed. In another implementation, a change in a second class lookup can be reported on the feed of the parent.

Some embodiments can also create stories for dependent field changes. A dependent field change is a field that changes value when another field changes, and thus the field has a value that is dependent on the value of the other field. For example, a dependent field might be a sum (or other formula) that totals values in other fields, and thus the dependent field would change when one of the fields being summed changes. Accordingly, in one embodiment, a change in one field could create stories for multiple fields. In other embodiments, stories are not created for dependent fields.

B. how the Story is Generated

After it is determined that a story is going to be generated, some embodiments can also determine how the story is generated. In one embodiment, different methods can be used for different events, e.g., in a similar fashion as for the configurability of which events stories are generated. A story can also include a description of multiple events (e.g., john changed the account status and amount).

In one embodiment, the story is a grammatical sentence, thereby being easily understandable by a person. In another embodiment, the story provides detailed information about the update. In various examples, an old value and new value for a field may be included in the story, an action for the update may be provided (e.g., submitted for approval), and the names of particular users that are responsible for replying or acting on the story may be also provided. The story can also have a level of importance based on settings chosen by the administrator, a particular user requesting an update, or by a following user who is to receive the story, which fields is updated, a percentage of the change in a field, the type of event, or any combination of these factors.

The system may have a set of heuristics for creating a story from the event (e.g., a request to update). For example, the subject may be the user, the record, or a field being added or changed. The verb can be based on the action requested by the user, which can be selected from a list of verbs (which may be provided as defaults or input by an administrator of a tenant). In one embodiment, stories can be generic containers with formatting restrictions.

As an example of a creation of a new record “Mark Abramowitz created a new Opportunity IBM-20,000 laptops with Amount as $3.5M and Sam Palmisano as Decision Maker.” This event can be posted to the profile feed for Mark Abramowitz and the entity feed for record of Opportunity for IBM-20,000 laptops. The pattern can be given by (AgentFullName) created a new (ObjectName)(RecordName) with [(FieldName) as (FieldValue) [,/and]]*[[added/changed/removed] (RelatedListRecordName) [as/to/as] (RelatedListRecordValue) [,/and]]*. Similar patterns can be formed for a changed field (standard or custom) and an added child record to a related list.

VI. Tracking Commentary from or about a User

Some embodiments can also have a user submit text, instead of the database system generating a story. As the text is submitted by users, the text (also referred generally as messages) can be about any topic. Thus, more information than just actions of a user and events of a record can be conveyed. In one embodiment, the messages can be used to ask a question about a particular record, and users following the record can provide responses (comments).

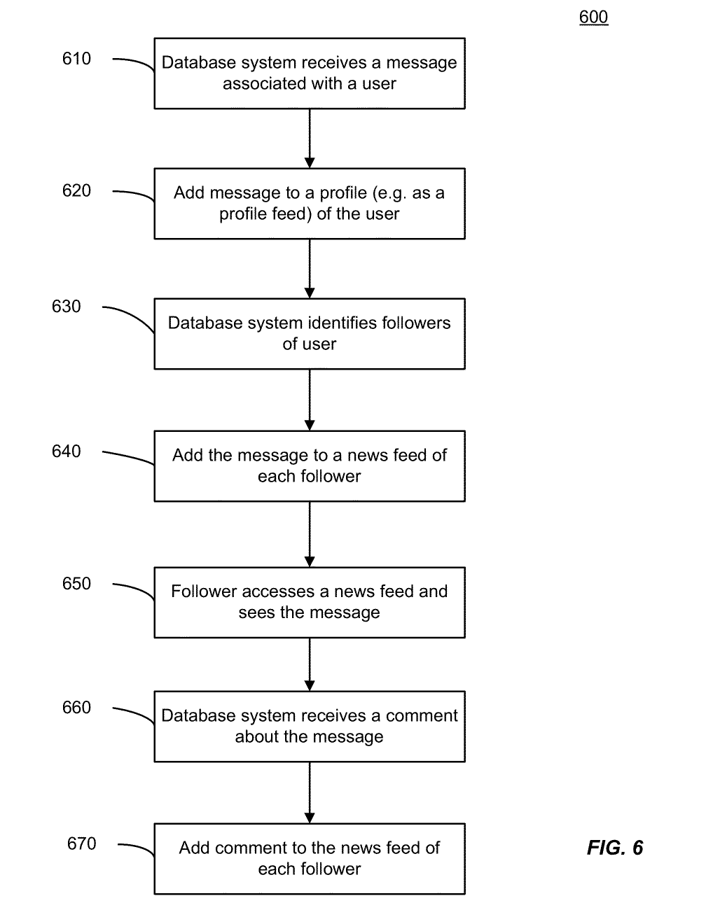

FIG. 6 is a flowchart of a method 600 for creating a news feed that includes messages associated with a first user according to embodiments. In one embodiment, method 600 can be combined with methods 300 and 500. In one aspect, a message can be associated with the first user when the first user creates the message (e.g., a post or comment about a record or another user). In another aspect, a message can be associated with the first user when the message is about the first user (e.g., posted by another user on the first user's profile feed).

In step 610, database system receives a message (e.g., a post or status) associated with a first user. The message (e.g., a post or status update) can contain text submitted by another user or by the first user. In one embodiment, a post is for a section of the first user's profile where any user can add a post, and where multiple posts can exist. Thus, a post can appear on the first user's profile and can be viewed when the first user's profile is visited. For a message about a record, the post can appear on a detail page of a record. Note the message can appear in other feeds as well. In another embodiment, a status update about the first user can only be added by the first user. In one implementation, a user can only have one status message.

In step 620, the message is added to a profile of the first user. In one implementation, the message can be added to a profile feed of the first user, which is associated (e.g., as a related list) with the first user's profile. In one embodiment, the posts are listed indefinitely. In another embodiment, only the most recent posts (e.g., last 50) are kept in the profile feed. Such embodiments can also be employed with stories. In yet another embodiment, the message can be added to a profile of the user adding the message.

In step 630, database system identifies followers of the first user. In one embodiment, the database system can identify the followers as described above for method 500. In various embodiments, a follower can select to follow a feed about the actions of the first user, messages about the first user, or both (potentially in a same feed).

In step 640, the message is added to a news feed of each follower. In one embodiment, the message is only added to a news feed of a particular follower if the message matches some criteria, e.g., the message includes a particular keyword or other criteria. In another embodiment, a message can be deleted by the user who created the message. In one implementation, once deleted by the author, the message is deleted from all feeds to which the message had been added.

In step 650, the follower accesses a news feed and sees the message. For example, the follower can access a news feed on the user's own profile page. As another example, the follower can have a news feed sent to his/her own desktop without having to first go to a home page.

In step 660, database system receives a comment about the message. The database system can add the comment to a feed of the same first user, much as the original message was added. In one embodiment, the comment can also be added to a feed of the user adding the comment. In one implementation, users can also reply to the comment. In another embodiment, users can add comments to a story, and further comments can be associated with the story. In yet another embodiment, making a comment or message is not an action to which a story is created. Thus, the message may be the only feed item created from such an action.

In one implementation, if a story (or post) is deleted, its corresponding comments are deleted as well. In another embodiment, new comments on a story (or post) do not update the story timestamp. Also, the story or post can continue to be shown in a feed (profile feed, record feed, or news feed) if it has had a comment within a specified timeframe (e.g., within the last week). Otherwise, the story (post) can be removed in an embodiment.

In some embodiments, all or most stories can be commented on. In other embodiments, stories for certain records (e.g., cases or ideas) are not commentable. In various embodiments, comments can be made for any one or more records of opportunities, accounts, contacts, leads, and custom objects.

In step 670, the comment is added to a news feed of each follower. In one embodiment, a user can make the comment within the user's news feed. Such a comment can propagate to the appropriate profile feed or record feed, and then to the news feeds of the following users. Thus, feeds can include what people are saying, as well as what they are doing. In one aspect, feeds are a way to stay up-to-date (e.g., on users, opportunities, etc.) as well as an opportunity to reach out to your co-workers/partners and engage them around common goals.

In some embodiments, users can rate stories or messages (including comments). A user can choose to prioritize a display of a feed so that higher rated feed items show up higher on a display. For example, in an embodiment where comments are answers to a specific question, users can rate the different status posts so that a best answer can be identified. As another example, users are able to quickly identify feed items that are most important as those feed items can be displayed at a top of a list. The order of the feed items can be based on an importance level (which can be determined by the database system using various factors, some of which are mentioned herein) and based on a rating from users. In one embodiment, the rating is on a scale that includes at least three values. In another embodiment, the rating is based on a binary scale.

Besides a profile for a user, a group can also be created. In various embodiments, the group can be created based on certain criteria that are common to the users, can be created by inviting users, or can be created by receiving requests to join from a user. In one embodiment, a group feed can be created, with messages being added to the group feed when someone adds a message to the group as a whole. For example, a group page may have a section for posts. In another embodiment, a message can be added to a group feed when a message is added about any one of the members. In yet another embodiment, a group feed can include stories about actions of the group as a whole (e.g., when an administrator changes data in a group profile or a record owned by the group), or about actions of an individual member.

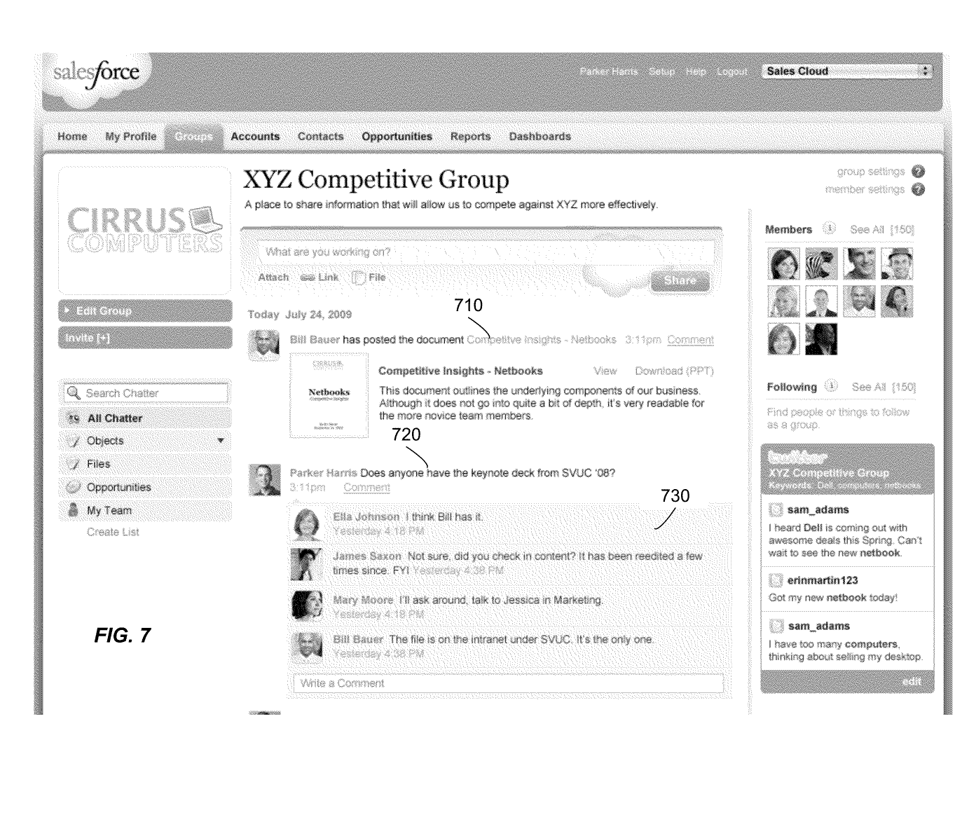

FIG. 7 shows an example of a group feed on a group page according to embodiments. As shown, a feed item 710 shows that a user has posted a document to the group object. The text “Bill Bauer has posted the document Competitive Insights” can be generated by the database system in a similar manner as stories about a record being changed. A feed item 720 shows a post to the group, along with comments 730.

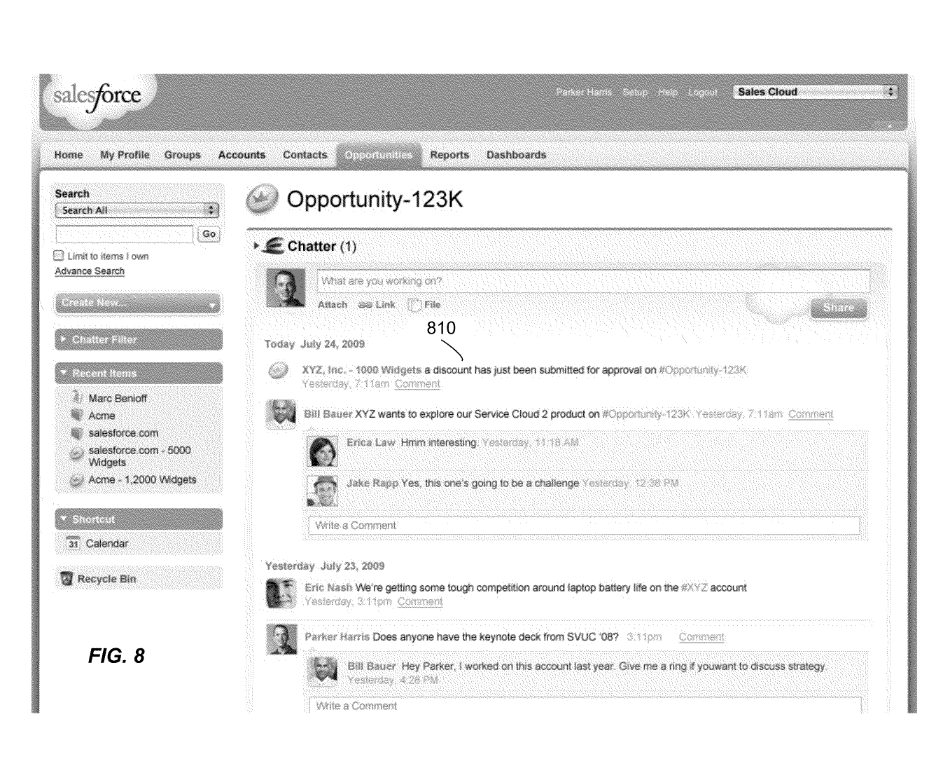

FIG. 8 shows an example of a record feed containing a story, post, and comments according to embodiments. Feed item 810 shows a story based on the event of submitting a discount for approval. Other feed items show posts that are made to the record and comments that are made on the posts.

VII. Infrastructure for a Feed

A. Tables Used to Create a Feed

FIG. 9A shows a plurality of tables that may be used in tracking events and creating feeds according to embodiments. The tables of FIG. 9A may have entries added, or potentially removed, as part of tracking events in the database from which feed items are creates or that correspond to feed items. In one embodiment, each tenant has its own set of tables that are created based on criteria provided by the tenant.

An event history table 910 can provide a history of events from which feed items are created. In one aspect, the events are for objects that are being tracked. Thus, table 910 can store change histories for feeds, and the changes can be persisted. In various embodiments, event history table 910 can have columns of event ID 911, object ID 912 (also called parent ID), and created by ID 913. The event ID 911 can uniquely identify a particular event and can start at 1 (or other number or value).

Each new event can be added chronologically with a new event ID, which may be incremented in order. An object ID 912 can be used to track which record or user's profile is being changed. For example, the object ID can correspond to the record whose field is being changed or the user whose feed is receiving a post. The created by ID 913 can track the user who is performing the action that results in the event, e.g., the user that is changing the field or that is posting a message to the profile of another user.

In some other embodiments, event history table 910 can have one or more of the following variables with certain attributes: ORGANIZATION_ID being CHAR(15 BYTE), FEEDS_ENTITY_HISTORY_ID being CHAR(15 BYTE), PARENT_ID being CHAR(15 BYTE), CREATED_BY being CHAR(15 BYTE), CREATED_DATE being a variable of type DATE, DIVISION being a NUMBER, KEY_PREFIX being CHAR(3 BYTE), and DELETED being CHAR(1 BYTE). The parent ID can provide an ID of a parent object in case the change is promulgated to the parent. The key prefix can provide a key that is unique to a group of records, e.g., custom records (objects). The deleted variable can indicate that the feed items for the event are deleted, and thus the feed items are not generated. In one embodiment, the variables for each event entry or any entry in any of the tables may not be nullable. In another embodiment, all entries in the event history table 910 are used to create feed items for only one object, as specified by the object ID 912. For example, one story cannot communicate updates on two records, such as updates of an account field and an opportunity field.

In one embodiment, a name of an event can also be stored in table 910. In one implementation, a tenant can specify events that they want tracked. In an embodiment, event history table 910 can include the name of the field that changed (e.g., old and new values). In another embodiment, the name of the field, and the values, are stored in a separate table. Other information about an event (e.g., text of comment, story, post or status update) can be stored in event history table 910, or in other tables, as is now described.

A field change table 920 can provide a history of the changes to the fields. The columns of table 920 can include an event ID 921 (which correlates to the event ID 911), an old value 922 for the field, and the new value 923 for the field. In one embodiment, if an event changes more than one field value, then there can be an entry for each field changed. As shown, event ID 921 has two entries for event E37.

In some other embodiments, field change table 920 can have one or more of the following variables with certain attributes: ORGANIZATION_ID being CHAR(15 BYTE), FEEDS_ENTITY_HISTORY_FIELDS_ID being CHAR(15 BYTE) and identifying each entry, FEEDS_ENTITY_HISTORY_ID being CHAR(15 BYTE), FIELD_KEY being VARCHAR2(120 BYTE), DATA_TYPE being CHAR(1 BYTE), OLDVAL_STRING being VARCHAR2 (765 BYTE), NEWVAL_STRING being VARCHAR2(765 BYTE), OLDVAL_FIRST_NAME being VARCHAR2(765 BYTE), NEWVAL_FIRST_NAME being VARCHAR2(765 BYTE), OLDVAL_LAST_NAME being VARCHAR2(765 BYTE), NEWVAL_LAST_NAME being VARCHAR2(765 BYTE), OLDVAL_NUMBER being NUMBER, NEWVAL_NUMBER being NUMBER, OLDVAL_DATE being DATE, NEWVAL_DATE being DATE, and DELETED being CHAR(1 BYTE). In one embodiment, one or more of the variables for each entry in any of the tables may be nullable.

In one embodiment, the data type variable (and/or other variables) is a non-api-insertable field. In another embodiment, variable values can be derived from the record whose field is being changed. Certain values can be transferred into typed columns old/new value string, old/new value number or old/new value date depending upon the derived values. In another embodiment, there can exist a data type for capturing add/deletes for child objects. The child ID can be tracked in the foreign-key column of the record. In yet another embodiment, if the field name is pointing to a field in the parent entity, a field level security (FLS) can be used when a user attempts to a view a relevant feed item. Herein, security levels for objects and fields are also called access checks and determinations of authorization. In one aspect, the access can be for create, read, write, update, or delete of objects.

In one embodiment, the field name (or key) can be either a field name of the entity or one of the values in a separate list. For example, changes that do not involve the update of an existing field (e.g., a close or open) can have a field name specified in an enumerated list. This enumerated list can store “special” field name sentinel values for non-update actions that a tenant wants to track. In one aspect, the API just surfaces these values and the caller has to check the enumerated values to see if it is a special field name.

A comment table 930 can provide a history of the comments made regarding an event, e.g., a comment on a post or a change of a field value. The columns of table 930 can include an event ID 921 (which correlates to the event ID 911), the comment column 932 that stores the text of the comment, and the time/date 933 of the comment. In one embodiment, there can be multiple comments for each event. As shown, event ID 921 has two entries for event E37.

In some other embodiments, comment table 930 can have one or more of the following variables with certain attributes: ORGANIZATION_ID being CHAR(15 BYTE), FEEDS_COMMENTS_ID being CHAR(15 BYTE) and uniquely identifying each comment, PARENT_ID being CHAR(15 BYTE), CREATED_BY being CHAR(15 BYTE), CREATED_DATE being DATE, COMMENTS being VARCHAR2(420 BYTE), and DELETED being CHAR(1 BYTE).

A user subscription table 940 can provide a list of the objects being followed (subscribed) by a user. In one embodiment, each entry has a user ID 941 of the user doing the following and one object ID 942 corresponding to the object being followed. In one implementation, the object being followed can be a record or a user. As shown, the user with ID U819 is following object IDs O615 and O489. If user U819 is following other objects, then additional entries may exist for user U819. Also as shown, user U719 is also following object O615. The user subscription table 940 can be updated when a user adds or deletes an object that is being followed.

In some other embodiments, comment table 940 can be composed of two tables (one for records being followed and one for users being followed). One table can have one or more of the following variables with certain attributes: ORGANIZATION_ID being CHAR(15 BYTE), ENTITY_SUBSCRIPTION_ID being CHAR(15 BYTE), PARENT_ID being CHAR(15 BYTE), CREATED_BY being CHAR(15 BYTE), CREATED_DATE being DATE, and DELETED being CHAR(1 BYTE). Another table can have one or more of the following variables with certain attributes: ORGANIZATION_ID being CHAR(15 BYTE), USER_SUBSCRIPTIONS_ID being CHAR(15 BYTE), USER_ID being CHAR(15 BYTE), CREATED_BY being CHAR(15 BYTE), and CREATED_DATE being DATE.

In one embodiment, regarding a profile feed and a news feed, these are read-only views on the event history table 910 specialized for these feed types. Conceptually the news feed can be a semi-join between the entity subscriptions table 940 and the event history table 910 on the object IDs 912 and 942 for the user. In one aspect, these entities can have polymorphic parents and can be subject to a number of restrictions detailed herein, e.g., to limit the cost of sharing checks.

In one embodiment, entity feeds are modeled in the API as a feed associate entity (e.g., AccountFeed, CaseFeed, etc.). A feed associate entity includes information composed of events (e.g., event IDs) for only one particular record type. Such a list can limit the query (and sharing checks) to a specific record type. In one aspect, this structuring of the entity feeds can make the query run faster. For example, a request for a feed of a particular account can include the record type of account. In one implementation, an account feed table can then be searched, where the table has account record IDs and corresponding event IDs or pointers to particular event entries in event history table 910. Since the account feed table only contains some of the records (not all), the query can run faster.

In one embodiment, there may be objects with no events listed in the event history table 910, even though the record is being tracked. In this case, the database service can return a result indicating that no feed items exist.

In another embodiment, tables can also exist for audit tracking, e.g., to examine that operations of the system (e.g., access checks) are performing accurately. In one embodiment, audit change-history tables can be persisted (e.g., in bulk) synchronously in the same transaction as feed events are added to event history table 910. In another embodiment, entries to the two sets of table can be persisted in asynchronous manner (e.g., by forking a bulk update into a separate java thread). In one aspect, some updates to any of the tables can get lost if the instance of the table goes down while the update has not yet finished. This asynchronous manner can limit an impact performance on save operations. In some embodiments, a field “persistence type” (tri state: AUDIT, FEEDS or BOTH) can be added to capture user preferences, as opposed to being hardcoded.

B. FeedItem

A feed item can represent an individual field change of a record, creation and deletion of a record, or other events being tracked for a record or a user. In one embodiment, all of the feed items in a single transaction (event) can be grouped together and have the same event ID. A single transaction relates to the operations that can be performed in a single communication with the database. In another embodiment where a feed is an object of the database, a feed item can be a child of a profile feed, news feed, or entity feed. If a feed item is added to multiple feeds, the feed item can be replicated as a child of each feed to which the feed item is added.

In one implementation, a feed item is visible only when its parent feed is visible, which can be the same as needing read access on the feed's parent (which can be by the type of record or by a specific record). The feed item's field may be only visible when allowed under field-level security (FLS). Unfortunately, this can mean that the parent feed may be visible, but the child may not be because of FLS. Such access rules are described in more detail below. In one embodiment, a feed item can be read-only. In this embodiment, after being created, the feed item cannot be changed.

In multi-currency organizations, a feed item can have an extra currency code field. This field can give the currency code for the currency value in this field. In one aspect, the value is undefined when the data type is anything other than currency.

C. FeedComment

In some embodiments, a comment exists as an item that depends from stories, posts, status updates, and other items that are independent of each other. Thus, a feed comment object can exist as a child object of a feed item object. For example, comment table 930 can be considered a child table of event history table 910. In one embodiment, a feed comment can be a child of a profile feed, news feed, or entity feed that is separate from other feed items.

In various embodiments, a feed comment can have various permissions for the following actions. For read permission, a feed comment can be visible if the parent feed is visible. For create permission, if a user has access to the feed (which can be tracked by the ID of the parent feed), the user can add a comment. For delete, only a user with modify all data permission or a user who added the comment can delete the comment. Also delete permission can require access on the parent feed. An update of a comment can be restricted, and thus not be allowed.

In one embodiment, regarding a query restriction, a feed comment cannot be queried directly, but can be queried only via the parent feed. An example is “select id, parentid, (select . . . from feedcomment) from entityfeed”. In another embodiment, a feed comment can be directly queries, e.g., by querying comment table 930. A query could include the text of a comment or any other column of the table.

In another embodiment, regarding soft delete behavior, a feed comment table does not have a soft delete column. A soft delete allows an undelete action. In one implementation, a record can have a soft delete. Thus, when the record is deleted, the feed (and its children) can be soft deleted. Therefore, in one aspect, a feed comment cannot be retrieved via the “query” verb (which would retrieve only the comment), but can be retrieved via “queryAll” verb though. An example is queryAll(“select id, (select id, commentbody from feedcomments) from accountfeed where parentid=‘001x000xxx3MkADAA0’”); // where ‘001x000xxx3MkADAA0’ has been soft deleted. When a hard delete (a physical delete) happens, the comment can be hard deleted from the database.

In one embodiment, regarding an implicit delete, feeds with comments are not deleted by a reaper (a routine that performs deletion). In another embodiment, a user cannot delete a feed. In yet another embodiment, upon lead convert (e.g., to an opportunity or contact), the feed items of the lead can be hard deleted. This embodiment can be configured to perform such a deletion for any change in record type. In various implementations, only the comments are hard deleted upon a lead convert, other convert, or when the object is deleted (as mentioned above).

In one embodiment, viewing a feed pulls up the most recent messages or stories (e.g., 25) and searches the most recent (e.g., 4) comments for each feed item. The comments can be identified via the comment table 930. In one implementation, a user can request to see more comments, e.g., by selecting a see more link.

In some embodiments, user feeds and/or entity feeds have a last comment date field. In various embodiments, the last comment date field is stored as a field of a record or a user profile. For feeds with no comments, this can be the same as the created date. Whenever a new comment is created, the associated feed's last comment date can be updated with the created date of the comment. The last comment date is unchanged if a feed comment is deleted. A use case is to allow people to order their queries to see the feeds which have been most recently commented on.

D. Creating Custom Feeds by Customizing the Event History Table

In some embodiments, a tenant (e.g., through an administrator) or a specific user of a tenant can specify the types of events for which feed items are created. A user can add more events or remove events from a list of events that get added to the event history table 910. In one embodiment, a trigger can be added as a piece of code, rule, or item on a list for adding a custom event to the event history table 910. These custom events can provide customers the ability to create their own custom feeds and custom feed items to augment or replace implicitly generated feeds via event history table 910. Implicitly generated feed data can be created when feed-tracking is enabled for certain entities/field-names. In one embodiment, in order to override implicit feeds, feed tracking can be turned off and then triggers can be defined by the user to add events to the event history table 910. In other embodiments, users are not allowed to override the default list of events that are added to table 910, and thus cannot define their own triggers for having events tracked.

For example, upon lead convert or case close, a default action to be taken by the system may be to add multiple events to event history table 910. If a customer (e.g., a tenant or a specific user) does not want each of these events to show up as feed items, the customer can turn off tracking for the entities and generate custom feeds by defining customized triggers (e.g., by using an API) upon the events. As another example, although data is not changed, a customer may still want to track an action on a record (e.g., status changes if not already being tracked, views by certain people, retrieval of data, etc.).

In one embodiment, if a user does not want a feed item to be generated upon every change on a given field, but only if the change exceeds a certain threshold or range, then such custom feeds can be conditionally generated with the customized triggers. In one implementation, the default tracking for the record or user may be turned off for this customization so that the events are only conditionally tracked. In another implementation, a trigger can be defined that deletes events that are not desired, so that default tracking can still be turned on for a particular object type. Such conditional tracking can be used for other events as well.

In some embodiments, defining triggers to track certain events can be done as follows. A user can define an object type to track. This object type can be added to a list of objects that can be tracked for a particular tenant. The tenant can remove object types from this list as well. Custom objects and standard objects can be on the list, which may, for example, be stored in cache or RAM of a server or in the database. Generally only one such list exists for a tenant, and users do not have individual lists for themselves, although in some embodiments, they may particularly when the number of users in a tenant is small.

In one embodiment, a tenant can select which records of an object type are to be tracked. In another embodiment, once an object type is added to the tracking list of object types, then all records of that type are tracked. The tenant can then specify the particulars of how the tracking is to be performed. For example, the tenant can specify triggers as described above, fields to be tracked, or any of the customizations mentioned herein.

In some embodiments, when a feed is defined as an object in the database (e.g., as a child object of entity records that can be tracked), a particular instance of the feed object (e.g., for a particular record) can be create-able and delete-able. In one embodiment, if a user has access to a record then the user can customize the feed for the record. In one embodiment, a record may be locked to prevent customization of its feed.

One method of creating a custom feed for users of a database system according to embodiments is now described. Any of the following steps can be performed wholly or partially with the database system, and in particular by one or more processor of the database system.

In step A, one or more criteria specifying which events are to be tracked for possible inclusion into a feed to be displayed are received from a tenant. In step B, data indicative of an event is received. In step C, the event is analyzed to determine if the criteria are satisfied. In step D, if the criteria are satisfied, at least a portion of the data is added to a table (e.g., one or more of the tables in FIG. 9A) that tracks events for inclusion into at least one feed for a user of the tenant. The feed in which feed items of an event may ultimately be displayed can be a news feed, record feed, or a profile feed.

E. Creating Custom Feeds with Filtering

After feed items have been generated, they can be filtered so that only certain feed items are displayed, which may be tailored to a specific tenant and/or user. In one embodiment, a user can specify changes to a field that meet certain criteria for the feed item to show up in a feed displayed to the user, e.g., a newsfeed or even an entity feed displayed directly to the user. In one implementation, the criteria can be combined with other factors (e.g., number of feed items in the feed) to determine which feed items to display. For instance, if a small number of feed items exist (e.g. below a threshold), then all of the feed items may be displayed.

In one embodiment, a user can specify the criteria via a query on the feed items in his/her new feed, and thus a feed may only return objects of a certain type, certain types of events, stories about certain fields, and other criteria mentioned herein. Messages can also be filtered according to some criteria, which may be specified in a query. Such an added query can be added onto a standard query that is used to create the newsfeed for a user. A first user could specify the users and records that the first user is following in this manner, as well as identify the specific feed items that the first user wants to follow. The query could be created through a graphical interface or added by a user directly in a query language. Other criteria could include receiving only posts directed to a particular user or record, as opposed to other feed items.

In one embodiment, the filters can be run by defining code triggers, which run when an event, specific or otherwise, occurs. The trigger could then run to perform the filtering at the time the event occurs or when a user (who has certain defined triggers, that is configured for a particular user) requests a display of the feed. A trigger could search for certain terms (e.g., vulgar language) and then remove such terms or not create the feed item. A trigger can also be used to send the feed item to a particular person (e.g., an administrator) who does not normally receive the feed item were it not for the feed item containing the flagged terms.

F. Access Checks

In one embodiment, a user can access a feed of a record if the user can access the record. The security rules for determining whether a user has access to a record can be performed in a variety of ways, some of which are described in U.S. Pat. No. 8,095,531, titled “Methods and Systems for Controlling Access to Custom Objects in a Database.” For example, a security level table can specify whether a user can see a particular type of record and/or particular records. In one implementation, a hierarchy of positions within a tenant is used. For example, a manager can inherit the access levels of employees that the manager supervises. Field level security (FLS) can also be used to determine whether a particular story about an update to a field can be seen by the user. The field change table 920 can be used to identify a field name or field ID, and then whether the user has read access to that field can be determined from an FLS table. For example, if a user could not see a field of a social security number, the feed of the user provided to the user would not include any feed items related to the social security number field.

In one embodiment, a user can edit a feed of a record if the user has access to the record, e.g., deleting or editing a feed item. In another embodiment, a user (besides an administrator) cannot edit a feed item, except for performing an action from which a feed item can be created. In one implementation, a user is required to have access to a particular record and field for a feed item to be created based on an action of the user. In this case, an administrator can be considered to be a user with MODIFY-ALL-DATA security level. In yet another embodiment, a user who created the record can edit the feed.

G. Posts

In one embodiment, the text of posts are stored in a child table (post table 950), which can be cross-referenced with event history table 910. Post table 950 can include event ID 951 (to cross-reference with event ID 911), post text 952 to store the text of the post, and time/date 953. An entry in post table 950 can be considered a feed post object. Posts for a record can also be subject to access checks. In one implementation, if a user can view a record then all of the posts can be seen, i.e., there is not an additional level of security check as there is for FLS. In another implementation, an additional security check could be done, e.g., by checking on whether certain keywords (or phrases) exist in the post. For instance, a post may not be not provided to specified users if a certain keyword exists, or only provided to specified users if a keyword exists. In another embodiment, a table can exist for status updates.

VIII. Subscribing to Users and Records to Follow

As described above, a user can follow users, groups, and records. Embodiments can provide mechanisms for a user to manage which users, groups, and records that the user is currently following. In one embodiment, a user can be limited to the number of users and records (collectively or separately) that the user can follow. For example, a user may be restricted to only following 10 users and 15 records, or as another example, 25 total. Alternatively, the user may be permitted to follow more or less users.

In one embodiment, a user can go to a page of a record and then select to follow that object (e.g., with a button marked “follow” or “join”). In another embodiment, a user can search for a record and have the matching records show up in a list. The search can include criteria of records that the user might want to follow. Such criteria can include the owner, the creation date, last comment date, and numerical values of particular fields (e.g., an opportunity with a value of more than $10,000).

A follow button (or other activation object) can then reside next to each record in the resulting list, and the follow button can be selected to start following the record. Similarly, a user can go to a profile page of a user and select to follow the user, or a search for users can provide a list, where one or more users can be selected for following from the list. The selections of subscribing and unsubscribing can add and delete rows in table 920.

In some embodiments, a subscription center acts as a centralized place in a database application (e.g. application platform 18) to manage which records a user subscribes to, and which field updates the user wants to see in stories. The subscription center can use a subscription table to keep track of the subscriptions of various users. In one embodiment, the subscription center shows a list of all the items (users and records) a user is subscribed to. In another embodiment, a user can unsubscribe to subscribed objects from the subscription center.

A. Automatic Subscription

In one embodiment, an automatic subscription feature can ensure that a user is receiving certain feeds. In this manner, a user does not have to actively select certain objects to follow. Also, a tenant can ensure that a user is following objects that the user needs to be following.

In various embodiments for automatically following users, a default for small organizations can be to follow everyone. For big organizations, the default can be to follow a manager and peers. If a user is a manager, the default can be to follow the manager's supervisor, peers, and people that the manager supervises (subordinates). In other embodiments for automatically following records, records that the user owns may be automatically followed and/or records recently viewed (or changed) may be automatically followed.

In one example, a new record is created. The owner (not necessarily the user who created the entity) is subscribed to the entity. If ownership is changed, the new owner may automatically be subscribed to follow the entity. Also, after a lead convert, the user doing the lead convert may be automatically subscribed to the new account, opportunity, or contact resulting from the lead convert. In one implementation, the auto subscription is controlled by user preference. That is a user or tenant can have the auto subscribe feature enabled or not. In one aspect, the default is to have the auto-subscribe turned on.

FIG. 9B shows a flowchart illustrating a method 900 for automatically subscribing a user to an object in a database system according to embodiments. Any of the following steps can be performed wholly or partially with the database system, and in particular by one or more processor of the database system.

In step 901, one or more properties of an object stored in the database system are received. The properties can be received from administrators of the database system, or from users of the database system (which may be an administrator of a customer organization). The properties can be records or users, and can include any of the fields of the object that are stored in the database system. Examples of properties of a record include: an owner of the record, a user that converted the record from one record type to another record type, whether the first user has viewed the record, and a time the first user viewed the record. Examples of properties of a user include: which organization (tenant) the user is associated with, the second user's position in the same organization, and which other users the user had e-mailed or worked with on projects.

In step 902, the database system receives one or more criteria about which users are to automatically follow the object. The criteria can be received from administrators of the database system, or from one or more users of the database system. The users may be an administrator of a customer organization, which can set tenant-wide criteria or criteria for specific users (who may also set the criteria themselves). Examples of the criteria can include: an owner or creator of a record is to follow the record, subordinates of an owner or creator of a record are to follow the record, a user is to follow records recently viewed (potentially after a specific number of views), records that a user has changed values (potentially with a date requirement), records created by others in a same business group as the user. Examples of the criteria can also include: a user is to follow his/her manager, the user's peers, other users in the same business group as the user, and other users that the user has e-mailed or worked with on a project. The criteria can be specific to a user or group of users (e.g., users of a tenant).

In step 903, the database system determines whether the one or more properties of the object satisfy the one or more criteria for a first user. In one embodiment, this determination can occur by first obtaining the criteria and then determining objects that satisfy the criteria. The determination can occur periodically, at time of creation of an object, or at other times. If different users have different criteria, then the criteria for a particular user or group could be searched at the same time. Since users of different tenants normally cannot view objects of another tenant, certain criteria does not have to be checked. In another embodiment, this determination can occur by looking at certain properties and then identifying any criteria that are met. In yet another embodiment, the criteria and properties can be used to find users that satisfy the criteria.

In step 904, if the criteria are satisfied, the object is associated with the first user. The association can be in a list that stores information as to what objects are being followed by the first user. User subscription table 940 is an example of such a list. In one embodiment, the one or more criteria are satisfied if one property satisfies at least one criteria. Thus, if the criteria is that a user follows his/her manager and the object is the user's manager, then the first user will follow the object.

In one embodiment, a user can also be automatically unsubscribed, e.g., if a certain action happens. The action could be a change in the user's position within the organization, e.g., a demotion or becoming a contractor. As another example, if a case gets closed, then users following the case may be automatically unsubscribed.

B. Feed and Subscription API

In one embodiment, a feed and subscription center API can enable tenants to provide mechanisms for tracking and creating feed items, e.g., as described above for creating custom feeds by allowing users to add custom events for tracking. For example, after some initial feed items are created (e.g., by administrators of the database system), outside groups (e.g., tenants or software providers selling software to the tenants) can “enable objects” for feeds through a standard API. The groups can then integrate into the subscription center and the story feeds on their own. In one embodiment, the feed and subscription center API can use a graphical user interface implemented for the default feed tracking. In one embodiment, API examples include subscribing to an entity by creating a new entity subscription object for a particular user ID, or for all users of a tenant (e.g., user subscription table 940). In one embodiment, obtaining all subscriptions for a given user can be performed by using a query, such as “select . . . from EntitySubscription where userid=‘ . . . ’”.

Some embodiments have restriction on non-admin users, e.g., those without view all data permissions (VAD). One restriction can be a limit clause on entity subscription queries (e.g., queries on user subscription table 940), e.g., where the limit of the number of operations is less than 100. In one embodiment, users are not required to specify an order-by, but if an order-by is specified they can only order on fields on the entity subscription entity. In one implementation, filters on entity subscription can likewise only specify fields on the entity subscription entity. In one aspect, the object ID being followed can be sorted or filtered, but not the object name.

In one embodiment, one or more restrictions can also be placed on the identification of feed items in a feed that a user can access. For example, if a low-level user (i.e., user can access few objects) is attempting to see a profile feed of a high level user, a maximum number of checks (e.g. 500) for access rights may be allowed. Such a restriction can minimize a cost of a feed request. In some embodiments, there are restriction on the type of queries (e.g., fields for filtering) allowed to construct on feeds (e.g. on tables in FIG. 9A).

C. Sharing

As mentioned above, users may be restricted from seeing records from other tenants, as well as certain records from the tenant to which the user belongs (e.g., the user's employer). Sharing rules can refer to the access rules that restrict a user from seeing records that the user is not authorized to see or access. Additionally, in one implementation, a user may be restricted to only seeing certain fields of a record, field-level security (FLS).

In an embodiment, access rule checks are done upon subscription. For example, a user is not allowed to subscribe to a record or type of record that the user cannot access. In one aspect, this can minimize (but not necessarily eliminate) cases where a user subscribes to entities they cannot access. Such cases can slow down news feed queries, when an access check is performed (which can end up removing much of the feed items). Thus, a minimization of access checks can speed up operation. In another embodiment, when feed items are created dynamically, access rule checks may be done dynamically at the time of subsequent access, and not upon subscription or in addition to at time of subscription.

An example case where access checks are still performed is when a first user follows a second user, but the second user performs some actions on records or is following records that the first user is not allowed to see. The first user may be allowed to follow the second user, and thus the subscription is valid even though the first user may not be able to see all of the feed items. Before a story is provided to a news feed of the first user, a security check may be performed to validate whether the first user has access rights to the feed item. If not, the feed item is not displayed to the first user. In one implementation, users can be blocked from feed items that contain certain terms, symbols, account numbers, etc. In one embodiment, any user can follow another user. In another embodiment, users may be restricted as to which users, objects, and/or records he/she can follow.

Regarding viewing privileges of a feed, in one embodiment, a user can always see all of his own subscriptions (even if he's lost read access to a record). For example, a user can become a contractor, and then the user may lose access to some records. But, the user may still see that he/she is following the object. This can help if there is a limit to the number of objects that can be followed. To unsubscribe a user may need to know what they are following so they can unsubscribe and subscribe to objects the user can see. In another embodiment, for access to other people's subscriptions, a user can be required to need read-access on the record-id to see the subscription. In some embodiments, users with authorization to modify all data can create/delete any subscription. In other embodiments, a user can create/delete subscriptions only for that user, and not anyone else.

D. Configuration of which Field to Follow

There can be various feed settings for which feed items get added to profile and record feeds, and which get added to news feeds. In one embodiment, for profile feeds and entity feeds, stories can be written for all standard and custom fields on the supported objects. In one implementation, feed settings can be set to limit how many and which fields of a record are tracked for determining whether a story is to be generated. For example, a user or administrator can choose specific fields to track and/or certain ones not to track. In another embodiment, there is a separate limit for the number of trackable fields (e.g., 20) for a record. Thus, only certain changes may be tracked in an entity history and show up in the feed. In yet another embodiment, default fields may be chosen for tracking, where the defaults can be exposed in the subscriptions center.

IX. Adding Items to a Feed

As described above, a feed includes feed items, which include stories and messages, as defined herein. Various feeds can be generated. For example, a feed can be generated about a record or about a user. Then, users can view these feeds. A user can separately view a feed of a record or user, e.g., by going to a home page for the user or the record. As described above, a user can also subscribe (follow) to user or record and receive the feed items of those feeds through a separate feed application (e.g., in a page or window), which is termed “chatter” in certain examples. The feed application can provide each of the feeds that a user is following in a single news feed.

A feed generator can refer to any software program running on a processor or a dedicated processor (or combination thereof) that can generate feed items (e.g., stories or messages) and combine them into a feed. In one embodiment, the feed generator can generate a feed item by receiving a story or message, identifying what feeds the item should be added to, and adding the feed. Adding the feed can include adding additional information (metadata) to the story or message (e.g., adding a document, sender of message, a determined importance, etc.). The feed generator can also check to make sure that no one sees stories for data that they don't have access to see (e.g., according to sharing rules). A feed generator can run at various times to pre-compute feeds or to compute them dynamically, or combinations thereof.

In one embodiment, the feed generator can de-dupe events (i.e., prevent duplicates) that may come in from numerous records (and users). For example, since a story can be published to multiple feeds (e.g., John Choe changed the Starbucks Account Status) and a person can be subscribed to both the Starbucks account and John Choe, embodiments can filter out duplicates before adding or displaying the items in a news feed. Thus, the Feed Generator can collapse events with multiple records and users for a single transaction into a single story and ensure the right number of stories for the particular feed. In some embodiments, an action by a user does not create a feed item for that user (e.g., for a profile feed of that user), and it is only the feed of the object being acted upon (e.g., updated) for which a feed item is created. Thus, there should not be duplicates. For example, if someone updates the status of a record, the feed item is only for the record and not the user.

In one embodiment, processor 417 in FIG. 4 can identify an event that meets criteria for a story, and then generate the story. Processor 417 can also identify a message. For example, an application interface can have certain mechanisms for submitting a message (e.g., “submit” buttons on a profile page, detail page of a record, “comment” button on post), and use of these mechanisms can be used to identify a message to be added to a table used to create a feed or added directly to a list of feed items ready for display.

A. Adding Items to a Pre-Computed Feed

In some embodiments, a feed of feed items is created before a user requests the feed. Such an embodiment can run fast, but have high overall costs for storage. In one embodiment, once a profile feed or a record feed has been created, a feed item (messages and stories) can be added to the feed. The feed can exist in the database system in a variety of ways, such as a related list. The feed can include mechanisms to remove items as well as add them.

As described above, a news feed can be an aggregated feed of all the record feeds and profile feeds to which a user has subscribed. The news feed can be provided on the home page of the subscribing user. Therefore, a news feed can be created by and exist for a particular user. For example, a user can subscribe to receive entity feeds of certain records that are of interest to the user, and to receive profile feeds of people that are of interest (e.g., people on a same team, that work for the user, are a boss of the user, etc.). A news feed can tell a user about all the actions across all the records (and people) who have explicitly (or implicitly) subscribed to via the subscriptions center (described above).

In one embodiment, only one instance of each story is shown on a user's news feed, even if the story is published in multiple entities to which the user is subscribed. In one aspect, there may be delays in publishing news articles. For example, the delay may be due to queued up messages for asynchronous entity history persistence. Different feeds may have different delays (e.g., delay for new feeds, but none of profile and entity feeds). In another embodiment, certain stories regarding a subscribed profile feed or an entity feed are not shown because the user is not allowed access, e.g., due to sharing rules (which restrict which users can see which data). Also, in one embodiment, data of the record that has been updated (which includes creation) can be provided in the feed (e.g., a file or updated value of a feed can be added as a flash rendition).

Examples are provided below as how it can be determined which feed items to add to which news feeds. In one embodiment, the addition of items to a news feed is driven by the following user. For example, the user's profile can be checked to determine objects the user is following, and the database may be queried to determine updates to these objects. In another embodiment, the users and records being followed drive the addition of items to a news feed. Embodiments can also combine these and other aspects. In one embodiment, a database system can be follower-driven if the number of subscriptions (users and records the user is following) is small. For example, since the number subscriptions are small, then changes to a small number of objects need to be checked for the follower.

Regarding embodiments that are follower-driven, one embodiment can have a routine run for a particular user. The routine knows the users and records that the user is following. The routine can poll the database system for new stories and messages about the users and records that are being followed. In one implementation, the polling can be implemented as queries. In one embodiment, the routine can run at least partially (even wholly) on a user device.

Regarding embodiments where a news feed is driven by the record (or user) being followed, processor 417 can identify followers of the record after a feed item is added to the record feed. Processor 417 can retrieve a list of the followers from the database system. The list can be associated with the record, and can be stored as a related list or other object that is a field or child of the record.

In one embodiment, profile and record feeds can be updated immediately with a new feed item after an action is taken or an event occurs. A news feed can also be updated immediately. In another embodiment, a news feed can be updated in batch jobs, which can run at periodic times.

B. Dynamically Generating Feeds

In some embodiments, a feed generator can generate the feed items dynamically when a user requests to see a particular feed, e.g., a profile feed, entity feed, or the user's news feed. In one embodiment, the most recent feed items (e.g., top 50) are generated first. In one aspect, the other feed items can be generated as a background process, e.g., not synchronously with the request to view the feed. However, since the background process is likely to complete before a user gets to the next 50 feed items, the feed generation may appear synchronous. In another aspect, the most recent feed items may or may not include comments, e.g., that are tied to stories or posts.

In one embodiment, the feed generator can query the appropriate subset of tables shown in FIG. 9A and/or other tables as necessary, to generate the feed items for display. For example, the feed generator can query the event history table 910 for the updates that occurred for a particular record. The ID of the particular record can be matched against the ID of the record. In one embodiment, changes to a whole set of records can be stored in one table. The feed generator can also query for status updates, posts, and comments, each of which can be stored in different parts of a record or in separate tables, as shown in FIG. 9A. What gets recorded in the entity history table (as well as what is displayed) can be controlled by a feed settings page in setup, which can be configurable by an administrator and can be the same for the entire organization, as is described above for custom feeds.

In one embodiment, there can be two feed generators. For example, one generator can generate the record and profile feeds and another generator can generate news feeds. For the former, the feed generator can query identifiers of the record or the user profile. For the latter, the news feed generator can query the subscribed profile feeds and record feeds, e.g., user subscription table 940. In one embodiment, the feed generator looks at a person's subscription center to decide which feeds to query for and return a list of feed items for the user. The list can be de-duped, e.g., by looking at the event number and values for the respective table, such as field name or ID, comment ID, or other information.

C. Adding Information to Feed History Tables

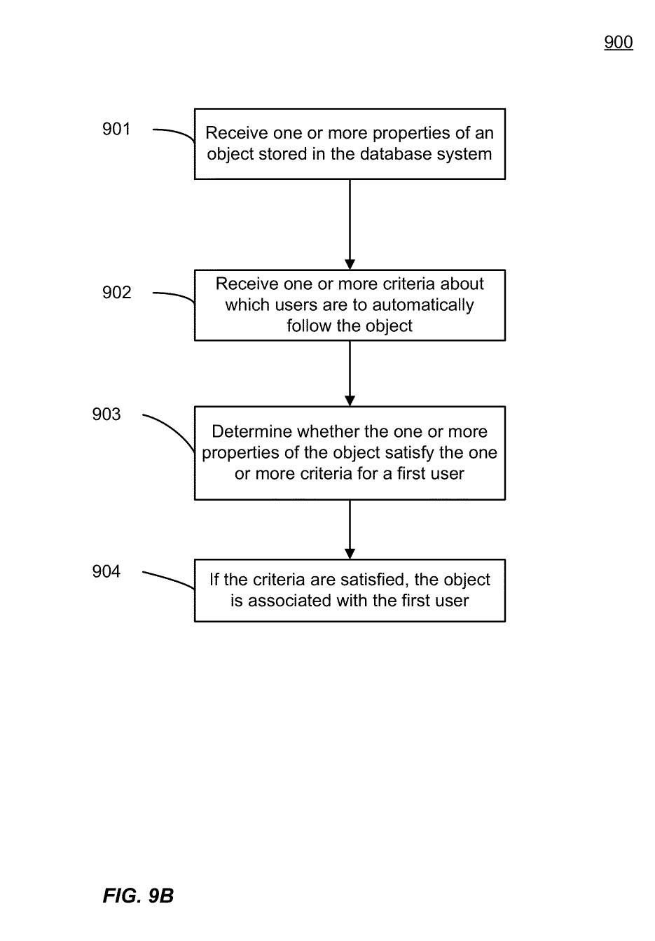

FIG. 10 is a flowchart of a method 1000 for saving information to feed tracking tables according to embodiments. In one embodiment, some of the steps may be performed regardless of whether a specific event or part of an event (e.g., only one field of an update is being tracked) is being tracked. In various embodiments, a processor or set of processors (hardwired or programmed) can perform method 1000 and any other method described herein.

In step 1010, data indicative of an event is received. The data may have a particular identifier that specifies the event. For example, there may be a particular identifier for a field update. In another embodiment, the transaction may be investigated for keywords identifying the event (e.g., terms in a query indicating a close, change field, or create operations).

In step 1020, it is determined whether the event is being tracked for inclusion into feed tables. The determination of what is being tracked can be based on a tenant's configuration as described above. In one aspect, the event has an actor (person performing an event), and an object of the event (e.g., record or user profile being changed).

In step 1030, the event is written to an event history table (e.g., table 910). In one embodiment, this feed tracking operation can be performed in the same transaction that performs a save operation for updating a record. In another embodiment, a transaction includes at least two roundtrip database operations, with one roundtrip being the database save (write), and the second database operation being the saving of the update in the history table. In one implementation, the event history table is chronological. In another implementation, if user A posts on user B's profile, then user A is under the “created by” 913 and user B is under the object ID 912.

In step 1040, a field change table (e.g., field change table 920) can be updated with an entry having the event identifier and fields that were changed in the update. In one embodiment, the field change table is a child table of the event history table. This table can include information about each of the fields that are changed. For example, for an event that changes the name and balance for an account record, an entry can have the event identifier, the old and new name, and the old and new balance. Alternatively, each field change can be in a different row with the same event identifier. The field name or ID can also be included to determine which field the values are associated.

In step 1050, when the event is a post, a post table (e.g., post table 950) can be updated with an entry having the event identifier and text of the post. In one embodiment, the field change table is a child table of the event history table. In another embodiment, the text can be identified in the transaction (e.g., a query command), stripped out, and put into the entry at the appropriate column. The various tables described herein can be combined or separated in various ways. For example, the post table and the field change table may be part of the same table or distinct tables, or may include overlapping portions of data.

In step 1060, a comment is received for an event and the comment is added to a comment table (e.g., comment table 930). The comment could be for a post or an update of a record, from which a story can be generated for display. In one embodiment, the text can be identified in the transaction (e.g., a query command), stripped out, and put into the entry at the appropriate column.

D. Reading Information from F History Tables

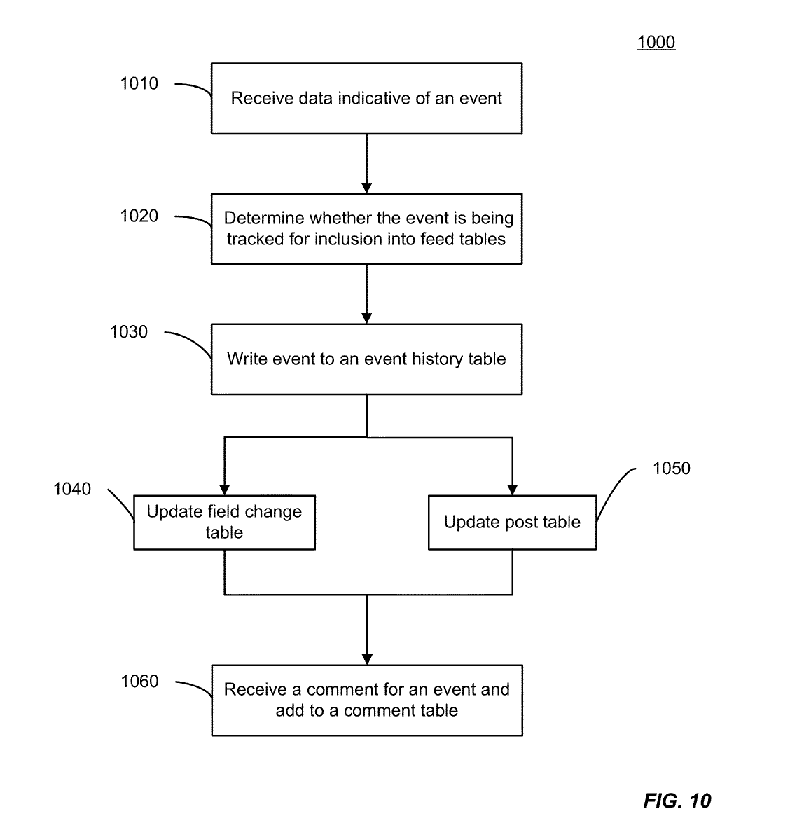

FIG. 11 is a flowchart of a method 1100 for reading a feed item as part of generating a feed for display according to embodiments. In one embodiment, the feed item may be read as part of creating a feed for a record.

In step 1110, a query is received for an event history table (e.g., event history table 910) for events related to a particular record. In one embodiment, the query includes an identifier of the record for which the feed is being requested. In various embodiments, the query may be initiated from a detail page of the record, a home page of a user requesting the record feed, or from a listing of different records (e.g. obtained from a search or from browsing).

In step 1120, the user's security level can be checked to determine if the user can view the record feed. Typically, a user can view a record feed, if the user can access the record. This security check can be performed in various ways. In one embodiment, a first table is checked to see if the user has a classification (e.g., a security level that allows him to view records of the given type). In another embodiment, a second table is checked to see if the user is allowed to see the specific record. The first table can be checked before the second table, and both tables can be different sections of a same table. If the user has requested the feed from the detail page of the record, one embodiment can skip the security level check for the record since the check was already done when the user requested to view the detail page.

In one embodiment, a security check is determined upon each request to view the record feed. Thus, whether or not a feed item is displayed to a user is determined based on access rights, e.g., when the user requests to see a feed of a record or a news feed of all the objects the user is following. In this manner, if a user's security changes, a feed automatically adapts to the user's security level when it is changed. In another embodiment, a feed can be computed before being requested and a subsequent security check can be made to determine whether the person still has access right to view the feed items. The security (access) check may be at the field level, as well as at the record level.

In step 1130, if the user can access the record, the a field level security table can be checked to determine whether the user can see particular fields. In one implementation, only those fields are displayed to the user. Alternatively, a subset of those the user has access to is displayed. The field level security check may optionally be performed at the same time and even using the same operation as the record level check. In addition, the record type check may also be performed at this time. If the user can only see certain fields, then any feed items related to those fields (e.g., as determined from field change table 920) can be removed from the feed being displayed.

In step 1140, the feed items that the user has access to are displayed. In one embodiment, a predetermined number (e.g., 20) of feed items are displayed at a time. The method can display the first 20 feed items that are found to be readable, and then determine others while the user is viewing the first 20. In another embodiment, the other feed items are not determined until the user requests to see them, e.g., by activating a see more link.

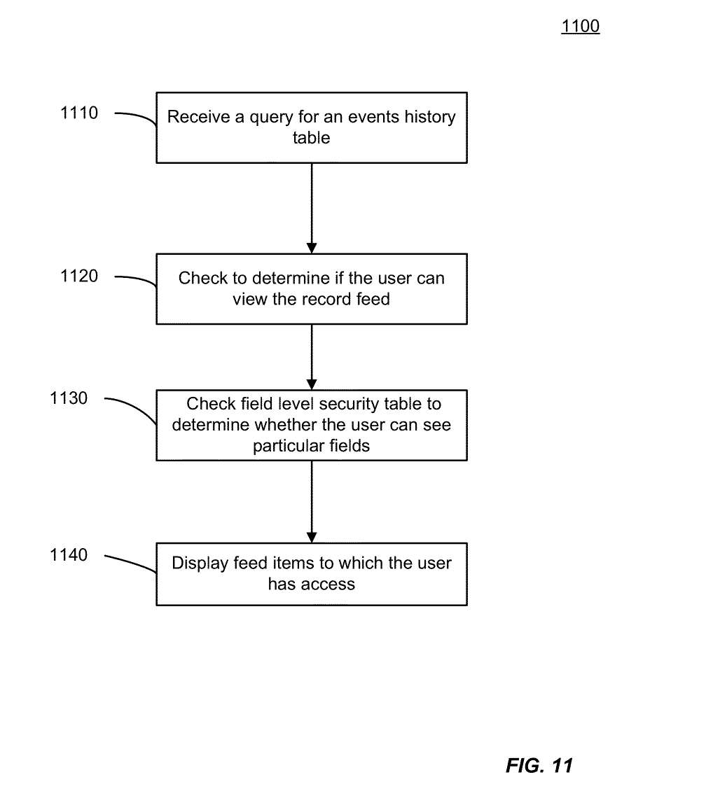

FIG. 12 is a flowchart of a method 1200 for reading a feed item of a profile feed for display according to embodiments. In one embodiment, the query includes an identifier of the user profile feed that is being requested. Certain steps may be optional, as is also true for other methods described herein. For example, security checks may not be performed.

In step 1210, a query is directed to an event history table (e.g., event history table 910) for events having a first user as the actor of the event (e.g., creation of an account) or on which the event occurred (e.g., a post to the user's profile). In various embodiments, the query may be initiated by a second user from the user's profile page, a home page of a user requesting the profile feed (e.g., from a list of users being followed), or from a listing of different users (e.g., obtained from a search or from browsing). Various mechanisms for determining aspects of events and obtaining information from tables can be the same across any of the methods described herein.

In step 1220, a security check may also be performed on whether the second user can see the first user's profile. In one embodiment any user can see the profile of another user of the same tenant, and step 1220 is optional.

In step 1230, a security (access) check can be performed for the stories based on record types, records, and/or fields, as well security checks for messages. In one embodiment, only the stories related to records that the person has updated are the ones that need security check as the feed items about the user are readable by any user of the same tenant. Users of other tenants are not navigable, and thus security can be enforced at a tenant level. In another embodiment, messages can be checked for keywords or links to a record or field that the second user does not have access.

As users can have different security classifications, it is important that a user with a low-level security cannot see changes to records that have been performed by a user with high-level security. In one implementation, each feed item can be checked and then the viewable results displayed, but this can be inefficient. For example, such a security check may take a long time, and the second user would like to get some results sooner rather than later. The following steps illustrate one embodiment of how security might be checked for a first user that has a lot of feed items, but the second user cannot see most of them. This embodiment can be used for all situations, but can be effective in the above situation.

In step 1231, a predetermined number of entries are retrieved from the event history table (e.g., starting from the most recent, which may be determined from the event identifier). The retrieved entries may just be ones that match the user ID of the query. In one embodiment, entries are checked to find the entries that are associated with the user and with a record (i.e., not just posts to the user account). In another embodiment, those entries associated with the user are allowed to be viewed, e.g., because the second user can see the profile of the first user as determined in step 1220.

In step 1232, the record identifiers are organized by type and the type is checked on whether the second user can see the record types. Other checks such as whether a record was manually shared (e.g., by the owner) can also be performed. In one embodiment, the queries for the different types can be done in parallel.

In step 1233, if a user can see the record type, then a check can be performed on the specific record. In one embodiment, if a user can see a record type, then the user can see all of the records of that type, and so this step can be skipped. In another embodiment, the sharing model can account for whether a user below the second user (e.g., the second user is a manager) can see the record. In such an embodiment, the second user may see such a record. In one implementation, if a user cannot see a specific record, then comments on that record are also not viewable.

In step 1234, field level sharing rules can be used to determine whether the second user can see information about an update or value of certain fields. In one embodiment, messages can be analyzed to determine if reference to a particular field name is made. If so, then field level security can be applied to the messages.

In step 1280, steps 1231-1234 are repeated until a stopping criteria is met. In one embodiment, the stopping criteria may be when a maximum number (e.g., 100) of entries that are viewable have been identified. In another embodiment, the stopping criteria can be that a maximum number (e.g., 500) of entries from the entity history table have been analyzed, regardless of whether the entries are viewable or not.

In one embodiment, a news feed can be generated as a combination of the profile feeds and the entity feeds, e.g., as described above. In one implementation, a list of records and user profiles for the queries in steps 1110 and 1210 can be obtained from user subscription table 940. In one embodiment, there is a maximum number of objects that can be followed.

In various embodiments, the entity history table can be queried for any one or more of the following matching variables as part of determining items for a feed: CreatedDate, CreatedById, CreatedBy.FirstName, CreatedBy.LastName, ParentId, and Parent.Name. The child tables can also be queried for any one or more of the following matching variables as part of determining items for a feed: DataType, FieldName, OldValue, and NewValue. A query can also specify how the resulting feed items can be sorted for display, e.g., by event number, date, importance, etc. The query can also include a number of items to be returned, which can be enforced at the server.

The two examples provided above can be done periodically to create the feeds ahead of time or done dynamically at the time the display of a feed is requested. Such a dynamic calculation can be computationally intensive for a news feed, particularly if many users and records are being followed, although there can be a low demand for storage. Accordingly, one embodiment performs some calculations ahead of time and stores the results in order to create a news feed.

E. Partial Pre-Computing of Items for a Feed

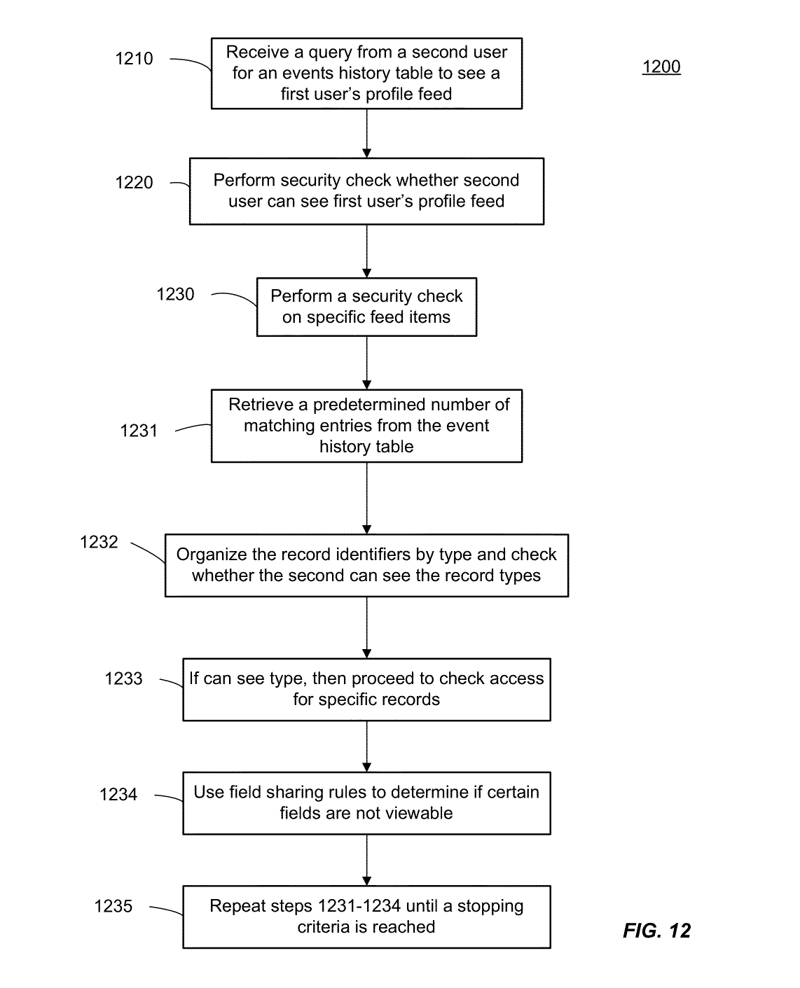

FIG. 13 is a flowchart of a method 1300 of storing event information for efficient generation of feed items to display in a feed according to embodiments. In various embodiments, method 1300 can be performed each time an event is written to the events history table, or periodically based on some other criteria (e.g., every minute, after five updates have been made, etc.).

In step 1310, data indicative of an event is received. The data may be the same and identified in the same way as described for step 1010. The event may be written to an event history table (e.g., table 910).

In step 1320, the object(s) associated with the event are identified. In various embodiments, the object may be identified by according to various criteria, such as the record being changed, the user changing the record, a user posting a message, and a user whose profile the message is being posted to.

In step 1330, the users following the event are determined. In one embodiment, one or more objects that are associated with the event are used to determine the users following the event. In one implementation, a subscription table (e.g., table 940) can be used to find the identified objects. The entries of the identified objects can contain an identifier (e.g., user ID 941) of each the users following the object.

In step 1340, the followers of the event are written to a news feed table along with an event identifier. In one embodiment, each follower is added as a separate entry into the news feed table along with the event ID. In another embodiment, each of the events for a user is added as a new column for the row of the user. In yet another embodiment, more columns (e.g. columns from the other tables) can be added.

News feed table 960 shows an example of such a table with user ID 961 and event ID or pointer 962. The table can be organized in any manner. One difference from event history table 910 is that one event can have multiple entries (one for each subscriber) in the news feed table 960. In one embodiment, all of the entries for a same user are grouped together, e.g., as shown. The user U819 is shown as following events E37 and E90, and thus any of the individual feed items resulting from those events. In another embodiment, any new entries are added at the end of the table. Thus, all of the followers for a new event can be added as a group. In such an embodiment, the event IDs would generally be grouped together in the table. Of course, the table can be sorted in any suitable manner.

In an embodiment, if the number of users is small, then the feed items in one or more of the tables may be written as part of the same write transaction. In one implementation, the determination of small depends on the number of updates performed for the event (e.g., a maximum number of update operations may be allowed), and if more operations are performed, then the addition of the feed items is performed. In one aspect, the number of operations can be counted by the number of rows to be updated, including the rows of the record (which depends on the update event), and the rows of the history tables, which can depend on the number of followers. In another embodiment, if the number of users is large, the rest of the feed items can be created by batch. In one embodiment, the feed items are always written as part of a different transaction, i.e., by batch job.

In one embodiment, security checks can be performed before an entry is added to the news feed table 960. In this manner, security checks can be performed during batch jobs and may not have to be performed at the time of requesting a news feed. In one implementation, the event can be analyzed and if access is not allowed to a feed item of the event, then an entry is not added. In one aspect, multiple feed items for a same user may not result from a same event (e.g., by how an event is defined in table 910), and thus there is no concern about a user missing a feed item that he/she should be able to view.

In step 1350, a request for a news feed is received from a user. In one embodiment, the request is obtained when a user navigates to the user's home page. In another embodiment, the user selects a table, link, or other page item that causes the request to be sent.

In step 1360, the news feed table and other tables are accessed to provide displayable feed items of the news feed. The news feed can then be displayed. In one embodiment, the news feed table can then be joined with the event history table to determine the feed items. For example, the news feed table 960 can be searched for entries with a particular user ID. These entries can be used to identify event entries in event history table 910, and the proper information from any child tables can be retrieved. The feed items (e.g., stories and messages) can then be generated for display.

In one embodiment, the most recent feed items (e.g., 100 most recent) are determined first. The other feed items may then be determined in a batch process. Thus, the feed item that a user is most likely to view can come up first, and the user may not recognize that the other feed items are being done in batch. In one implementation, the most recent feed items can be gauged by the event identifiers. In another embodiment, the feed items with a highest importance level can be displayed first. The highest importance being determined by one or more criteria, such as, who posted the feed item, how recently, how related to other feed items, etc.

In one embodiment where the user subscription table 940 is used to dynamically create a news feed, the query would search the subscription table, and then use the object IDs to search the event history table (one search for each object the user is following). Thus, the query for the news feed can be proportional to the number of objects that one was subscribing to. The news feed table allows the intermediate step of determining the object IDs to be done at an earlier stage so that the relevant events are already known. Thus, the determination of the feed is no longer proportional to the number of object being followed.

In some embodiments, a news feed table can include a pointer (as opposed to an event identifier) to the event history table for each event that is being followed by the user. In this manner, the event entries can immediately be retrieved without having to perform a search on the event history table. Security checks can be made at this time, and the text for the stories can be generated.

X. Display of a Feed

Feeds include messages and stories and can show up in many places in an application interface with the database system. In one embodiment, feeds can be scoped to the context of the page on which they are being displayed. For example, how a story is presented can vary depending on which page it is being displayed (e.g., in news feeds, on a detail page of a record, and even based on how the user ended up at a particular page). In another embodiment, only a finite number of feed items are displayed (e.g., 50). In one implementation, there can be a limit specifically on the number of stories or messages displayed. Alternatively, the limit can be applied to particular types of stories or messages. For example, only the most recent changes (e.g., 5 most recent) for a field may be displayed. Also, the number of fields for which changes are displayed can also be limited. Such limits can also be placed on profile feeds and news feeds. In one embodiment, feed items may also be subject to certain filtering criteria before being displayed, e.g., as described below.

A. Sharing Rules for Feeds

As mentioned above, a user may not be allowed to see all of the records in the database, and not even all of the records of the organization to which the user belongs. A user can also be restricted from viewing certain fields of a record that the user is otherwise authorized to view. Accordingly, certain embodiments use access rules (also called sharing rules and field-level security FLS) to ensure that a user does not view a story or message that the user is not authorized to see. A feed of a record can be subject to the same access rules as the parent record.

In one embodiment, access rules can be used to prevent subscription to a record that the user cannot see. In one implementation, a user can see a record, but only some of the fields. In such instances, only items about fields that the user can access may be displayed. In another embodiment, sharing rules and FLS are applied before a feed item is being added to a feed. In another embodiment, sharing rules and FLS are applied after a feed item has been added and when the feed is being displayed. When a restriction of display is mentioned, the enforcement of access rules may occur at any stage before display.

In some implementations, the access rules can be enforced when a query is provided to a record or a user's profile to obtain feed items for a news feed of a user. The access rules can be checked and cross-references with the feed items that are in the feed. Then, the query can only return feed items for which the user has access.

In other implementations, the access rules can be enforced when a user selects a specific profile feed or record feed. For example, when a user arrives on a home page (or selects a tab to see the record feed), the database system can check to see which feed items the user can see. In such an embodiment, each feed item can be associated with metadata that identifies which field the feed item is about. Thus, in one embodiment, a story is not visible unless the associated record and/or field are visible to the user.

In one example, when a user accesses a feed of a record, an access check can be performed to identify whether the user can access the object type of the record. In one implementation, users are assigned a profile type, and the profile type is cross-referenced (e.g., by checking a table) to determine whether the profile type of the user can see the object type of the record.

In some embodiments, access to specific records can be checked, e.g., after it has been determined that the user can access the record type. Rules can be used to determine the records viewable by a user. Such rules can determine the viewable records as a combination of those viewable by profile type, viewable due to a profile hierarchy (e.g., a boss can view records of profile types lower in the hierarchy), and viewable by manual sharing (e.g., as may be done by an owner of a record). In one embodiment, the records viewable by a user can be determined beforehand and stored in a table. In one implementation, the table can be cross-referenced by user (or profile type of a user) to provide a list of the records that the user can see, and the list can be searched to determine if the record at issue is among the list. In another implementation, the table can be cross-referenced by record to determine a list of the profile types that can access the record, and the list can be searched to find out if the requesting user is in the list. In another embodiment, the records viewable by a user can be determined dynamically at the time of the access check, e.g., by applying rules to data (such as user profile and hierarchy information) obtained from querying one or more tables.

In other embodiments, checks can be made as to whether a user has access to certain fields of a record, e.g., after it has been determined that the user can access the record. In one aspect, the access check on fields can be performed on results already obtained from the database, to filter out fields that the user cannot see. In one embodiment, the fields associated with retrieved feed items are determined, and these fields are cross-referenced with an access table that contains the fields accessible by the user (e.g., using the profile type of the user). Such an access table could also be a negative access table by specifying fields that the user cannot see, as can other access tables mentioned herein. In one embodiment, the field level access table is stored in cache at a server.

In one embodiment, a user can see the same fields across all records of a certain type (e.g., as long as the user can see the record). In one implementation, there is a field level access table for each object type. The access table can be cross-referenced by user (e.g., via profile type) or field. For example, a field can be identified along with the profile types that can see the field, and it can be determined whether the user's profile type is listed. In another example, the user can be found and the fields to which the user has access can be obtained. In another embodiment, the accessible fields could be specified for each record.

Regarding profile feeds and news feeds, a first user may perform an action on a record, and a story may be generated and added to the first user's profile feed. A second user who is allowed to follow the first user may not have access rights to the record. Thus, the story can be excluded from a news feed of the second user, or when the second user views the first user's profile feed directly. In one embodiment, if a user is already on the detail page, then another access check (at least at the record level) may optionally not be performed since a check was already done in order to view the detail page.

In some embodiments, for profile feeds and news feeds, the feed items can be organized by object type. It can then be determined whether the requesting user can access to those object types. Other access checks can be done independently or in conjunction with these access checks, as is described above.

B. API Implementation

Various embodiments can implement the access rules in various ways. In one embodiment, all recent feed items (or more generally events) are retrieved from a feed that is ready for display (e.g., after a feed generator performs formatting) or a table. Then, bulk sharing checks can be applied on the retrieved items. The viewable feed items of the most recent set can then be displayed.

In another embodiment regarding a profile feed, for non-VAD (view all data) users, i.e., users who can see everything, certain functions can be overridden. In one implementation, a FROM clause in a query can be overridden to be a pipelined function, e.g., with different parts of the query being operated on at the same time, but with different operations of a pipeline. This pipeline function can be given a row limit and the maximum number of sharing checks to run. It can loop, selecting the next batch of rows, run sharing checks against them in bulk, and pipe back any IDs which are accessible. In one aspect, in nearly all cases, the user feed can contain accessible IDs so the sharing checks can pass on the first loop. However, it is possible the sharing may have changed such that this user's access is greatly reduced. In one worst case, embodiments can run sharing checks on up to the maximum number of sharing check rows (e.g., a default 500) and then terminate the function with the IDs which passed so far, possibly zero. Such an example includes a low level person viewing profile feed of CEO.

In some embodiments, if the user has a small number of subscriptions (e.g., less than 25), then embodiments can first run sharing checks on those IDs and then drive the main query from those accessible IDs, as opposed to a semi-join against the subscription and running sharing checks on the resulting rows. In other embodiments, FLS is enforced by building up a TABLE CAST of the accessible field IDs from the cached values. A main query can then join against this table to filter only accessible fields.

XI. Filtering and Searching Feeds

It can be possible that a user subscribes to many users and records, which can cause a user's news feed to be very long and include many feed items. In such instances, it can be difficult for the user to read every feed item, and thus some important or interesting feed items may not be read. In some embodiments, filters may be used to determine which feed items are added to a feed or displayed in the feed, even though a user may be authorized to see more than what is displayed. Section VII.E also provides a description of filtering based on criteria.

In one embodiment, an “interestingness” filter can function as a module for controlling/recommending which stories make it to the news feed when the number of items that a user subscribes to is large. In one such embodiment, a user can specify a filter, which is applied to a user's news feed or to record and profile feeds that the user requests. Different filters can be used for each. For example, processing can be done on the news feed to figure out which stories are the most relevant to the user. One embodiment can use an importance level, as described herein. Other embodiments can include a user specifying keywords for a message and specifying which records or users are most important.

In one embodiment, a filter can be used that only allows certain feed items to be added to a feed and/or to be displayed as part of a feed. A filter can be used such that the removal or non-addition of certain feed items automatically occur for any new feed items after the filter criteria are entered. The filter criteria can also be added retroactively. The criteria of such a filter can be applied via a query mechanism as part of adding a feed item to a table or displaying a feed, as described in sections above. In various embodiments, a user can directly write a query or create the query through a graphical user interface.

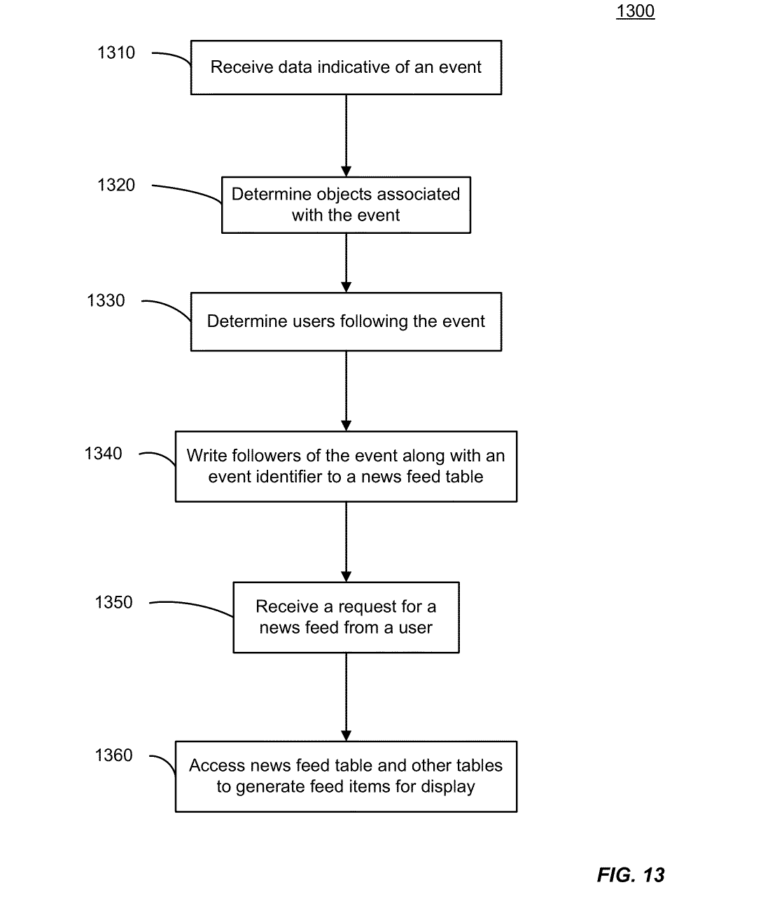

FIG. 14 is a flowchart of a method 1400 for creating a custom feed for users of a database system using filtering criteria according to embodiments. Any of the following steps can be performed wholly or partially with the database system, and in particular by one or more processor of the database system.

In step 1410, one or more criteria specifying which feed items are to be displayed to a first user are received from a tenant. In one embodiment, the criteria specifies which items to add to the custom feed. For example, the criteria could specify to only include feed items for certain fields of a record, messages including certain keywords, and other criteria mentioned herein. In another embodiment, the criteria specifies which items to remove from the custom feed. For example, the criteria could specify not to include feed items about certain fields or including certain keywords.

In step 1420, the database system identifies feed items of one or more selected objects that match the criteria. The feed items can be stored in the database, e.g., in one or more of the tables of FIG. 9A. In one embodiment, the one or more selected objects are the objects that the first user is following. In another embodiment, the one or more selected objects is a single record whose record feed the first user is requesting.

In step 1430, the feed items that match the criteria are displayed to the first user in the custom feed. The generation of text for a story can occur after the identification of the feed items (e.g., data for a field change) and before the display of the final version of the feed item.

In one embodiment, the criteria is received before a feed item is created. In another embodiment, the criteria is received from the first user. In one aspect, the criteria may only be used for determining feeds to display to the first user. In yet another embodiment, the criteria is received from a first tenant and applies to all of the users of the first tenant. Also, in an embodiment where a plurality of criteria are specified, the criteria may be satisfied for a feed item if one criterion is satisfied.

Some embodiments can provide mechanisms to search for feed items of interest. For example, the feed items can be searched by keyword, e.g., as entered by a user. As another example, a tab (or other selection device) can show feed items about or from a particular user. In one implementation, only messages (or even just comments) from a particular user can be selected.

In another embodiment, a user can enter search criteria so that the feed items currently displayed are searched and a new list of matching feed items is displayed. A search box can be used to enter keywords. Picklists, menus, or other mechanisms can be used to select search criteria. In yet another embodiment, feed comments are text-indexed and searchable. Feed comments accessibility and visibility can apply on the search operation too.

In one embodiment, when a user performs a search of feeds, there can be an implicit filter of the user (e.g., by user ID). This can restrict the search to only the news feed of the user, and thus to only record feeds and profile feeds that the user is subscribed. In another embodiment, searches can also be done across feeds of users and records that are not being subscribed.

Besides searching for feed items that match a criteria, one also could search for a particular feed item. However, in one embodiment, a user cannot directly query a feed item or feed comment. In such an embodiment, a user can query to obtain a particular profile or record feed, and then navigate to the feed item (e.g., as child of the parent feed). In another embodiment, the relationship from a feed to its parent entity (e.g., a record or user profile) is uni-directional. That is, a user can navigate from the feed to the parent but not vice versa.

In one embodiment, a user can directly query the child tables, e.g., comment table 930. Thus, a user could search for comments only that user has made, or comments that contain certain words. In another embodiment, a user can search for a profile feed of only one user. In yet another embodiment, a user can search for profile feeds of multiple users (e.g., by specifying multiple user names or IDs), which can be combined into a single feed.

XII. Maintaining Records for Follower's Feeds

If every feed item is stored and maintained on a follower's feed or even in the profile and/or record feeds, the amount of data to be stored could be massive, enough to cause storage issues in the system. In one embodiment, the N (e.g., 50) most recent feed items for each feed are kept. However, there can be a need to keep certain older feed items. Thus, embodiments can remove certain feed items, while keeping others. In other embodiments, old stories may be archived in a data store separate from where recent feed items are stored.

In some embodiments, feeds are purged by a routine (also called a reaper) that can remove items deemed not worthy to keep (e.g., old items). Any underlying data structures from which feed items are created can also be purged. In one embodiment, the reaper can remove certain items when new items are added (e.g., after every fifth item added). As another example, feed items may be deleted synchronously during the save operation itself. However, this may slow down each save operation. In one embodiment, however, this may be better than incurring a larger cost when the items are removed at longer intervals. In another embodiment, the reaper can run periodically as a batch process. Such routines can ensure that a table size does not become too large. In one aspect, a reaper routine can keep the event history table relatively small so the sharing checks are not extremely expensive.

In various embodiments, the reaper can maintain a minimum number (e.g., 50 or 100) of feed items per record, maintain a minimum number of records per user (e.g., per user ID), and not deleting feed items (or entire records) which have comments against it. Such embodiments can ensure that the detail page and profile page have sufficient data to display in a feed. Note that the sharing checks for feed queries can cut down the number of records further for users with less access. Thus, the number of records finally displayed for specific users can be significantly less than a minimum number for a specific profile or record feed. In one embodiment, a reaper deletes data that is older than a specified time (e.g., 6 months or a year).

In one embodiment, the reaper can perform the deletion of feed items (purging) as a batch up deletion. This can avoid deletion of large number of records that may lead to locking issues. In another embodiment, the reaper can be run often so that the table does not become difficult to manage (e.g., size-wise). In this way the reaper can work on a limited set of records. In one implementation, the reaper may have logic that deletes certain items (e.g., by an identification) from tables (e.g., those in FIG. 9A), or sections of the tables.

XIII. Sharing Information with Multiple Groups/Organizations

A database system of the type described above may be suitably configured to support a variety of information and content sharing, posting, distribution, and communication techniques. For example, a user of the database system can create posts or messages that are meant to be published for other users to see. In certain information networking environments (e.g., social networking sites, enterprise level information networking systems, social media applications, and the like) users can join different groups. In this regard, a given user may be a registered member of a “Product Marketing” group, a “Friday Lunch” group, and a “Company Softball Team” group. At times, a user who is a member of multiple groups may want to post or share information or content to two or more of the groups. For example, the user may want to make a general announcement that is applicable to all of his registered groups.

In accordance with traditional information sharing methodologies, a user shares information across multiple groups by individually accessing or logging into each of the different groups for purposes of redundantly sharing the same content or information. For example, a user could access Group 1 and post the comment “I will be on vacation next week” such that other members of Group 1 will receive the information. Thereafter, the user could access Group 2 and redundantly create the same post such that other members of Group 2 will receive the information. As another example, suppose that a manager reads an interesting post, and wants to share that post with four of his teams (groups). He would need to share the same post four different times: one for each of his teams. This methodology can be frustrating and time consuming, especially if the user wants to share common information or content across many different groups.

In accordance with certain embodiments, the database system enables users to post, share, and distribute information and content with multiple groups in a quick and efficient manner by selecting multiple groups while posting. In practice, the system provides a suitably formatted and configured selection menu that enables the user to view and choose any number of groups. After multiple groups are selected, the system responds in an automated and one-step manner such that the user need not redundantly make the same post for the different groups.

In accordance with a multi-tenant database environment, a user's groups may be associated with the same tenant/organization. Thus, once the user logs into Organization 1 (for example), any of that user's groups in Organization 1 will be available for selection when posting, sharing, or distributing information, as explained above. If the user logs into Organization 2, however, any of that user's groups in Organization 2 will be available for selection. In this regard, many companies have multiple organizations (e.g., research and development, sales, and support), wherein a user may have different login credentials for the different organizations. Suppose that a user needs to post some information to all of these organizations. In accordance with traditional methodologies, that user would need to individually login to each of the organizations, and then post and share the same information multiple times to reach the different groups.

As an extension of the basic concept described above, a multi-tenant database system could be suitably configured to allow a user to select groups across a plurality of different organizations, where each of the organizations may require a different set of user credentials for login purposes. In accordance with this feature, the database system presents a selection menu to the user, wherein the menu indicates the user's different groups (whether or not those groups are associated with the same or different organizations). If the user is currently logged into only one of his organizations, then the system prompts the user (via a pop-up window, a notification, an email, or the like) to log into one or more other organizations. In preferred implementations, the database system maintains persistent login status for the user, i.e., the authentication procedure is a “one time” routine for purposes of posting across multiple organizations, such that the user need not re-enter his credentials each and every time. Thus, the user can select among different organizations and different groups while posting or sharing information from one GUI element.

As an example, assume that a user wishes to share information with the following: Group 1, Group 2, and Group 3 (each of which is defined for Organization 1); and Group 4 and Group 5 (each of which is defined for Organization 2). If the database system has already been configured with the user's credentials for both organizations, then the user only needs to log into one of the two organizations. If the user creates a post, he will be presented with a menu element that includes selectable entries for Group 1, Group 2, and Group 3 (listed in association with Organization 1), and selectable entries for Group 4 and Group 5 (listed in association with Organization 2). This scheme allows the user to quickly and easily share information across multiple groups without having to repeat the process five times, and without having to log in two different times.

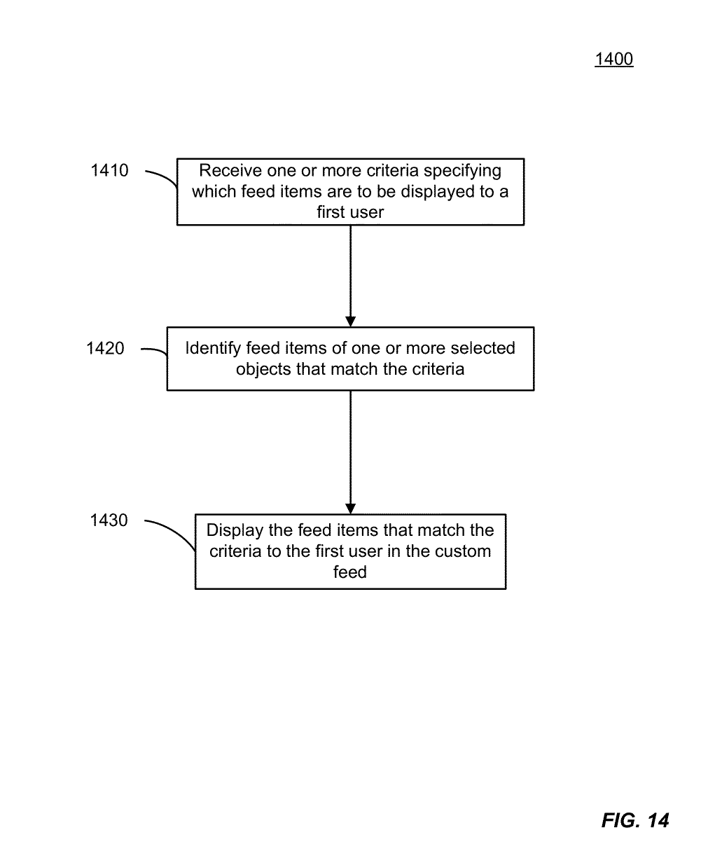

FIG. 15 is a flow chart that illustrates an exemplary process 1500 for automatically posting information (or sharing information/content) to multiple groups or organizations supported by a database system. The process 1500 may be performed by a database system, such as a multi-tenant database system of the type described above. The process 1500 provides one or more GUI elements that are associated with a user post, the sharing of information, the distribution of content, the sending of files, or the like (task 1502). In accordance with certain embodiments, task 1502 corresponds to the rendering of an interactive user entry field, region, or control that the user manipulates to create a post, share content, send a message, distribute a file, etc. The process 1500 also provides a menu element that includes selectable entries for a plurality of different groups (task 1504), wherein the user of the database system is assumed to be a registered member of each of the plurality of groups. The menu is provided as one or more GUI elements, which in turn may be associated with the GUI elements provided by task 1502. In accordance with certain embodiments, the selection menu is presented as an option in the context of the user entry field, GUI element, or control that is otherwise utilized to create the post, share content, send a message, distribute a file, etc. This description assumes that the menu is generated and rendered as an interactive drop-down menu.

The process may continue when the user selects at least two of the groups contained in the selection menu (task 1506). In a multi-tenant database system, task 1506 may also be associated with the selection of at least two different organizations. As described above, the different groups selected by the user may be defined within only one organization/tenant supported by the database system, or the multiple groups may be distributed across a plurality of different organizations/tenants. Accordingly, although not shown in FIG. 15, the process 1500 may be performed to log the user into a plurality of different organizations, and to maintain a persistent logged-in status for the user across those organizations. In turn, the persistent logged-in status can be used to accommodate seamless information sharing across multiple organizations if needed.

This example assumes that the user selects multiple groups as “recipients” of common information or content, e.g., a post or a message. Accordingly, the process 1500 receives the information to be posted, shared, distributed, or sent (task 1508). The process 1500 also obtains a group selection request that identifies the groups selected at task 1506. The group selection request is generated in response to user interaction with the selection menu, as described above. In certain practical embodiments, the process 1500 obtains the group selection request concurrently with receiving the information. Indeed, the group selection and the information to be shared may be provided to the database system in a single communication from the user device. The process 1500 responds to the communication by updating the database system as needed (task 1510). In this regard, the database system is updated to provide the received information to the selected groups, to members of the groups, or the like. Notably, the shared information is distributed as needed in an automated and seamless manner without any further action by the user. In other words, the information can be directed to the plurality of different groups (which may be across different organizations) in a single-step manner without requiring additional posting/sharing action on the part of the user.

Thereafter, the shared information will be available at the applicable destination and in the desired format as required by the different groups. For example, a shared post may appear on the respective home page or wall for each of the selected groups. As another example, a shared file might appear as available for download in a respective “Group Files” area for each of the selected groups.

XIV. Blind Mentions of Users in an Information Networking Environment

A database system of the type described above may be suitably configured to publish content using a variety of techniques, tools, or applications. For example, the database system may support one or more of the following features: chatting; private messaging; email; message posting; instant messaging; conversation threads; commenting; notes; etc. In accordance with existing information networking applications and systems, the author of content (e.g., a post) can mention another user using a special character such as “@” (resulting in an “at-mention”). When a user is at-mentioned in the body of a post, the system responds by sending the mentioned user a message to let the user know that she was referred to in a post. The message to the mentioned user will usually include a link to the published post. Moreover, the mentioned user's name (or identifier) will usually appear in the published content in hypertext format that links to the mentioned user's home page or profile. For example, the user Mark Smith may create the following post:
Mark Smith: I will be meeting @John Doe and a few others for lunch today. Feel free to join us at @The Best Burger at noon!
   This post includes two at-mentions—the first identifies the user John Doe, and the second identifies the user The Best Burger. After Mark Smith submits this post for publication, the system will send one notification to John Doe and another notification to The Best Burger. The published representation of the post will appear as above (with or without the “@” symbols), with the italicized text formatted as hypertext. Thus, any user that clicks on @John Doe will be taken to the profile or home page of John Doe.

In certain situations, however, it may be desirable to automatically notify or inform a user in a manner that is transparent to the readers of the published content or in a manner that does not provide a link to the user's profile page. Referring again to the above example, assume that Mark Smith would like to invite his wife Kate Smith to the same lunch, but for some reason he is reluctant to publish a link to Kate Smith's profile page. As another example, assume that Mark Smith would like to discreetly inform his supervisor Jeff Doe of the lunch without letting anyone else know that Jeff Doe might attend the lunch. Traditional at-mention mechanisms do not contemplate such situations. Rather, conventional at-mention techniques will result in the publication of @Kate Smith and @Jeff Doe within the body of the post, as explained above.

A database system as described here can be suitably configured to support a “blind at-mention” feature that addresses the scenario described above. In accordance with this feature, the author of content to be published or distributed can reference one or more users while creating the content. The reference may, but need not, be embedded in the body of the content (in a manner similar to traditional at-mentions). In certain embodiments, one or more special characters or a predefined string of characters are entered before and/or after the username of the blind mentioned user. As one possible implementation, a blind at-mention is created when a single special character (such as the ampersand symbol, the percentage symbol, or the like) immediately precedes the username, e.g., &Kate Smith or % Jeff Doe.

In accordance with the example described above, the author Mark Smith could blind mention his wife and his supervisor in the following manner:
Mark Smith: I will be meeting @John Doe &Jeff Doe and a few others for lunch today. Feel free to join us at @The Best Burger at noon! My wife &Kate Smith may join me as well.

The user-entered text includes two blind at-mentions—the first identifies the user Jeff Doe, and the second identifies the user Kate Smith. This content will be visible to the author Mark Smith as he creates the post. However, after Mark Smith submits this post, the database system detects the two blind at mentions and removes or hides them from the published version of the post. Consequently, the actual published version of the post, which is visible to all users, will appear as follows:
Mark Smith: I will be meeting @John Doe and a few others for lunch today. Feel free to join us at @The Best Burger at noon! My wife may join me as well.
   Thus, readers of the published post (other than the creator, Mark Smith) will be unaware that Jeff Doe and Kate Smith were actually notified of the post. Moreover, the published post will contain no hypertext or links associated with the users Jeff Doe and Kate Smith. In certain embodiments, however, the blind at mentions will be visible to the author Mark Smith, assuming that he is logged in using the appropriate credentials.

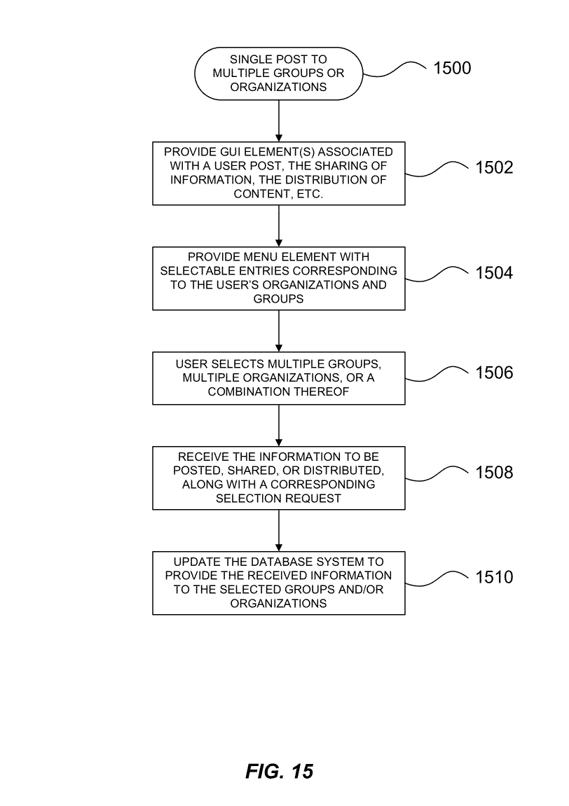

FIG. 16 is a flow chart that illustrates an exemplary process 1600 for notifying users of content published in an information networking environment by way of a blind at-mention scheme, as described above. The process 1600 may be performed by a database system, such as a multi-tenant database system of the type described above. The process 1600 provides one or more GUI elements that are associated with the creation or authoring of a user post, the sharing of information, the distribution of content, the sending of files, or the like (task 1602). In accordance with certain embodiments, task 1602 corresponds to the rendering of an interactive user entry field, region, or control that the user manipulates to create a post, share content, send a message, distribute a file, etc. This example assumes that the user is preparing a post to be published on her main page, although the techniques and technologies described herein are also applicable to other types of authored content, in any desired format.

In accordance with conventional methodologies, the user authors the post using an appropriate input device (e.g., a keyboard). This example assumes that the post includes content that the author intends to be published and viewable as usual. This portion of the user-entered information represents the “to be published content.” In addition, this example assumes that the post includes at least one blind at-mention of another user. As explained above, the blind at-mention includes an identifier of a user of the database system (e.g., a username, a nickname, an email address, or the like) along with a blind copy designator for the identifier. In certain implementations, the blind copy designator includes at least one special character that immediately precedes or follows the identifier of the user. In some embodiments, the blind copy designator includes a defined string of one or more characters that immediately precedes or follows the identifier of the user. For the example described here, the blind copy designator is the ampersand symbol. Moreover, the database system only recognizes user-entered text as a blind at-mention if the ampersand symbol immediately precedes the intended user identifier, without any space between the ampersand symbol and the user identifier.

After authoring the post, the user takes some action that causes the post to be entered or submitted. For example, the user may click on a GUI element labeled “Submit Post” or “OK”. In response to such interaction, the database system receives a corresponding request to publish at least the “to be published” content (task 1604). The received request will include or identify the desired content for publication, along with the text, characters, or data for the blind at-mention. Moreover, the received request may include or identify the text, characters, or data for any conventional at-mentions created by the user. The database system processes the request in an appropriate manner, initiates database updates as needed, and otherwise handles the received request to publish at least some of the content (task 1606). Notably, the database system releases the “to be published” content such that the published content includes no indicia of the identifier of the blind mentioned user. As explained above, the actual published post as viewed by users other than the author will not include the user-entered text corresponding to the blind at-mention.

The process 1600 continues by communicating a notification to the blind mentioned user of the database system (task 1608). The notification may be provided in one or more of the following formats, without limitation: a private message; an instant message; an email; a text message; a pop-up window; or the like. The notification may include a reference to the published content, e.g., a hyperlink, hypertext, or a URL that points to the published content. Thus, the blind mentioned user can quickly and easily access the published content via the received notification.

XV. Advanced Searching for Posts/Comments

A database system of the type described above may be suitably configured to support a variety of information and content sharing, posting, distribution, and communication techniques. In this regard, and in accordance with conventional social networking systems, the database system allows a user to create posts, which may appear on the profile page of the user, on the profile page of a different user, on the profile page of a group or an organization, or elsewhere. A user's profile page typically includes an area that is devoted to posts created by the user, along with related comments, replies, notes, attachments, and the like. The posts that appear on a user's profile page are usually arranged in chronological order with the newest posts or thread at the top of the posting area. Older posts may be viewed by scrolling down on the profile page, by viewing subpages, by visiting an archive, or the like. In this context, the feed items 710, 720 shown in FIG. 7 represent two posts made to a group, along with associated comments 730 for the feed item 720.

In accordance with that depicted in FIG. 7, conventional social networking applications show the most recent user-posted content, comments, and updates, and it can be cumbersome and frustrating to find a specific post or comment that was published a long time ago (e.g., weeks or months in the past). For example, the user may need to scroll down to the bottom of a long page, click through multiple pages of historical posts, or click on a “show more” link or button multiple times to reach the desired time period, and then scan the current page to find the actual post or comment of interest.

A database system as described here can be suitably configured to support an enhanced or advanced search feature that enables a user to quickly and easily locate posted and published content such as user posts, comments, notes, remarks, and the like. In certain embodiments, the search function utilizes a suitably configured and formatted interactive GUI control, which may appear on the user's profile page, on a devoted “search” page or window, or on any other page or GUI element that is accessible by the user. The search interface may be provided as a pop-up window or frame that appears in response to the user selecting a context menu item (e.g., if the user “right clicks” on a displayed post or comment, or within a region that is used to display posts, such as the user's wall), or in response to the user selecting a designated link or dropdown menu item. Alternatively, the search interface may be rendered as a persistent element on the user's profile page. For example, the search interface may be located at or near the top of the profile page, or in a sidebar of the profile page.

Although not always required, the interactive searching interface described here utilizes at least three data entry elements, which may be implemented as text entry fields, regions, or boxes. One text entry box is designated for text (or any type of data, characters, or information) that indicates at least one author of a post. Another text entry box is designated for text (or any form of data, characters, or information) that indicates at least one destination, recipient, or addressee of a post. A third text entry box is designated for text (or any form of data, characters, or information) that indicates body content of a post. These data entry elements may be arranged in any desired format or configuration to accommodate ease of use. Each text entry box may be populated with a “disappearing” label that identifies its purpose, wherein the label disappears when the user focuses in the text entry box or when the user starts using the text entry box. For example, the first text entry box may initially include the label “User Name of Poster”, the second text entry box may initially display the label “Where or To Whom Posted”, and the third text entry box may initially contain the label “Enter Keywords or Search Strings”.

The characteristics and functionality of the data entry elements, and the manner in which the database system processes the user input, may vary from one implementation to another. Moreover, the searching function may leverage any number of existing data search technologies if so desired. For example, the database system may support keyword searching, specific text string searching via the use of quotation marks, Boolean operators, and other schemes and techniques that may be found in other search engine applications.

It should be appreciated that the interactive search feature may use alternative and/or additional search fields, depending on the embodiment. That said, most information network systems that handle user posts and comments maintain data that indicates when posts were made, who created the posts, and where or to whom posts were directed. Accordingly, the three specific data entry elements mentioned above will be suitable for most if not all practical scenarios.

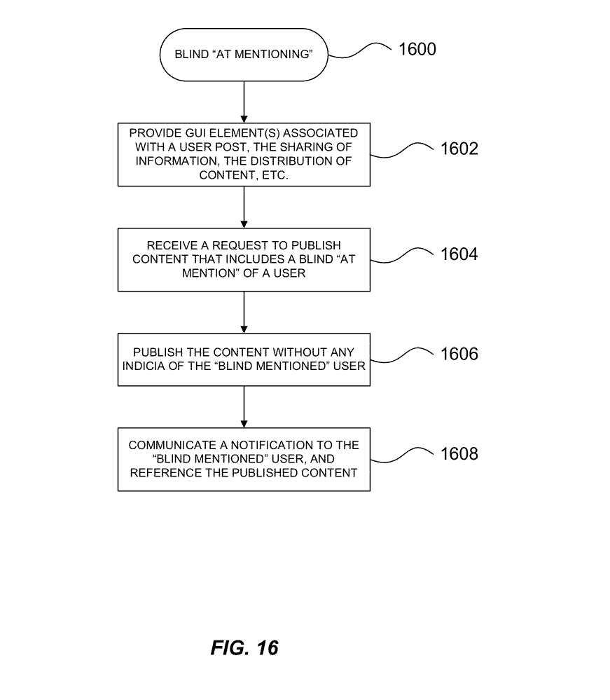

FIG. 17 is a flow chart that illustrates an exemplary process 1700 for enhanced searching of content that is posted in an information networking environment. The process 1700 assumes that the host database system employs a searching feature of the type described above. Accordingly, the database system operates to provide a suitably formatted interactive searching interface to the user (task 1702). As mentioned above, the searching interface includes a plurality of data entry elements, e.g., a number of distinct text entry boxes that are specified for purposes of searching certain predefined fields, data objects, metadata, and/or other information related to published posts, comments, notes, or content. In this regard, the data entry elements correspond to searchable fields of user posts published by the database system.

This description assumes that the user interacts with the searching interface, inputs data into at least one of the text entry boxes, and initiates a search by manipulating a GUI control item (e.g., a “Go” button, a “Search” button, or a “Find Posts” button). In response to such user interaction with the searching interface, the database system receives the user-entered search criteria (task 1704) and applies the search criteria in an attempt to locate relevant user posts published by the database system. The process 1700 queries the database system with the received search criteria to find matching user posts that satisfy the search criteria (task 1706). As used here, “user posts” is intended to contemplate posts, comments, notes, remarks, chat records, and/or other types of published content that might be available to the user.

This example assumes that task 1706 finds one or more matching user posts. The process 1700 continues by displaying results that indicate, include, or otherwise reference the matching user posts (task 1708). For example, task 1708 may generate a list of matching posts and display the list as an overlay element on the page. In certain embodiments, the list of matching posts is interactive in that it allows the user to select any of the displayed matching posts, wherein selecting a post initiates some other action (e.g., opening the full version of the post, navigating to the page or location where the selected post resides, displaying a context menu, etc.). If a large number of matching posts are found, the displayed list may be rendered as a scrollable element, or as a multi-page element.

In accordance with one optional feature, the matching user posts can be filtered using predefined filtering criteria. For example, the list of matching posts could be sorted or filtered according to username, posting date, or the like. As another example, the process 1700 could filter the matching posts in accordance with a user-selected time frame (task 1710). In this regard, a dropdown menu may be provided to allow the user to select a desired time frame for filtering the results. In accordance with one non-limiting example, the dropdown menu includes the following selectable filtering criteria: 1 Month; 3 Months; 6 Months; 1 Year; 2 Years; and Older Than 2 Years.

XVI. Collaborative Advertising in an Information Networking Environment

A database system of the type described herein may be suitably configured to distribute electronic advertisements to its users, leveraging common and well-known electronic advertising techniques and technologies. For instance, targeted or otherwise intelligent advertisements can be pushed to individual users based on their preferences, profile data, “likes” and “dislikes”, and possibly other criteria. Electronic advertisements may be provided for presentation on a user's home or profile page, collected on a special advertisement page, or the like.

The database system described here allows users to collaborate in association with electronic advertisements that are presented to them. More specifically, the database system provides one or more collaboration mechanisms in conjunction with electronic advertisements, wherein the collaboration mechanisms enable users to directly share, recommend, suggest, like/dislike, comment on, flag, and/or perform other interactive actions on (or in connection with) electronic advertisements. Such collaborative features provide better user context to the advertisements, increase the likelihood that relevant advertisements will reach interested users, and otherwise increase the advertising value for advertisers.

In certain embodiments, the interactive collaboration tool and the host database system are suitably configured to allow the recipient of an electronic advertisement to share the advertisement with other users, a group of users, an organization, etc. In this regard, a copy of the electronic advertisement will be provided to other users, groups, or entities identified by the recipient. Moreover, a shared advertisement may be delivered with a note or comment from the recipient, such as “I know that you are looking for a new fountain pen. Check out this awesome Japanese pen with a fine nib.”

As another example, the interactive collaboration mechanism and the host database system are configured to allow the recipient of an electronic advertisement to directly and immediately create a comment, remark, or note for the advertisement. For example, if the user is interested in an advertised produce but has a question, the user can post a comment in association with the advertisement, with the assumption that a marketing representative will see the comment and post a response. To this end, comments or notes entered in association with an electronic advertisement could be automatically sent to the advertising company, a marketing representative, a salesman, or the like (rather than simply having the comment appear to the users of the information networking system).

As another example, the interactive collaboration mechanism and the host database system are configured to allow the recipient of an electronic advertisement to quickly and easily notify other users by way of an at-mention function. In this regard, the collaboration mechanism may allow the user to create an at-mention (or any number of at-mentions) to notify another user of the advertisement. Use of the at-mention feature enables the recipient of an advertisement to quickly suggest or refer the received advertisement to other users. For example, a user may want to ask his friends about a product featured in an electronic advertisement and solicit feedback or comments on the advertisement.

The interactive collaboration mechanism and the database system may also be configured to receive and process “likes” and “dislikes” (or any type of voting information) corresponding to electronic advertisements. The accumulated like/dislike totals can be considered by other users and by the advertisers to determine levels of interest, advertising success, etc.

In certain embodiments, the database system maintains a region (on the user's profile page, such as a sidebar element) that is devoted to advertisement feeds. The advertisement feeds provide a summary or an indication of the advertisements, products, or services that have been recommended, shared, suggested, or “liked” by their friends. Notably, the collaboration mechanism is linked to each advertisement on an individualized basis, regardless of where or how the advertisements are presented to the users. In certain implementations, the collaboration mechanism is implemented as an integral part of the an electronic advertisement itself. In some embodiments, the collaboration mechanism “follows” an electronic advertisement such that the desired functionality is available regardless of the manner in which the advertisement is delivered and rendered for the end user.

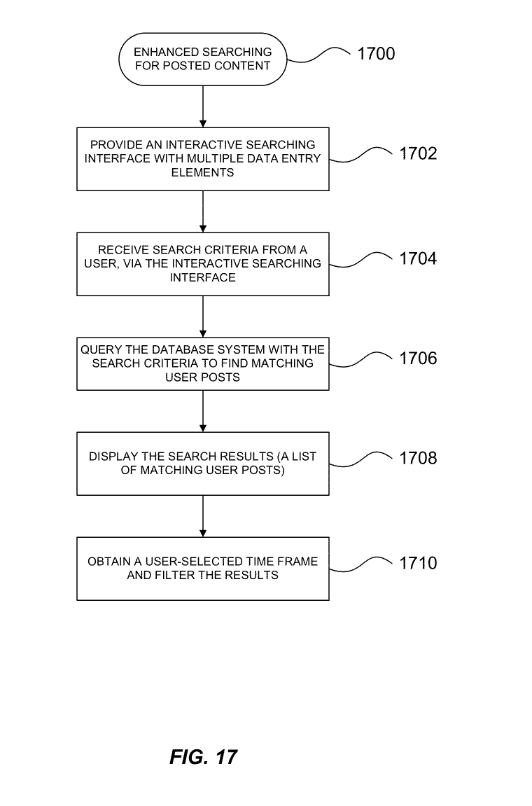

FIG. 18 is a flow chart that illustrates an exemplary process 1800 for electronic advertising collaboration in an information networking environment. The process 1800 begins by providing an electronic advertisement to a user (task 1802). This example assumes that the advertisement is published on the user's profile page. Alternatively, the advertisement could be delivered in an email format, as a text message, or on any webpage accessible to the user of the database system. The process 1800 also provides an interactive collaboration mechanism in association with the provided electronic advertisement (task 1804). The collaboration mechanism may be provided as an integral component of the electronic advertisement, for example, in a header or footer region of the advertisement space, as a graphical interface that is launched by hovering over or “right clicking” on the advertisement space, or the like. In certain embodiments, the electronic advertisement and the collaboration mechanism are concurrently provided together on a common graphical user interface screen, e.g., the user's profile page. The collaboration mechanism is preferably realized as an interactive GUI control that accommodates user manipulation, data entry, and the like.

The collaboration mechanism may include, without limitation, one or more of the following items: text entry fields; voting buttons (e.g., “like” or “dislike” buttons); command buttons (e.g., “Share” or “Recommend”); and dropdown menus (e.g., a “Contacts List” menu). In this regard, the collaboration mechanism may include a comment field in which the user can enter notes to be published in association with the advertisement. Moreover, the comment field (or any text entry field) could be utilized to at-mention one or more users in the context of the electronic advertisement. It should be appreciated that the specific format, content, and arrangement of elements corresponding to the collaboration mechanism may vary from one embodiment to another, from one user to another, from one tenant to another, etc.

This description assumes that the user interacts with the collaboration mechanism, inputs data into at least one of the text entry fields, and generates one or more collaboration requests by manipulating a GUI control item (e.g., a “Share” button, a “Send” button, or a “Like” button). In response to such user interaction with the collaboration mechanism, the database system receives at least one collaboration request (task 1806), which corresponds to or is otherwise associated with the electronic advertisement. The process 1800 handles the collaboration request in an appropriate manner and updates the database system in accordance with the collaboration request (task 1808). The process 1800 may also take additional actions as needed to satisfy the requirements of the collaboration request.

In some scenarios, the collaboration mechanism obtains a sharing command from the user, wherein the sharing command identifies a second user of the database system. In such situations, the database system is updated to share the electronic advertisement with the second user. Thus, the shared advertisement may be published on the second user's profile page, or it may be electronically delivered to a device that is registered to the second user.

As another example, the collaboration mechanism obtains a suggest command from the user, wherein the suggest command identifies a second user of the database system. In accordance with this example, the database system is updated to communicate a notification to the second user. The notification may include a reference to the electronic advertisement, such as a link, a URL, hypertext, or the like.

As another example, the collaboration mechanism obtains a comment (or any written text) from the user. Although not required, this description assumes that the comment is contextually related to the electronic advertisement in some manner. In accordance with this example, the database system is updated to publish the comment in association with the electronic advertisement. The published comment appears at or near the published location of the electronic advertisement. The published comment may also be distributed to other instantiations of the same electronic advertisement, across multiple users of the information networking system.

As yet another example, the collaboration mechanism can be used to obtain a like or dislike command (or any type of voting command) from the user, wherein a like command indicates that the user likes the electronic advertisement, and a dislike command indicates that the user dislikes the electronic advertisement. For this example, the database system is updated to adjust the like/dislike score maintained for the electronic advertisement. The score may be maintained for the particular instance of the advertisement that appears on the user's profile page, or it may be “globally” maintained for all instances of the same advertisement, regardless of where it appears in the information networking environment.

The collaboration methodologies described above can be applied to any and all advertisements provided by the information networking system on an individualized basis. Thus, each user has the ability to share, comment on, like, dislike, or at-mention advertisements. Moreover, comments and votes could be collected and shared throughout some or all of the information networking environment, and/or provided to advertisers if so desired.

XVII. Designating Favorite Users for a Chat Feature

A database system of the type described herein may be suitably configured to support a chat feature for the users of an information networking environment, leveraging common and well-known interactive chat methodologies and technologies. For instance, the database system may generate and provide a chat window at the request of a user, wherein the chat window can be manipulated by the user to invite other users to participate in a chat session, and wherein the chat window can be utilized to carry out the chat session in an ongoing manner. The chat window may display a searchable or scrollable list of users to enable the selection of chat invitees. In accordance with traditional chat interfaces, however, if the user wants to chat with a group of people, he needs to initiate a chat, search for other users to invite, and add all of the chat participants one by one. This can be a time consuming and repetitive process, especially if the user initiates many chat sessions throughout the day.

To address this issue, the database system presented here provides an interactive user interface that allows the user to designate any number of individuals and/or any number of user groups as “chat favorites” in accordance with the user's preferences. In this regard, a user can select any number of other users, designate and name a group for the selected users, and add that group to her list of chat favorites. Likewise, the user can designate any individual member of the information networking environment as one of her chat favorites. The chat window interface is updated as needed to reflect the user's current list of individual chat favorites and group chat favorites. Notably, the list of chat favorites may be provided in conjunction with a conventional “contacts” list of users, or in conjunction with a conventional list of “followed” users.

It should be appreciated that a favorite group is distinguishable from a “group” chat that may involve a system-defined or organization-defined group of users, which has been established without regard to the particular user. In other words, the members of a favorite group are selected by the user himself, and the list of members within any group can be modified at the request of the user.

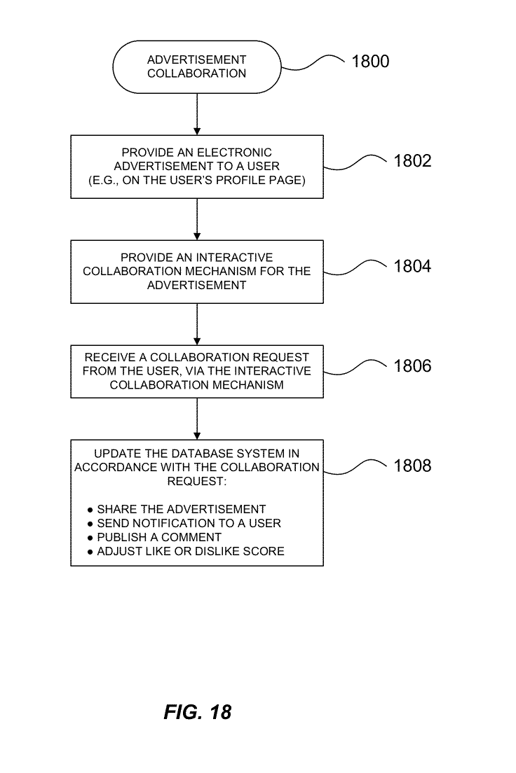

FIG. 19 depicts a portion of a chat window 1900, which includes a chat favorites element 1902. The chat window 1900 is used to find and select users or user groups for purposes of a chat session. A “host” user can invite individual users or user groups to join a chat session by interacting with the chat window 1900. The chat favorites element 1902 is realized as a graphical and interactive feature of the chat window 1900. The entries under the “My Favorites” heading correspond to the favorite users and favorite user groups, as designated by the user. Individual users and user groups can be added to the “My Favorites” list in any suitable manner. Moreover, favorite groups can be created by the host user in any manner. Although any number of favorite entries could be maintained, FIG. 19 shows only one entry 1904 for an individual user, and only one entry 1906 for a user group (“My Team”).

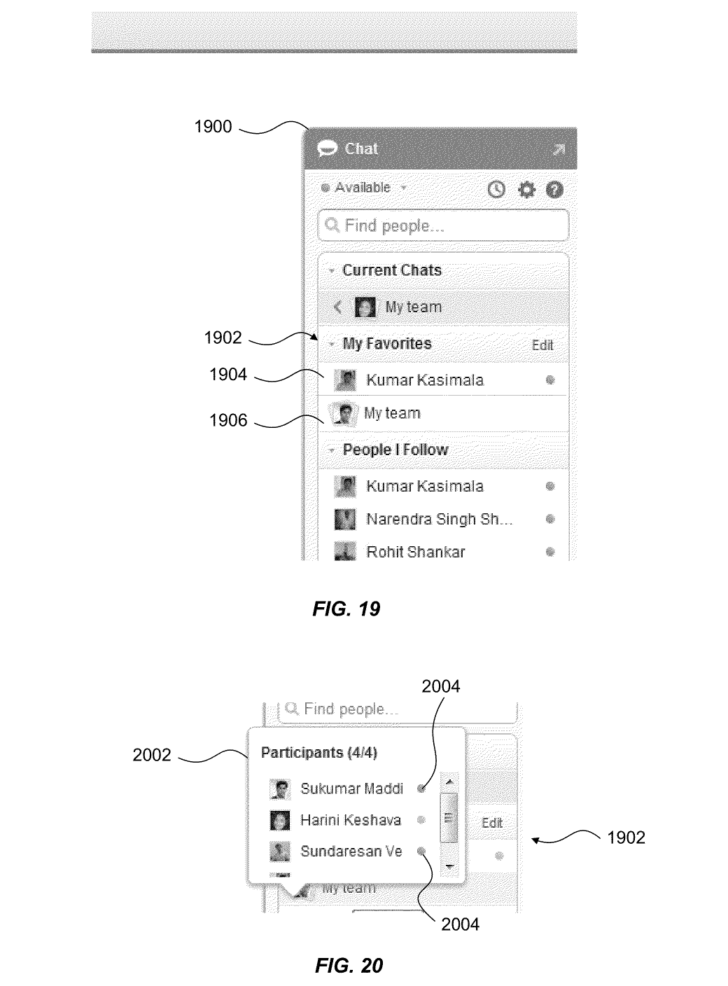

FIG. 20 depicts the chat favorites element 1902 with at least some of the members of the “My Team” user group shown in an expanded form. The chat favorites element 1902 includes or is associated with a member list 2002 corresponding to the entry 1906 for the user group. The member list 2002 indicates that the “My Team” user group includes four members or participants. Moreover, the member list 2002 is implemented as an interactive element that allows the user to scroll through the member list 2002 (if the entire list is too long to show in its entirety). The member list 2002 may also include status icons 2004 that indicate the availability status of each member of the user group (e.g., online, offline, out of office, in a meeting, etc.).

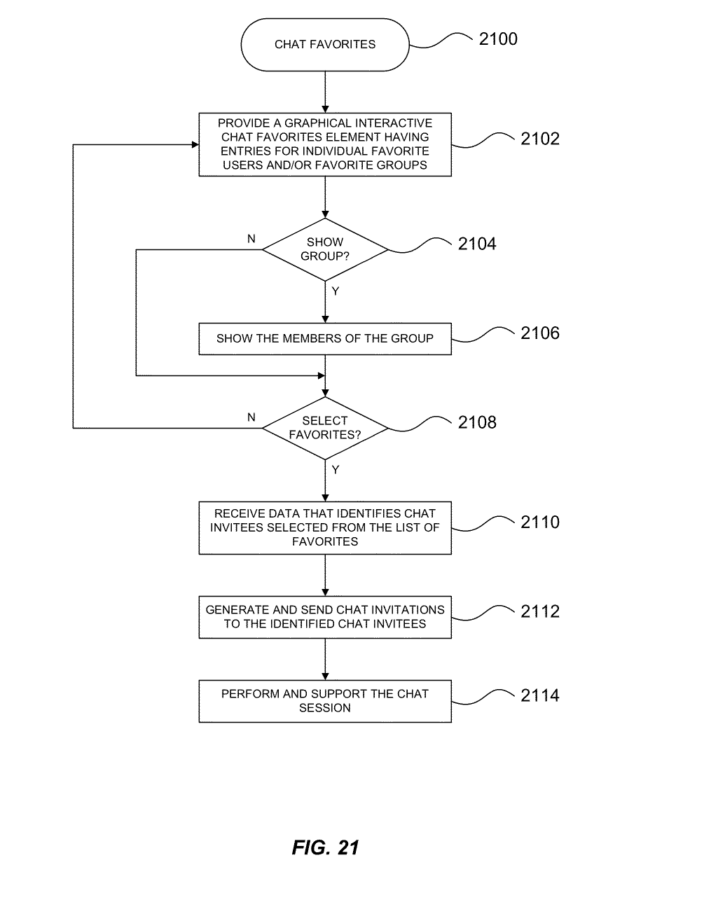

FIG. 21 is a flow chart that illustrates an exemplary process 2100 for supporting a chat favorites feature in an information networking environment. The process 2100 assumes that the host system has already been configured to support the chat favorites functionality described above. Accordingly, the process 2100 provides the graphical interactive chat favorites element in association with a chat window (task 2102). The chat favorites element may appear automatically when the host user launches the chat window, or it may remain hidden until opened by the host user. As explained above, the chat favorites element includes a list of at least one favorite user and/or at least one favorite group, as designated, defined, or selected by the host user. In other words, the chat favorites list is personal to that particular user.

This example assumes that the list includes an entry that identifies a defined group of users. If the process 2100 detects a certain form of user interaction with the entry (the “Yes” branch of query task 2104), then the chat favorites element is updated to provide and show a member list that indicates the individual members of the group. The user interaction may be, for example, a “right click” action associated with the entry, a cursor hovering action associated with the entry, or the selection of an interactive GUI element (an icon, button, link, or the like).

This description assumes that the host user selects one or more favorites from the chat favorites element (the “Yes” branch of query task 2108). In this regard, the user may select one or more individual users, one or more user groups, or any combination thereof. In certain embodiments, an individual member of a favorite group can be selected if the group has been expanded to show the individual members (see FIG. 20). Favorites can be selected in any manner (using, for example, a “right click” action associated with an entry, a “double click” action associated with an entry, or the selection of an interactive GUI element (an icon, button, link, or the like).

The database system receives data that identifies one or more chat invitees selected from the interactive chat favorites element (task 2110), and responds to the received data by generating and sending chat invitations to the chat invitees (task 2112). Thereafter, the process 2100 may perform and support a chat session that includes the host user and one or more of the chat invitees (task 2114), using conventional chat functionality. During the chat session, the host user may revisit the chat favorites element to invite other favorite users or favorite groups to join the current chat session.

As explained previously, the database system may receive requests to designate selected users as favorites of the host user, and/or requests to designate favorite groups of the host user. Such requests may be initiated by the host user using the interactive chat favorites element. The database system responds to such requests by updating the list of favorites in accordance with the new favorite designations conveyed by the requests. Of course, the host user may also remove users and groups from the favorites list, modify the membership of a favorite group, rename a group, and perform other actions related to the creation, deletion, maintenance, or use of the chat favorites.

XVIII. Automatic “Out of Office” Post Generation

A database system of the type described herein may be suitably configured to support an automatic response or reply feature that generates and publishes automated posts on behalf of users when certain conditions are satisfied. More specifically, a user of an information networking environment can configure an “out of office” type of response such that an automated response post (which includes a user-defined message) is generated and published whenever a post, comment, message or other content published in the information networking environment refers to, identifies, or mentions the user.

The database system provides an option to allow the user to create, specify, and configure an automated response post. For example, the system may generate and display an interactive configuration screen or window that allows the user to enter relevant information and automatic response criteria including, without limitation: the user's name (to be included in automatic response posts); the user's title; the user's email address; the user's telephone number(s); the message content to be included in automatic response posts; a group or a list of groups to which automatic post responses will be directed; an organization or a list of organizations to which automatic post responses will be directed; a time period or duration during which automatic post responses will be published; and whether or not the automatic response function is active. Assuming that the feature is active, an automatic response post will be generated and published when: (1) a post mentions or otherwise refers to the user; and (2) the context of the post satisfies the automatic response criteria for the user. In certain embodiments, automatic post responses are contemplated whenever the user is at-mentioned in a post, comment, message, etc.

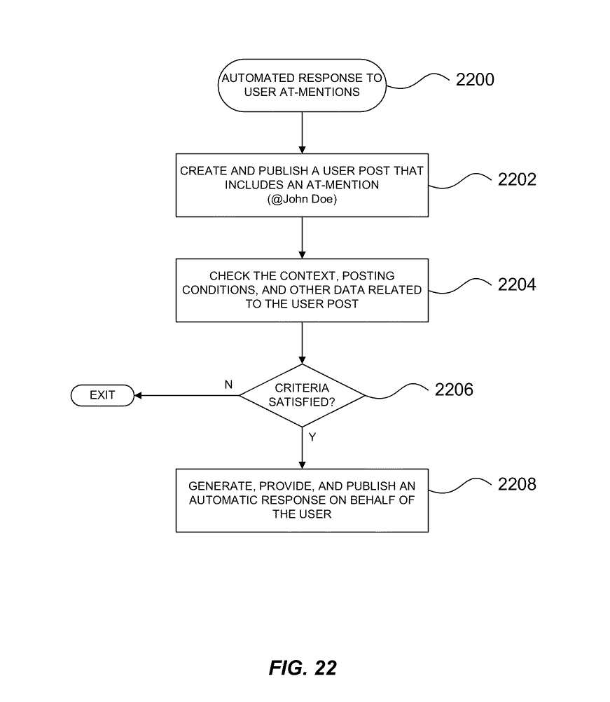

FIG. 22 is a flow chart that illustrates an exemplary process 2200 for automatically responding to posts. The process 2200 assumes that the host system has already been configured to support the automatic response functionality described above. This description assumes that the host database system has created and published a user post, comment, message, or any content that includes an at-mention identifying a user of the information networking environment (task 2202). In accordance with common posting conventions, at-mentions are formatted as “@username” (where “username” is replaced with the actual user name of the mentioned person).

The process 2200 publishes the post in a conventional manner such that the at-mention appears as hypertext to establish a link to the mentioned person's account, profile page, or the like. In addition, the database system checks the context, posting conditions, and/or other data related to the post (task 2204) to determine whether or not the context of the post satisfies the designated and defined automatic response criteria for the mentioned user (query task 2206). For example, task 2204 may check whether the automatic post response feature is currently active, whether the referencing post originated from a group that is eligible to receive automatic response posts, whether the referencing post was made during the time period defined for automatic response posts, etc.

This description assumes that the automatic response criteria is satisfied (the “Yes” branch of query task 2206). Accordingly, the process 2200 continues by generating, providing, and publishing an appropriate automatic response post on behalf of the mentioned user (task 2208). Notably, the body of the automatic response post will include the response message chosen by the mentioned user. The response message may be selected from a menu of standard responses, generated from a template, or authored by the mentioned user when manipulating the configuration or setup screen. In certain embodiments, the original referencing post is published in a topic thread (which may appear, for example, on a profile page, a group home page, or the like). Consequently, the automatic response post is also published in the same topic thread, such that it appears in chronological order in accordance with the usual posting conventions used by the information networking environment.

As one example, a referencing post and a corresponding automated response post may appear as follows:

Mark Jones: Good morning team! I have a meeting with @Mike Ness this
afternoon, and will report back to everyone tomorrow morning. In my
absence, you should coordinate with @Dilbert Sullivan or my secretary.

| | |
|---|---|
| COMMENT - LIKE - SHARE | Today at 9:57 AM |

| Dilbert Sullivan: I am on vacation until next Monday. I will be | |
|---|---|
| checking my email from time to time. Thanks! (Auto Post) | |
| LIKE | Today at 9:57 AM |
| Mike Ness: Hey Mark, I'm looking forward to our meeting. Don't | |
| forget to bring the notes from the other day. | |
| LIKE | Today at 10:26 AM |

For this example, the user Mark Jones created the first post, which includes two at-mentions: one referencing the user Mike Ness, and one referencing the user Dilbert Sullivan. The database system processes the at-mention of Dilbert Sullivan in accordance with the automatic response methodology outlined above, determines that the automatic response criteria has been satisfied, and immediately generates a response post on behalf of Dilbert Sullivan. This “Auto Post” appears in the same thread as the original referencing post, and it has the same time stamp as the original post. Even though Dilbert Sullivan is currently unavailable, the original post remains unchanged (the at-mention of Dilbert Sullivan remains visible and effective as hypertext). This example also shows a normal user-entered response post created by the user Mike Ness, arranged in the same thread.

XIX. Smart Posting to Multiple Groups/Organizations

A database system of the type described herein may be suitably configured to support a smart posting methodology that enables a user to post content within one or more groups across different tenants or organizations in a multi-tenant database environment. In this regard, a single user may have login credentials for different tenants (instances) of the multi-tenant database environment. Moreover, that user may be a member of the “same” group across multiple instances. For example, the user may be a member of the “Softball” group defined within Tenant 1, and a member of the Softball group defined within Tenant 2. As another example, the user may be a member of the Wednesday Lunch group, which is commonly defined across multiple instances. In such a scenario, the same discussion topic or thread may appear concurrently across different instances. For example, a discussion about next week's lunch menu may be commonly discussed in the Wednesday Lunch group, regardless of the tenant. In accordance with traditional user posting protocols and methodologies, the user must log in to each instance and independently author the same post if she wants the message to be received across all of the tenants. Section XIII, which appears above, describes an approach that could be utilized to post content to multiple groups.

The approach described here provides an option to configure a common group that exists across multiple organizations/tenants. After identifying the tenants that are eligible for common group posting, an author of a post can select linked tenants for purposes of common posting. Moreover, if another user responds to a “common” post in any of the linked tenants, the response will be reflected in all of the linked groups across the different tenants.

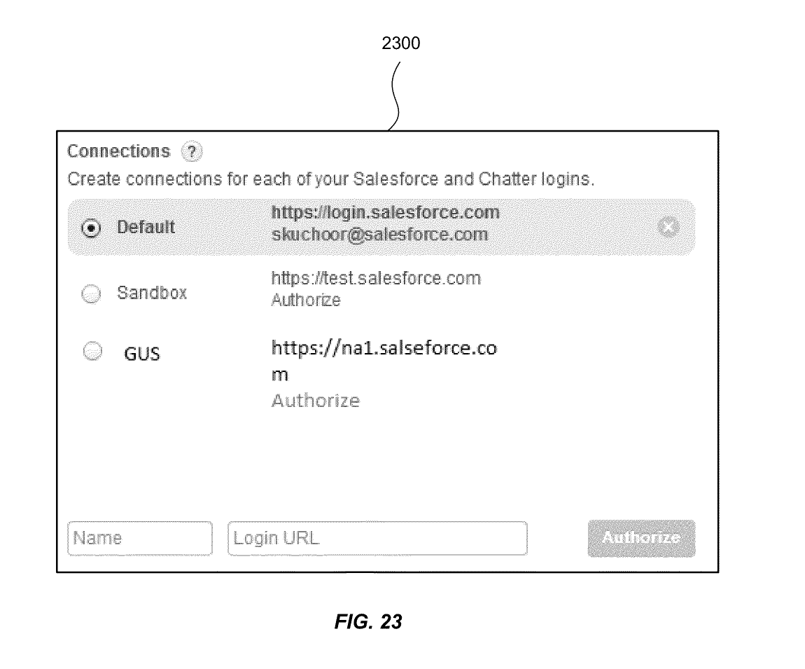

FIG. 23 depicts a configuration interface 2300 that can be used to identify or select which tenants will be subjected to the common group posting methodology. The configuration interface 2300 may be launched from the user's home or profile page, or it may be provided elsewhere. The configuration interface 2300 allows the user to create persistent login connections for different instances, tenants, or organizations for which the user has login credentials. The user selects each instance (one at a time), and enters the respective login information to establish the backend links across groups defined in the tenants. This enables the user to create posts for a common group across multiple tenants without having to provide login credentials each time. Using the configuration interface 2300, the user specifies all instances that should be considered for purposes of processing common group posts (as described in more detail below).

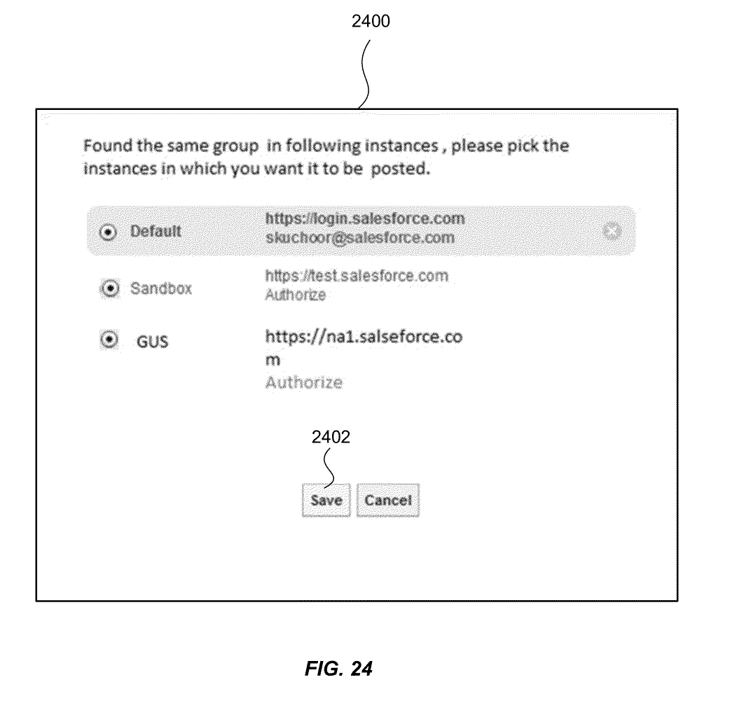

This description assumes that the user has specified three different tenants for purposes of common group posts. Notably, each tenant requires a different set of login credentials, and the user's profile page is accessed using a different URL for each tenant. This particular configuration setup is also reflected in the confirmation interface 2400 depicted in FIG. 24. The confirmation interface 2400 is described in more detail below.

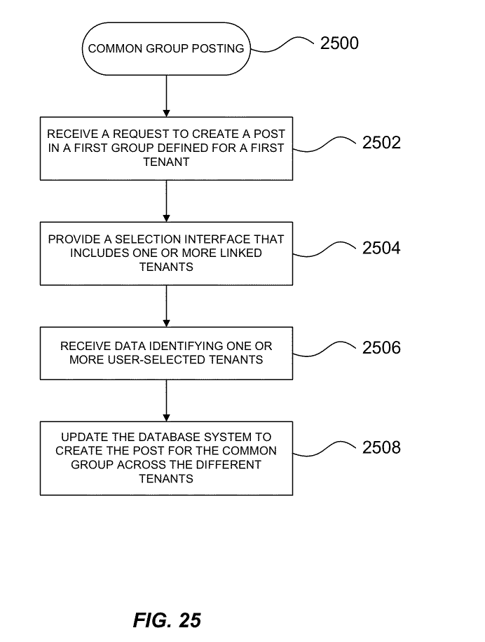

FIG. 25 is a flow chart that illustrates an exemplary process 2500 for posting content for a common group that exists across a plurality of instances. The process 2500 receives a request to create a post in a group that is defined for a first tenant of the multi-tenant database system (task 2502). The process 2500 checks to determine whether the same group exists in any of the linked tenants. If no linked tenants are found, then the process 2500 may exit or cause the post to be published only in the first group. This description assumes that the same group is found in multiple tenants. Accordingly, the process 2500 provides a selection interface that includes a list of at least one linked tenant associated with the group (task 2504). The same group is defined in each of the tenants found on the list. Referring to FIG. 24, the confirmation interface 2400 includes three entries corresponding to the three tenants in which the common group exists.

The confirmation interface 2400 prompts the user to select or identify the instances (tenants) in which the content is to be posted. FIG. 24 depicts a scenario where the user has selected all three of the instances for purposes of the common group post. After making the appropriate selections, the user may activate the save button 2402. In response to this action, the process 2500 receives data that identifies one or more of the linked tenants selected from the list (task 2506). The received data is then processed or otherwise acted upon to update the database system in an appropriate manner (task 2508). More particularly, the process 2500 creates the post in the common group across all of the designated tenants. Notably, task 2508 is performed in a seamless manner without requiring any additional login procedures. This procedure allows the user to quickly and conveniently propagate the same post to other users of the group, even though the group may span a plurality of different tenants or instances.

XX. Group-Based Synchronized File Folder Feature

A database system of the type described herein may be suitably configured to cooperate with local client devices to support a synchronized file folder feature for user groups that are defined within an information networking environment. File sharing and synchronization in this context allows members of a group to have quick local access to files (attachments) that are associated with the group in some manner. For example, attachments to posts that appear in threads maintained for the group can be automatically downloaded and synchronized at the client device level. As another example, a member of the group can locally create and save a document in the local instantiation of the synchronized group folder such that a copy of the document (along with any updates or changes) will be automatically uploaded to the server-based instantiation of the group folder.

In certain embodiments, the database system allows a user to “subscribe” to the folder synchronization service if that user is a member of a group that already has a synchronized group folder. Thus, the user can configure the local version of the synchronized folder when he initially joins the group or at any time after joining the group. In this regard, a user could create the group-based synchronized folder concurrently with the creation of the group itself. The use of a synchronized group-based folder is desirable to provide quick local access to information and files related to the group, whether or not the local user is logged into the information networking server. In other words, the local version of the synchronized folder can be updated in the background regardless of the user's activity with the group. Moreover, the local device may be any computing device, a smart phone, a tablet device, or any electronic device having the necessary computing power and network connectivity.

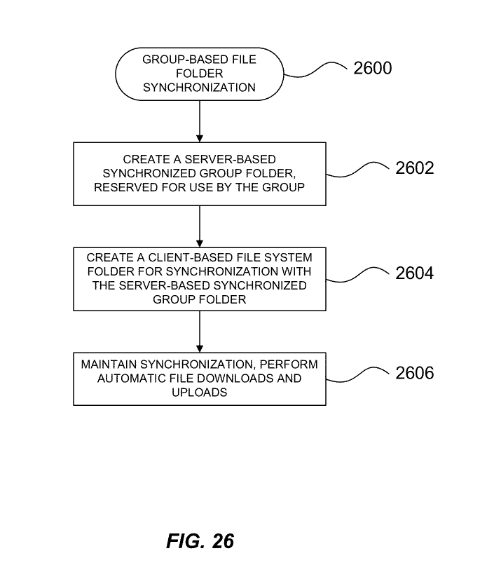

FIG. 26 is a flow chart that illustrates an exemplary process 2600 for synchronizing files for a group of users in an information networking environment. This description assumes that the host database system is compatible with the synchronization methodology outlined above. The process 2600 may begin by creating a server-based synchronized group folder, which is reserved for use by a particular group (task 2602). In certain embodiments, this server-based folder is visible to members of the group when they log into the information networking environment. For example, the server-based synchronized folder may be located on the profile or home page designated for the group.

The process also creates a corresponding client-based file system folder on a local computing device (task 2604). The local device represents the machine that provides a user with access to the information networking environment. In practice, therefore, task 2604 may be performed any number of times as needed to create a respective file system folder on each computing device used by the user. Notably, the user is a registered member of the group for which the server-based synchronized group folder was created (at task 2602).

Creation of the local file system folder may be accomplished by downloading a client application, file, or code that is written to carry out the client-side synchronization functionality. In this regard, the user may be presented with one or more interactive interface screens or elements that facilitate the creation of the client-based synchronized group folder. Accordingly, task 2604 may prompt the user to name the local folder, designate the file system directory location of the local folder, and/or designate other configuration settings as needed.

After the synchronized group folders have been created and initialized, the process 2600 maintains synchronization between the folders (task 2606) by automatically downloading files to the local folder, automatically uploading files from the local folder to the group folder, etc. It should be appreciated that the synchronized group folders can be shared by any number of subscribed group members and, therefore, the server-based group folder may need to maintain synchronization with a plurality of different local devices. Files that are associated with the group can be automatically downloaded to the local file system folder, such that the user has quick and easy access to those files. For example, assume that an attachment file is included in a post or a thread that resides on the home page of the group. The database system may be updated to add the attachment file to the server-based synchronized group folder, or the attachment file may simply remain in its original location (associated with the post/thread). Regardless of how the attachment file is handled at the server side, it will be automatically downloaded to the local file system folder of each member of the group, unless a member has not activated the synchronized folder option. As another example, a member of the group may upload a file into the server-based synchronized group folder so that the file can be automatically downloaded and shared with other members of the group.

A variety of file synchronization, replication, and/or folder synchronization techniques and technologies may also be leveraged in the context of the group-based folders. In any event, any changes or modifications to the contents of any of the synchronized folders will propagate to all other synchronized folders, to maintain consistency for all members of the group across the information networking environment.

XXI. Saving Favorite Chats in an Information Networking Environment

As mentioned above in Section XVII, a database system of the type described herein may be suitably configured to support a variety of chat features for the users of an information networking environment. Existing online chat systems may utilize a “chat history” feature that serves as a temporary archive of all chat sessions and chat conversations that involve the user. The chat history preserves all chat sessions for a designated period of time (e.g., three months) before clearing the history. Although chat history is a useful feature, it can be cumbersome to navigate and find specific chat conversations, especially if the user is a prolific chat participant. Moreover, chat history merely archives any and all chat conversations for the user, whether or not the user has any interest in those conversations.

A database system may be suitably designed in the manner described here to allow users to “favorite” a chat conversation in real-time while participating in the chat, and to designate a previously archived chat conversation as a favorite. A chat session that has been marked as a favorite by a user will be saved in a group or collection of flagged or designated favorite chat conversations, such that the user can quickly and easily view and retrieve a favorite chat conversation at a later date. Notably, the favorite chat sessions are user-specified in that the user is in control of which chat sessions are marked as personal favorites, whether or not those chat sessions are also archived in accordance with a traditional chat history feature.

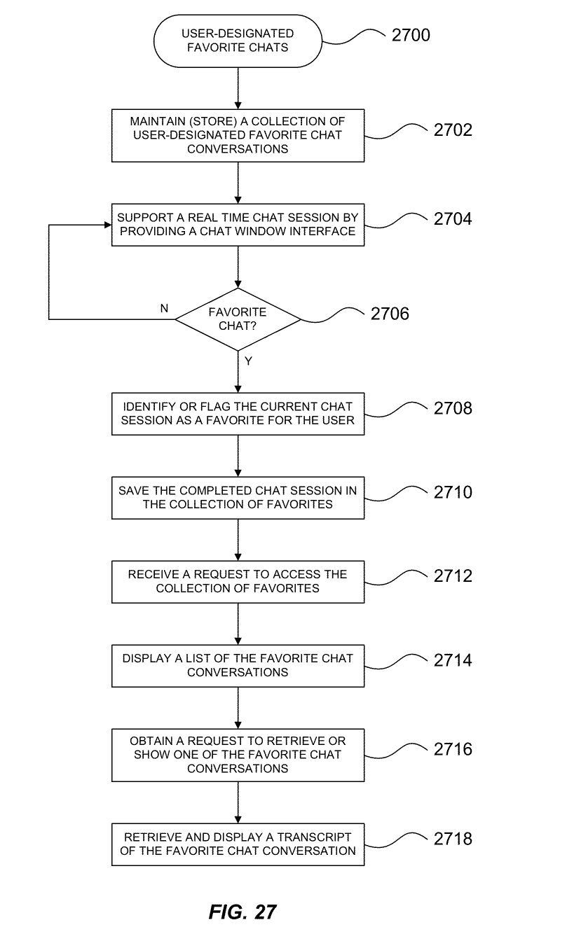

FIG. 27 is a flow chart that illustrates an exemplary process 2700 for saving and retrieving user-designated favorite chats. This description assumes that the host database system has already been configured to support the favorite chat feature mentioned above. To this end, the process 2700 maintains or stores a collection of favorite chat conversations for the user (task 2702). In practice, the database system may designate a portion of its database for favorite chats, and each user or any number of users may have a respective collection of favorite chats if so desired. Any number of favorite chat conversations could be maintained for the user, and for an indefinite period of time if so desired. The user or a system administrator may have control over the number of chat conversations that can be saved in the user's collection, how long the chat conversations are saved, and other configuration settings related to the favorite chat feature described here.

The process 2700 supports a real time chat session by providing a suitably formatted chat window interface to the user (task 2704). Thus, the current chat session involves the user as one of the chat participants. The chat window interface may include or cooperate with a user interface control that can be manipulated by the user to designate the current chat session as a favorite of the user. The user interface control may be realized as an interactive GUI element, an active link, a dropdown menu item, a keystroke, or the like, wherein user interaction with the control may be associated with the generation of a favorite chat request. If the database system receives a favorite chat request (the “Yes” branch of query task 2706), then the current chat session is identified, flagged, or otherwise marked as a favorite conversation for the user (task 2708). Alternatively, the user can identify a previously saved or archived chat as a personal favorite for purposes of the remainder of the process 2700. In other words, task 2708 can identify a real time chat or a previously saved chat as a favorite.

In certain embodiments, the process 2700 saves the completed chat session in the collection of favorites that is designated for the user (task 2710). Thus, the current chat session is added to the maintained collection of chat conversations for purposes of subsequent viewing or retrieval. Thereafter, the process 2700 may receive an access request for the collection of favorite chat conversations (task 2712). In this regard, the chat window interface or the user's profile page may include or cooperate with a suitably formatted user interface control that can be manipulated by the user to access a list of favorite chats. The user interface control may be realized as an interactive GUI element, an active link, a dropdown menu item, a keystroke, or the like, wherein user interaction with the control may be associated with the generation of the access request.

This description assumes that the database system receives an access request and, therefore, the process 2700 continues by providing and displaying a list of the favorite chat conversations, wherein the list includes at least some of the saved collection of chats (task 2714). The list could be displayed on a single GUI screen, or it could be provided on multiple screens, as a scrollable element, or the like. The chat entries may be provided in any order (typically in chronological order), and the entries may be sortable in accordance with any preferred criteria. The list of favorite chats is interactive in nature, such that the user can select an entry to retrieve, view, or otherwise access the selected chat conversation. This description assumes that the database system eventually obtains a chat retrieval request for an entry that appears in the list of favorite chat conversations (task 2716) and, in response to the request, retrieves and displays a saved favorite chat conversation (task 2718). Thus, the selected entry identifies at least one saved favorite chat conversation, and the process 2700 can retrieve and provide a transcript of the requested chat conversation to the user.

The database system may also support sharing of favorite chat conversations. In this regard, the user could email or otherwise send a copy of a favorite chat conversation to another user of the information networking environment. As another example, the user could grant temporary access rights to a favorite chat, or send an access URL to grant access to a favorite chat.

XXII. Notification of Online User Status for a Chat Feature

A database system of the type described herein may be suitably configured to support a variety of user communication features in the context of an information networking environment, such as chat, private messaging, email, posting, and the like. Conventional messaging and chat applications may provide user status indicators such that a given user can quickly determine whether or not other users are available. For example, a chat or messaging application may provide a simple status icon that indicates whether a user is currently offline, online, on vacation, out of the office, etc. Status indicators are helpful, but they force users to access and view certain screens, pages, or GUIs to check the current status of other users. In certain situations, this characteristic can be annoying and inconvenient. For example, assume that a first user needs to send an urgent message to a second user, and the second user is currently offline. The first user may need to frequently check the messaging window or screen in an ongoing manner to determine when the second user is online. To accomplish this, the first user may need to switch windows, launch and monitor the messaging application, and/or search for the second user's status indicator (wherever it may be provided).

The features and functions described here address the shortcomings discussed above. In particular, an information networking environment can be provided with a user status alerting feature that generates alerts related to changes in the status of users. For the above example, an alert would be automatically generated for the first user as soon as the second user's status changes from “offline” to “online”. Alerts can be provided in association with any designated or monitored user status, and alerts need not be limited to “online” notifications.

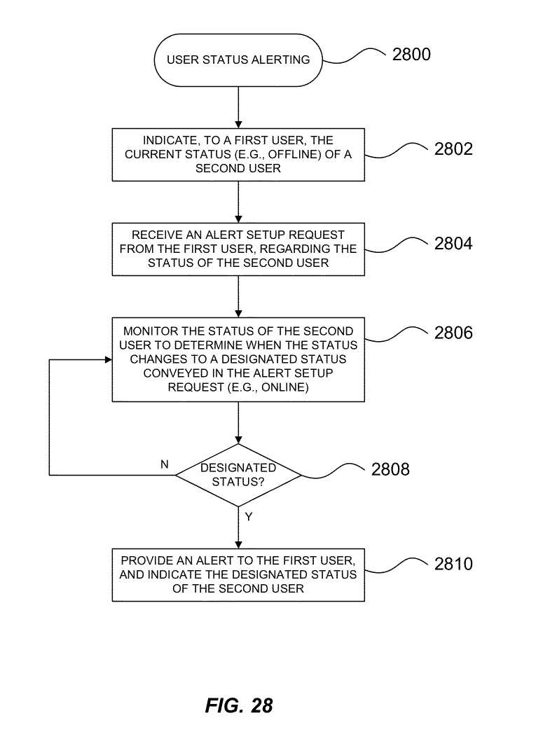

FIG. 28 is a flow chart that illustrates an exemplary process 2800 for alerting users of an information networking environment. This description assumes that the host database system has been configured to support the alerting scheme outlined above. Accordingly, the process 2800 may begin by indicating (to a first user of the information networking environment) the current status of a second user of the information networking environment (task 2802). For this example, the current status is assumed to be an offline status. That said, the current status could be any status, as long as the first user wishes to receive a notification when the current status changes to another status. Thus, the current status may be any of the following, without limitation: offline; online; busy; unavailable; on vacation; out of office; in a meeting; sick; unknown; or the like. Task 2802 may provide an indication of the current status in any suitable format, such as an icon, a color code, a brief written description, or the like. For this example, task 2902 provides a color-coded icon (such as a graphical representation of an indicator light) next to the second user's name or avatar, which in turn may be provided in a chat window interface, a messaging window interface, a contacts list, a list of users followed by the first user, on the second user's profile page, etc.

This description assumes that the second user's current status (as indicated at task 2802) is “offline” or “unavailable”. This description also assumes that the first user is interested in knowing when the second user's status changes to “online” or “available”. To this end, the database system allows the first user to generate an alert setup request that represents an instruction to notify the first user when the status of the second user changes to a designated status (e.g., “online” or “available”). In certain embodiments, the database system provides a simple GUI control element that can be activated by the first user to generate the alert setup request, wherein by default the request is associated with an “online” notification. In other embodiments, the first user is presented with additional options associated with the alerting scheme. For example, the database system may allow the first user to select or specify which user status should be monitored, and may allow the first user to select or designated the manner in which he would like to be notified.

This description relates to a simple implementation that merely checks for changes from offline to online status. Accordingly, the embodiment described here provides a link, a button, or an icon that the first user activates to generate and send the alert setup request. The database system receives the alert setup request (task 2804) and processes the request on behalf of the first user. In this regard, the process 2800 monitors the status of the second user to determine when the status changes from the previous status (offline) to the designated status that is associated with, conveyed in, or otherwise indicated by the alert setup request (task 2806). This description assumes that the process 2800 eventually determines that the status of the second user has changed to the designated status (the “Yes” branch of query task 2808). For this example, the “Yes” branch of query task corresponds to the offline-to-online transition for the second user.

In response to the detection of the designated status, the process 2800 provides an alert to the first user, wherein the alert indicates the designated status of the second user (task 2810). The alert may be provided in one or more forms, which may be configured by the first user, selected by the first user and included in the request, or the like. Depending on the particular embodiment and/or the specific scenario, the alert may be provided in any of the following forms, without limitation: an audio annunciation, a pop-up window, a text message, an email, a private message, a voicemail, a telephone call, a video annunciation, or a graphical icon. Notably, the alert is automatically generated immediately in response to the change in status, or shortly thereafter. Thus, the first user is quickly informed of the online status of the second user by the background alerting function, and the first user need not actively switch windows, launch applications, or manually check/view the current status of the second user. In some embodiments, the alert remains active or is periodically generated until the first user acknowledges it, disable it, or cancels it.

XXIII. Note-Taking Support for a Chat Feature

As mentioned above in Section XVII, a database system of the type described herein may be suitably configured to support a variety of chat features for the users of an information networking environment. Existing online chat systems may utilize a chat window interface that is updated in real time to reflect the conversation between the chat participants. In certain situations, it may be necessary to take notes or copy some of the chat content while participating in a live chat session. In accordance with traditional methodologies, a user can select and copy a portion of the chat content from the chat window interface and then paste the copied portion into another document or file, which in turn can be saved in a designated location. For example, a user could copy an excerpt from the chat window interface, paste the excerpt into a word processor document, and save the document. This procedure is time consuming, inconvenient, and distracting to the user.

A database system may be suitably designed in the manner described here to allow users to quickly and easily create and save notes that are taken directly from the chat window interface. A collection of saved chat notes is maintained on behalf of the user, such that the user can access and view the notes at any time. Notably, the chat notes are user-specified in that the user is in control of the content of each chat note.

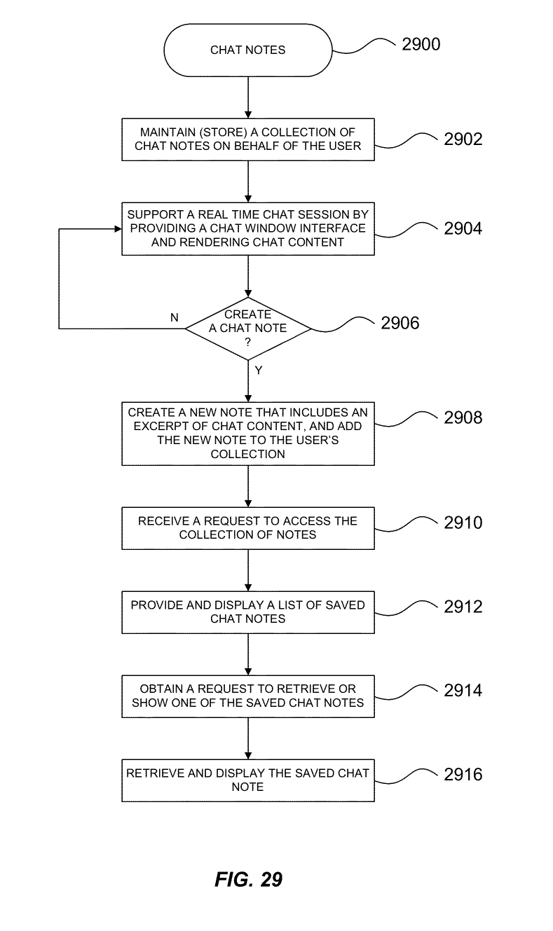

FIG. 29 is a flow chart that illustrates an exemplary process 2900 for supporting a chat notes feature in an information networking environment. This description assumes that the host database system has already been configured to support the chat notes feature mentioned above. To this end, the process 2900 maintains or stores a collection of retrievable chat notes on behalf of the user (task 2902). In practice, the database system may designate a portion of its database for chat notes, and each user or any number of users may have a respective collection of chat notes if so desired. Any number of chat notes could be maintained for the user, and for an indefinite period of time if so desired. The user or a system administrator may have control over the number of chat notes that can be saved in the user's collection, how long the chat notes are preserved, and other configuration settings related to the chat notes feature described here.

The process 2900 supports a real time chat session by providing a suitably formatted chat window interface to the user (task 2904). Thus, the current chat session involves the user as one of the chat participants. The content of the chat conversation may be rendered and displayed in the chat window interface, in accordance with conventional techniques and technologies. In this regard, the chat window interface may be updated as needed to reflect new chat entries made by the user and made by any other participants of the chat session. During the chat session (or at any time while the content of the chat session is still accessible), the process 2900 receives a create note request (the “Yes” branch of query task 2906). The create note request indicates or includes an excerpt or a selected passage of the chat content, which has been taken from the chat session. The create note request may also include additional user-entered content that supplements the selected chat content.

In certain embodiments, the create note request is generated in response to user interaction with the chat window interface. For example, the create note request may be generated in response to the selecting of an excerpt of chat content as presented in the chat window interface. To this end, the user may select or highlight a passage of displayed text, and then access a context menu associated with the highlighted passage (e.g., right clicking on or hovering over the passage). The context menu may give the user the option to add the content to the user's collection of chat notes. As another example, the chat window interface may include or cooperate with a user interface control that can be manipulated by the user to initiate the saving of a chat note for the highlighted content. The user interface control may be realized as an interactive GUI element, an active link, a dropdown menu item, a keystroke, or the like, wherein user interaction with the control may be associated with the generation of a create note request. If the database system receives a create note request (the “Yes” branch of query task 2906), then the process 2900 continues by creating a new retrievable chat note for the user (task 2908). The new note includes the selected excerpt of the chat content, and the new note is added to the user's collection of chat notes. Chat notes are preferably saved with additional information, such as a date/time stamp, the name of the author (or authors) of the saved chat content, the title of the chat session, an identifier of the chat session, the name of the chat session host, or the like.

Thus, the new note is added to the maintained collection of notes such that the user can view or retrieve the note at any time. Thereafter, the process 2900 may receive an access request for the collection of chat notes (task 2910). In this regard, the chat window interface or the user's profile page may include or cooperate with a suitably formatted user interface control that can be manipulated by the user to access a list of saved chat notes. The user interface control may be realized as an interactive GUI element, an active link, a dropdown menu item, a keystroke, or the like, wherein user interaction with the control may be associated with the generation of the access request.

This description assumes that the database system receives an access request and, therefore, the process 2900 continues by providing and displaying a list of saved chat notes, wherein the list includes at least some of the maintained collection of chat notes (task 2912). The list could be displayed on a single GUI screen, or it could be provided on multiple screens, as a scrollable element, or the like. The chat notes may be provided in any order (typically in chronological order), and the entries may be sortable in accordance with any preferred criteria. The list of notes is interactive in nature, such that the user can select an entry to retrieve, view, or otherwise access the selected chat note. This description assumes that the database system eventually obtains a note retrieval request for an entry that appears in the provided list of saved chat notes (task 2914) and, in response to the request, retrieves and displays a saved chat note (task 2916). Thus, the selected entry identifies at least one saved chat note, and the process 2900 can retrieve and provide the requested chat note to the user.

The database system may also support sharing of chat notes. In this regard, the user could email or otherwise send a copy of a chat note to another user of the information networking environment. As another example, the user could grant temporary access rights to a saved chat note, or send an access URL to grant access to a saved chat note.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description. Moreover, the specific details of particular embodiments may be combined in any suitable manner without departing from the spirit and scope of embodiments of the invention. However, other embodiments of the invention may be directed to specific embodiments relating to each individual aspect, or specific combinations of these individual aspects.

It should be understood that any of the embodiments of the present invention can be implemented in the form of control logic using hardware and/or using computer software in a modular or integrated manner. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. Computer readable media encoded with the program code may be packaged with a compatible device or provided separately from other devices (e.g., via Internet download). Any such computer readable medium may reside on or within a single computer program product (e.g., a hard drive or an entire computer system), and may be present on or within different computer program products within a system or network. A computer system may include a monitor, printer, or other suitable display for providing any of the results mentioned herein to a user.

Any of the methods described herein may be totally or partially performed with a computer system including a processor, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. A method of managing a chat feature of an information networking environment, the method comprising:
providing, by a database system, a graphical interactive chat favorites element comprising a list of at least one favorite user or group of the information networking environment, as designated by a first user;
receiving, at the database system, data identifying one or more chat invitees selected from the list of the interactive chat favorites element; and
generating chat invitations to the one or more chat invitees.

2. The method of claim 1, wherein the list comprises an entry that identifies a defined group of users.

3. The method of claim 2, further comprising:
detecting user interaction with the entry, the user interaction associated with a show group command; and
providing a member list that indicates individual members of the defined group of users, wherein the member list is provided in response to detecting the user interaction with the entry.

4. The method of claim 1, further comprising:
receiving, at the database system, a request to designate a selected user as a favorite of the first user; and
updating the list of the interactive chat favorites element, in accordance with the received request.

5. The method of claim 1, further comprising:
receiving, at the database system, a request to designate a plurality of selected users as a favorite group of the first user; and
updating the list of the interactive chat favorites element, in accordance with the received request.

6. The method of claim 1, wherein the method is performed by a multi-tenant database system.

7. The method of claim 1, wherein the method is performed by a processor executing instructions of a tangible and non-transitory computer readable medium.

8. A method of managing a chat feature of an information networking environment, the method comprising:
providing, by a database system, a chat window interface to support a chat session that involves a user of the information networking environment;
receiving a favorite chat request at the database system, the favorite chat request generated in response to the user interacting with the chat window interface; and
identifying the chat session as a favorite conversation for the user, wherein the identifying is performed in response to receiving the favorite chat request.

9. The method of claim 8, further comprising:
maintaining a collection of favorite chat conversations, wherein the identifying adds the chat session to the maintained collection of favorite chat conversations.

10. The method of claim 9, further comprising:
receiving an access request for the collection of favorite chat conversations; and
providing a list of favorite chat conversations, the list comprising at least some of the maintained collection of favorite chat conversations.

11. The method of claim 10, further comprising:
obtaining a chat retrieval request for an entry that appears in the provided list of favorite chat conversations; and
retrieving a saved favorite chat conversation from the maintained collection of favorite chat conversations, wherein the entry identifies the saved favorite chat conversation.

12. A method of alerting users of an information networking environment of the changing status of other users, the method comprising:
receiving an alert setup request at a database system, the alert setup request representing an instruction to notify a first user of the information networking environment when a status of a second user of the information networking environment changes to a designated status;
determining, by the database system, when the status of the second user changes from a previous status to the designated status; and
in response to the determining, providing an alert to the first user, wherein the alert indicates the designated status of the second user.

13. The method of claim 12, wherein the providing provides the alert in the form of an audio annunciation, a pop-up window, a text message, an email, a private message, a voicemail, a telephone call, a video annunciation, or a graphical icon.

14. The method of claim 12, wherein:
the previous status of the second user is an offline status; and
the designated status of the second user is an online status.

15. The method of claim 12, wherein the designated status is selectable by the first user.

16. A method of managing notes for a chat feature of an information networking environment, the method comprising:
providing, by a database system, a chat window interface to support a chat session that involves a user of the information networking environment;
receiving a create note request at the database system, the create note request indicating an excerpt of chat content taken from the chat session; and
creating a retrievable note for the user, wherein the creating is performed in response to receiving the create note request.

17. The method of claim 16, further comprising:
maintaining a collection of chat notes on behalf of the user, wherein the creating adds the retrievable note to the maintained collection of chat notes.

18. The method of claim 16, further comprising:
receiving an access request for the collection of chat notes; and
providing a list of saved chat notes, the list comprising at least some of the maintained collection of chat notes.

19. The method of claim 18, further comprising:
obtaining a note retrieval request for an entry that appears in the provided list of saved chat notes; and
retrieving a saved chat note from the maintained collection of saved chat notes, wherein the entry identifies the saved chat note.

20. The method of claim 16, wherein the create note request is generated in response to selecting the excerpt of chat content as presented in the chat window interface.
